(19) United States
(12) Patent Application Publication
(10) Pub. No.: US 2010/0173167 A1
(43) Pub. Date: Jul. 8, 2010

(54) METHOD FOR PRODUCING THIN LAYERS AND CORRESPONDING LAYER

(75) Inventors: Klaus-Dieter Vissing, Morsum (DE); Christopher Dölle, Delmenhorst (DE); Matthias Ott, Dohren (DE)

Correspondence Address: WEINGARTEN, SCHURGIN, GAGNEBIN & LEBOVICI LLP, TEN POST OFFICE SQUARE, BOSTON, MA, 02109, US

(73) Assignee: FRAUNHOFER-GESELLSCHAFT ZUR FÖRDERUNG DER ANGEWANDTEN FORSCHUNG E.V., München (DE)

(21) Appl. No.: 12/598,087

(22) PCT Filed: Apr. 30, 2008
(86) PCT No.: PCT/EP08/55351

§ 371 Date: Dec. 15, 2009

(30) Foreign Application Priority Data
Apr. 30, 2007 (DE) 10 2007 020 655.2

(51) Int. Cl. B32B 27/28; C08F 2/48; C08F 2/46

(52) U.S. Cl. 428/447; 427/508; 427/515

(57) ABSTRACT

The invention relates to a coating method comprising the following steps
a) providing a mixture or a pure substance comprising or consisting of inactive, liquid precursors,
b) applying a liquid layer made up of the mixture or the pure substance to a surface to be coated,
c) crosslinking the liquid precursors by means of radiation having a wavelength of ≦250 nm, so that a solid layer is produced from the mixture and the layer comprises ≧10 atomic % of C, based on the quantity of the atoms contained in the layer without H and F,
   and so that the C contained in the layer is at most 50 atomic % of the C, based on the quantity of the C atoms contained in the layer, constituent of a methoxy group.

The invention further relates to layers which can be produced or are generated by means of this method and the uses thereof and also to corresponding coated items and the uses thereof.

The invention relates to a coating method comprising the following steps

a) providing a mixture or a pure substance comprising or consisting of inactive, liquid precursors,

b) applying a liquid layer made up of the mixture or the pure substance to a surface to be coated,

c) crosslinking the liquid precursors by means of radiation having a wavelength of ≦250 nm, so that a solid layer is produced from the mixture and the layer comprises ≧10 atomic % of C, based on the quantity of the atoms contained in the layer without H and F,

and so that the C contained in the layer is at most 50 atomic % of the C, based on the quantity of the C atoms contained in the layer, constituent of a methoxy group.

The invention further relates to layers which can be produced or are generated by means of this method and the uses thereof and also to corresponding coated items and the uses thereof.

Table of Contents

1. Glossary (definitions) . . . 4

2. General overview . . . 8
2.1 Prior art . . . 8
   2.1.1 Radiation chemistry/electron beam curing, EB curing, EB crosslinking . . . 8
   2.1.2 Methods for forming thin layers from the prior art . . . 12
2.2 Description of the invention . . . 14
   2.2.1 General description of the invention . . . 14
   2.2.2 General layer properties . . . 24
   2.2.3 Procedural advantages . . . 27
2.3 Delimitation against the prior art . . . 29

3. Precursors which may be used . . . 41
3.1 Silicone compounds . . . 41
3.2 Partially and fully fluorinated carbon compounds . . . 41
3.3 Halogen-free, organic liquids . . . 41

4. Fillers and additives which may be used . . . 43

5. Coating methods . . . 44

6. Substrates/surfaces . . . 47

7. General information concerning the conducting of the method . . . 48

8. Applications . . . 66
8.1 Coating crosslinked in accordance with the invention with dispersed, finely divided solids . . . 66
8.2 PDMS-like coating . . . 69
8.3 Antimicrobial, preferably non-cytotoxic coating . . . 86
8.4 Corrosion protection and tarnish protection . . . 88
8.5 Parting layers . . . 93
8.6 Easy-to-clean layers . . . 96
8.6.1 Surfaces which are easy to clean by way of suitable surface chemistry . . . 96
8.6.2 Surfaces which are easy to clean by way of smoothing or sealing of surface unevenness . . . 99
8.7 Integration of solid particles . . . 99
8.8 Adhesion promoter layers, primer layers, functionalized surfaces . . . 101
8.9 Electrical insulation layers . . . 105
8.10 Locally located coatings . . . 106
8.11 Optical functional layers . . . 109
8.12 Anti-fingerprint coatings . . . 112
8.13 Smoothing and sealing coatings . . . 114
8.14 Structuring, topography-imparting coatings . . . 117

9. General information . . . 120

10. Examples . . . 121

1. Glossary (Definitions)

Inactive precursors: Precursors containing no silane, peroxo, halogen, acrylate, methacrylate, isocyanate and epoxide groups and also groups which are comparatively chemically reactive with the aforementioned groups, preferably those additionally also containing no carboxylic acid, acid ester, acid anhydride and nitrogen-containing functional groups. Preferred inactive precursors are silicone oils, saturated hydrocarbons, mineral oils, fluoro-organic/partially fluorinated oils and as an exception to the aforementioned, depending on the application, fatty acids, triglycerides and polyethers.

Excimer lamps: Excimer, short form of “excited dimer”. An excimer denotes a short-lived bond of two molecules or atoms that exists only in the excited state (in the case of non-identical partners, the term “exiplex” is also used). After the disintegration of the connection the bond energy is released in the form of light. Gas mixtures containing components which are capable of forming excimer complexes are the starting point for what are known as excimer light sources. Generally speaking, energy is supplied to the gas through an electrical field, thus providing the basis for the formation of excimers. Excimer lasers coherently emit the light which is released after the disintegration of the excimers; excimer lamps are a light source which radiates non-coherently. Examples: KrF (248 nm), Xe₂ (172 nm), F₂ (155 nm), ArF (193 nm) KrCl (222 nm), etc.

Line emitters/band emitters: Light sources, the emission spectra of which comprise one or more discrete frequencies or consist thereof. Line/band emitters are based on the excitation of discrete energy levels such as for example atomic or molecular energy levels or electronic band transitions for semiconductors. The wavelength of the emitted light corresponds to the difference in energy between the excited energy level and the end energy level assumed after the emission of light, frequently the basic state or relaxation level. In accordance with the likelihood of transition between the energy levels, the emission spectrum additionally comprises, around the emission wavelength, a certain additional wavelength range, what is known as the spectral bandwidth. Hereinafter, the term “irradiation at a wavelength” will refer in all cases both to the wavelength which is to be directly assigned to the discrete energy levels of the radiation source, the central wavelength of the level transition, and to the wavelength range which, around the central wavelength, is to be assigned to the spectral bandwidth of the transition. Hereinafter, the term “line emitter” will refer to an emitter based on discrete transitions in atoms or molecules, for example excimer lamps, excimer lasers. The term “band emitter” refers to an emitter based on a transition between electronic bands, for example the semiconductor laser.

Particle diameter: The term “particle diameter” refers in the scope of this invention, unless otherwise explicitly stated, to what is known as the equivalent diameter. This refers, irrespective of the actual shape of the particle, to the diameter of a volume-identical, ideally spherical particle or, in the case of planar projection of an area-identical, ideally round particle. The person skilled in the art can determine the particle diameter and the particle size distribution based on known methods. For example, the dynamic light scattering technology is suitable for particles smaller than 2 μm; laser diffraction (for example DIN ISO 8130-13) can be used for particles larger than 2 μm. In this case, as also in similar methods, the diameter is determined based on a characteristic, physically accessible property (for example scattering, diffraction, rate of descent, etc.).

Polymerization: Connection of monomers or precursors to form macromolecules in which one type or a plurality of types of atoms or groups of atoms (what are known as repetitive units, basic modules or repetition units) are repeatedly strung together. Polymerization generally produces molecules having a (predictable) short-range order.

Polymer: Product produced by a polymerization.

Plasma polymerization: Plasma polymerization generates layers which, in their chemical or structural composition, are clearly distinguishable from polymeric layers. Whereas in the case of polymers the linking process of the precursors takes place in a predictable manner (see above), during plasma polymerization the precursors which are used are markedly altered (up to complete destruction) as a result of contact with the plasma and are deposited in the form of reactive species. This produces a highly crosslinked layer without uniform regions. In addition, this layer which is produced is also subjected to the plasma, so that ablation and redeposition effects give rise to further modifications. The plasma-polymeric layer is three-dimensionally crosslinked and amorphous. Accordingly, plasma polymerization differs, in the sense of this text, from conventional polymerization methods. It is a method in which excited gaseous precursors (also referred to as monomers) from a plasma are deposited onto a substrate as a highly crosslinked layer. A precondition for a plasma polymerization is the presence of chain-forming atoms such as carbon or silicon in the working gas. As a result of the excitation, the molecules of the gaseous (precursors) are fragmented by the bombardment with electrons and/or high-energy ions. This produces highly excited radical or ionic molecular fragments which react with one another in the gas space and are deposited on the surface to be coated. The electrical charge of the plasma and the intensive ion and electron bombardment thereof act continuously on this deposited layer, so that in the deposited layer a further reaction is triggered and a high degree of linking of the deposited molecules may be achieved. Reference is made, in this connection, for example to the following citation: “Plasmapolymerisation” in H. Yasuda, Academic Pres., Inc. (1985).

Within the scope of the present text, the term “plasma polymerization” also comprises in particular plasma-assisted CVD (PE/CVD). In this case, the substrate is additionally heated to conduct the reaction. Plasma polymerization can be carried out both under atmospheric pressure and under low pressure.

Plasma polymer: Product produced by plasma polymerization.

Crosslinking: Three-dimensional linking of precursors which are used, wherein within the scope of this text, in the case of “crosslinking”, the linking is not based on conventional polymerization reactions. That means that the layers which are produced during “crosslinking” in the sense of this text are based, unlike polymers, not on a polymeric chain reaction. Accordingly, crosslinked layers are configured in such a way that they display no short-range order with regard to their former precursor structures. In this respect, layers generated by crosslinking are similar to plasma-polymeric layers. “Crosslinking” in the sense of this application also means in all cases the forming of layers, i.e. a planar reaction affecting the entire surface to be coated. Crosslinking accordingly serves to generate a (solid) layer. It therefore involves not merely generating points of adhesion between surfaces.

Excimer-crosslinked: Crosslinked, preferably crosslinked by means of UV radiation of ≦250 nm, in particular crosslinked by means of UV radiation of from 120-250 nm, most particularly preferably crosslinked by means of line or band emitters with emission in the aforementioned wavelength ranges.

Relatively long-chain precursors: Molecules having a molecular weight of greater than 600 g/mol. The relatively long-chain precursors will in turn have been produced conventionally by a polymerization reaction.

Precursors: Organic or siliconorganic or fluoro-organic molecules or mixtures of these molecules as progenitors for layers.

2. General Overview

2.1 Prior Art

2.1.1 Radiation Chemistry/Electron Beam Curing, EB Curing, EB Crosslinking

Radiation chemistry describes the examination of radiation-induced chemical processes during irradiation with light. In particular if suitable radiation sources are available, such as for example lasers in the visible spectral range and in the UV range, incoherent radiation sources such as mercury lamps or excimer lamps and high-energy radioactive gamma emitters, the entire range of possible effects can be analyzed. Focal points of the examinations are formed, not only by the basic principles and the theoretical description, but above all by the interaction between radiation with matter of various states (solid, liquid, gaseous) and also the detailed analysis of specific classes of substance. For example, macromolecules such as polypropylene, fluoropolymers or polysiloxanes have been analyzed with regard to the chain breaks to be expected, fragments produced as a result and the subsequent recombination and crosslinking. Corresponding effective cross sections may be inferred from the literature. The influence of process gases or additions of foreign substances belongs for the most part to the prior art. A typical example of application of radiation chemistry is the curing of colorants, paints or adhesives, for example with the aid of photoinitiators which start radical polymerization reactions as a result of irradiation of light of a suitable wavelength.

The radiation sources used in the basic tests were generally gamma emitters, i.e. extremely high-energy radiation. However, these radioactive radiation sources are to be regarded as posing a serious threat to health and use thereof requires corresponding, complex technical measures. In addition, X-radiation may be mentioned as an alternative radiation.

Nowadays, on the other hand, lasers or excimer lamps, for example, provide economical radiation sources which industrially open up, at moderate cost, safe access to radiation chemistry. Excimer lamps are for example known in the prior art from the following documents:
CH 675 178 A5
CH 676 168 A5
DE 10 2005 046 233 A1
DE 199 16 474 A1 and
Kitamura, M et al., Applied Surface Science 79/80 (1994) 507-513 “A practical high power excimer-lamp excited by a microwave discharge”
U. Kogelschatz: Dielectric-barrier Discharges: Their History, Discharge Physics, and Industrial Applications, Plasma Chem. And Plasma Proc., Vol. 23, No. 1, 1-46 (2003)

The radiation energy of excimer lamps and lasers is sufficient to ionize a large number of elements and molecules or to open single and double bonds. For example, the dissociation energy of the O₂ molecule is 5.1 eV, of a C—C single bond approx. 3.57 eV, of a C═C double bond approx. 6.3 eV, the dissociation of a hydrogen atom from methane 4.5 eV, etc. The photon energy of the KrF excimer lamp (wavelength 248 nm) is, by way of comparison thereto, 5 eV, of an Xe₂ emitter (172 nm) 7.2 eV, of an F₂ emitter (155 nm) 8 eV, of an ArF emitter (193 nm) 6.4 eV, KrCl (222 nm) 5.6 eV, etc. It is thus possible to be able to utilize a number of the known processes of radiation chemistry using simple radiation sources. Thus, for example, bonds within the molecules or of molecular fragments of an applied liquid can be broken open. The radicals which are produced in this way are oriented in a statistically new manner and can bring about new crosslinking of the liquid and thus contribute to a stable layer formation.

In addition to the possibility of irradiating with a pure electromagnetic wave of specific photon energy, an alternative is irradiation with an electron beam (electron beam curing, ESH, EB curing, EB crosslinking). In electron beam curing radiation sources based on the principle of cathode ray tubes are used. Cathode ray tubes generate accelerated electrons which are a corpuscular radiation and penetrate for example pigments, fillers, metal foils and paper. The effect of the electrons may be classified in relation to their energy: the rapid primary electrons and the backscattered electrons do not cause chemical reactions. Their effective cross section is too small; they are not captured by the molecules and thus cannot carry out any formation of radicals, ionization or excitation. The secondary electrons in an energy range of between 3 and 50 eV are important for the curing. They are sufficiently slow, i.e. the effective cross section is sufficiently large, to ionize molecules and to form radicals. The kinetic energy of the electrons is insufficient to open both single and double bonds. As a result of fragmentation of this type, it is more generally possible to generate free radicals from monomers or oligomers which start for example chain reactions for polymerization (EB curing). Or it is possible to generate free radicals from macromolecules which lead to a three-dimensional crosslinking as a result of recombination of the radicals (EB crosslinking). Slow electrons having energies of below 3 eV lead only to excitation.

In a number of applications the use of electron beams is, purely in terms of the examination of the energies provided, an interesting alternative to pure irradiation with an electromagnetic wave. Accordingly, there are a number of applications which are possible equally by way of an electromagnetic wave and by way of electron beams.

Typical applications of electron beams are: it is possible to observe, by heating the surface at low pressure, melting processes and evaporation processes facilitating welding or microstructuring. Coatings, colorants and paints can be cured or surfaces can be chemically activated as a result of chemical reactions at atmospheric pressure. Dominant electron beam-curable coating materials are acrylate monomer-prepolymer binder systems and also cationically curing formulations made up of epoxides, polyols and vinyl ethers. A further application frequently to be encountered is increasing the cohesion of adhesive compounds in order to achieve for example higher stability with respect to shear forces. Known in the prior art are additives based on a modified silicone which is added to a composition at a low concentration. In this case, use is made for example of polysiloxanes provided with (meth)acrylic acid ester groups and fluorinated and/or perfluorinated residues.

A further biological application is the sterilization of packaging material.

Compared to the application with light, electron radiation provides much more rapid and cold layer curing. The cause may be identified above all in the marked absorption of the UV radiation in most materials, leading to heating of the irradiated surface. Thus, the UV emitters act comparatively superficially. Complete curing of thick layers, in particular of layers with additives, requires polymerization chain reactions. In addition, electron beam curing requires, owing to the relatively simple control of the electron energy, no photoinitiators to start the polymerization reaction; this is the case above all in irradiation with conventional commercial mercury lamps.

Nevertheless, it should be noted that the use of electron beams has to date not become established in the full range of applications, but is competitive only in specific cases or in large-scale production. About 90% of beam-curable materials are currently cured with the aid of UV emitters; just 10% are allotted to electron beam installations. The main reason may be identified in the technically complex implementation. For example, an N₂ atmosphere is generally required to prevent inhibition by oxygen. Furthermore, the electrons, which penetrate deep into the material, generate, during the deceleration of the electron beams in the film, marked radiation exposure in the X-ray range. For this reason, the emitters have to be integrated into a radiation protection hood and are subject to the German Radiation Protection Ordinance.

Owing to the technical requirements, the method is generally limited to 2D surfaces.

2.1.2 Methods for Forming Thin Layers from the Prior Art

“Sol-Gel-Science—The Physics and Chemistry of Sol-Gel-Processing”, (C. J. Brinker, G. Scherer; Academic Press, New York 1989) provides an overview of sol-gel technology, with the aid of which thin and very thin layer coatings can be produced. Generally speaking, the layers are cured by way of hydrolysis and condensation processes by heat treating the substrate at temperatures of above 80° C.

DE 40 19 539 A1 describes the production of a decrosslinking surface, a thin film of a silicone oil being applied to a surface to be decrosslinked and the oil being crosslinked by means of a plasma.

DE 100 34 737 A1 discloses a method for producing a permanent demolding layer by plasma polymerization, HMDSO, for example, being deposited by plasma polymerization as the layer.

Further documents which disclose plasma-polymeric coatings are documents DE 101 31 156 A1, DE 10 2004 026 479 A1 and DE 103 53 530 A1. These documents disclose plasma-polymeric layers for parting or molding functions.

The publication “UV Curing Without Photoinitiators” (Scherzer, T., et al., Institut für Oberflächenmodifizierung e.V., Proc. Rad. Tech. Europe 2001 Conf.) describes the initiation of a photopolymerization of acrylates by means of monochromatic UV light of a wavelength of 222 nm. The UV light source specified is a KrCl excimer lamp. This is a polymerization reaction in the conventional sense.

WO 96/34700 discloses a method in which monomers comprising a double bond are polymerized by means of UV light. Photoinitiators are used in this case, so that a conventional polymerization is started.

DE 199 57 034 B4 discloses the build-up of layers on surfaces by means of excimer lamps through reactive fragments from the gas phase.

DE 42 30 149 A1 describes the production of oxidic protective layers by means of excimer lamps from polymers or from solid metallo-organic compounds.

The publication “Plasma-deposited organosilicon thin films as dry resists for deep ultraviolet lithography”, Horn, M. W. et al., J. Vac. Sci. Technol. B 8 (6), November/December 1990 discloses the modification of plasma-polymeric (solid) layers by means of UV light.

The publication “Release Layers for Contact and Imprint Lithography”, Resnick, D., Semiconductor International, June 2002 discloses the use of a liquid precursor for polydimethylsiloxane. This liquid precursor is, according to the citation (to which reference is made in the aforementioned document) “Soft Lithography”, Xia, Y. et al., Angew. Ref. Matter. Sci. 1998 PDMS, provided with a reactive group (for example vinyl-terminated PDMS), so that the PDMS is present as a conventional polymer. The UV-curable dimethylsiloxane oligomer layer disclosed in the document is also produced by means of conventional polymerization.

DE 199 61 632 A1 discloses a UV-curable paint, the curing involving a conventional polymerization reaction in this case too. In particular, monomers with reactive groups (acrylate monomers) are used.

The publication “Funktionelle Schichten durch UV- and Elektronenstrahlhärtung”, Mehnert, R. et al., Mat.-wiss. u. Werkstofftech. 32, 774-780 (2001) discloses the curing of oligomeric acrylates with reactive groups.

EP 0 894 029 B1 discloses the curing of ethylene-containing unsaturated monomers by means of UV irradiation by excimer lamps. The products which are produced are conventional polymers.

JP 11035713 discloses a gas barrier layer which is crosslinked using excimer lamps. The layer which is produced comprises, according to the disclosed IR spectrum, no carbon.

The publication “Photo induced synthesis of amorphous SiO₂ with tetrametoxilane”, Awatsu, K. and Onoki, I., Appl. Phys. Lett. 69 (4), 22 July 1996 discloses the crosslinking of tetramethoxysilane (TMOS) by means of excimer lamps to form an amorphous SiO₂ layer. The layer which is produced is not described in depth; it is deposited on a wafer. The result of the treatment is a layer which is similar to inorganic SiO₂ as a result of elimination of the methoxy groups.

Also known are a number of further publications, for example “Wettability and surface composition of poly(dimethylsiloxane) irradiated at 172 nm”, Graubner, V. et al. Polymeric Materials: Science & Engineering, 88, 488 (2003), disclosing the treatment of (solid) polymer layers with excimer lamps.

2.2 Description of the Invention

2.2.1 General Description of the Invention

The object of invention was to disclose, with regard to the coating methods known in the prior art, a further method having advantages in a large number of individual areas.

This object is achieved by a coating method comprising the following steps:

a) providing a mixture or a pure substance comprising or consisting of inactive, liquid precursors,

b) applying a liquid layer made up of the mixture or the pure substance to a surface to be coated,

c) crosslinking the liquid precursors by means of radiation having a wavelength of ≦250 nm, so that a solid layer is produced from the mixture and the layer comprises ≧10 atomic % of C, based on the quantity of the atoms contained in the layer without H and F,

and so that the C contained in the layer is at most 50 atomic % of the C, based on the quantity of the C atoms contained in the layer, constituent of a methoxy group.

Preferably, the crosslinking is carried out in such a way that at most 50 atomic % of the C, based on the quantity of the C atoms contained in the layer, is a constituent of an alkoxy group.

In principle, the person skilled in the art has at his disposal a number of possibilities for adjusting the content of carbon in the layer. This is of course possible, on the one hand, using the precursors (and if appropriate further constituents of the mixture); on the other hand, the duration of irradiation also plays a part as, when carrying out the method according to the invention, the carbon content in the layer which is produced decreases in many variants as the duration or intensity of irradiation increases.

Preferably, the method according to the invention is carried out in such a way that the C signal displays in the depth profile of the time of flight-secondary ion mass spectrometry (TOF-SIMS) profile, on standardization of the intensities to the silicon signal, a course which is substantially parallel to the X axis (sputtering cycles). This measurement reflects the distribution of carbon along the layer depth and displays a homogeneous distribution. For achieving this distribution, reference is made to the following text; for carrying out the corresponding measurement, also in particular to Example 2.

Depending on the method which is carried out, preferred durations of irradiation during the crosslinking may be: at least 50 ms, preferably 1 secs, particularly preferably 10 secs and at most 60 mins, preferably 20 mins, and particularly preferably 10 mins.

The irradiation intensity which may be utilized for the crosslinking may be varied both by way of the power of the radiation source and by way of the distance between the radiation source and substrate and by way of the atmospheric gas. Preferred is a distance between the surface to be coated and the lower edge of the lamp of from 1 mm to 20 cm, particularly preferably 5 mm to 5 cm.

The surface to be coated can be displaced, be rotated or otherwise moved during the irradiation or the irradiation unit can be moved relative to the substrate in order to achieve the desired local irradiation intensity and thus crosslinking of the precursors.

The irradiation can comprise one cycle within the scope of the aforementioned duration of irradiation, or comprise a plurality of cycles, also having a different duration of irradiation; if appropriate, the cycles can also be implemented with the aid of a plurality of irradiation units, for example by passing under excimer lamps connected in series. A number of from 1 to 50 cycles is preferred; 1 cycle is particularly preferred.

Furthermore, the irradiation can be carried out punctiformly, linearly, in a curved manner, 2-dimensionally, 3-dimensionally, in the shape of a regular pattern or statistically or with the aid of a mask or otherwise on the selected regions.

In addition to the possibility of irradiating the entire surface at a constant irradiation intensity and of achieving a unitary degree of crosslinking, it is equally possible to subject the surface to locally differing irradiation intensities, so that locally differing degrees of crosslinking are produced. The possible implementations of this are manifold.

The content of the carbon, which is, in the crosslinked layer produced in the method according to the invention, a constituent of a methoxy or alkoxy group, can also be controlled by carrying out the method accordingly. The main example of this is of course also the provided mixture or the pure substance as, if the process is conducted accordingly, the mixture or the substance is not completely fragmented.

For a large number of applications, it is preferable for the content of the C contained in the layer to be at most 50, preferably at most 30, more preferably at most 15 and particularly preferably at most 2 atomic % of the C, based on the quantity of the C atoms contained in the layer, constituent of a methoxy and more preferably also of an alkoxy group.

The appropriate content can be determined by means of methods with which the person skilled in the art is familiar, in particular after a derivatization, for example with moist hydrogen chloride gas. The alkoxy groups are substituted as a result of the derivatization. Subsequently, the derivative, for example the chlorine, can be determined for example on the surface with the aid of the ESCA. For this determination, care must be taken to ensure that the substrate is analyzed, after the derivatization, while air is excluded. For this purpose, the derivatization should be carried out in a reaction chamber connected to the analysis chamber. A further possibility for analysis is the analysis of the gas formed during the derivatization, for example of the alcohol eliminated as a result of the reaction with hydrogen chloride, for example using GC-MS analysis. Optical analysis methods may also beneficially be used.

UV radiation having a wavelength of ≧120 nm and ≦250 nm is preferably used for the coating method according to the invention. It is more preferable for use to be made, for this purpose, of line or band emitters having an emission exclusively within this range.

Preferred is a coating method according to the invention wherein the layer made up of liquid precursors is crosslinked by means of laser radiation or UV radiation from an excimer lamp.

More preferably, the crosslinking is carried out by means of UV radiation of a wavelength of ≦200 nm.

Crosslinking by means of UV radiation of a specific wavelength or from a specific radiation source means, within the scope of this text, that the crosslinking reaction is carried out predominantly, preferably completely, by means of the radiation of the specified wavelength or from the specified radiation source.

It has surprisingly been found that the method according to the invention, in particular in its preferred embodiments (cf. above and also hereinafter), may be used to generate layers having a, compared to the layers known in the prior art, outstanding homogeneous depth profile, in particular based on carbon. As a result of the use of the above-described radiation ranges and in particular of the above-described preferred radiation sources, it is possible to achieve an ideal combination of energy introduced and depth of penetration into the precursor layer. This applies in particular to the preferred precursors described hereinafter in the text. At wavelengths of the irradiated UV light of above 250 nm, the energy is often not sufficient to ensure the required degree of desired bond breakage. This applies in particular in lower regions of the layer to be crosslinked. On the other hand, excessively hard UV radiation, in particular that having a wavelength of <120 nm, is also disruptive for a large number of applications, as the amount of energy introduced is so great that excessively intensive crosslinking is carried out in the top layers of the precursor; this also leads to the carbon being expelled excessively intensively in the upper region of the layer. This leads to stresses within the layer owing to inhomogeneous crosslinking and substance composition; this can lead for example to the formation of cracks within the layer owing to mechanical inherent stress.

Preferably, in the coating method according to the invention, the liquid precursors are applied at an average layer thickness of from 3 nm to 10 μm. More preferred average layer thicknesses may be identified in the range of from 5 nm to 5 μm, again preferably in the range of from 10 nm to 1 μm, during application. In this case, it is of course possible for the mixture containing the precursors to comprise also constituents which extend beyond the resulting layer thickness of the precursors, for example particles (cf. hereinafter). It should also be noted that, depending on the configuration of the method, the crosslinked layer generated in the method according to the invention frequently has a lower layer thickness than the thickness of the liquid precursor layer, as volume shrinkage may frequently be observed during crosslinking.

For a large number of applications, it is preferable if the method according to the invention is carried out in such a way that the resulting layer thicknesses of the crosslinked layer are ≧20 nm, preferably ≧30 nm, more preferably ≧40 nm. With an appropriate minimum layer thickness, the desired effect may be ensured particularly effectively for a large number of applications.

Furthermore, preference is given to a coating without fillers or additives in which the layer thickness of the coated surface regions displays, for a flat area, deviations relative to the average coating thickness of less than 50 percent, particularly preferably less than 20 percent and more preferably less than 10 percent. The layer thicknesses can be measured using analysis methods known to the person skilled in the art, such as for example reflectometers or ellipsometers. Frequently, a microscope and knowledge of the relationships between discernible interference color and layer thickness are sufficient.

Furthermore, it is preferable to configure the method according to the invention in such a way as to generate a coating without fillers and/or additives, in which the layer thickness of the coated surface regions displays, for a flat area, deviations relative to the average coating thickness of less than 50 percent, particularly preferably less than 20 percent and more preferably less than 10 percent.

Preferably, the method according to the invention is carried out in such a way that the relative layer thickness deviation is, based on the average layer thickness along a section of 1 mm on the entire coated surface, at least 1%, preferably 2%, but in each case in absolute numbers at least 5 nm. The difference in layer thickness may be ascertained by means of known layer thickness measuring methods (reflectometry, ellipsometry, TEM (transmission electron microscopy), SEM (scanning electron microscopy) or preferably by examining the layer thickness-characteristic interference colors under a light microscope. The aforementioned layer thickness deviation is one of a plurality of criteria for distinguishing, for example, from plasma-polymeric layers. The latter preferred method is particularly preferred if substrates are coated having a roughness value Rₐ of ≦500 nm on the surface.

For certain applications, it is also preferable for the substrate to be coated to have at the surface a roughness value Rₐ of >500 nm, more preferably >1 μm.

The coatings which are generated in accordance with the invention may be classified as a partially closed or as a closed coating. Partially closed coatings are characterized by way of the degree of coverage, i.e. the ratio of the covered surface area to the total surface area. Partially closed coatings can have uncoated regions which are deliberately left open (deliberate structuring) or regions which are accidentally left open (coating errors). A closed surface has a degree of coverage of 1. Coatings having a degree of coverage of between 0.1 and 1 are preferred. Coatings having a degree of coverage of between 0.5 and 1 are particularly preferred. Closed coatings are more particularly preferred.

In the method according to the invention it is also preferable for the mixture provided in step a) to comprise ≧50% by weight, preferably ≧70% by weight, particularly preferably ≧85% by weight of or exclusively liquid precursors. In this case it is preferable, for a large number of applications, for only one species of liquid precursor to be present.

In addition, a method according to the invention is preferred, wherein the precursors provided in step a) comprise ≧10 atomic % of C, preferably ≧20 atomic % of C, particularly preferably ≧30 atomic % of C, based on the quantity of the atoms contained in the mixture without H and F. In this way, a sufficient amount of carbon is introduced via the liquid precursors into the layer to be crosslinked.

It is more preferable for the C contained in the mixture provided in step a) to be at most 50 atomic %, preferably at most 30 atomic %, preferably at most 10 atomic % and particularly preferably at most 1 atomic %, based on the quantity of the C atoms contained in the mixture, a constituent of an alkoxy group, preferably a methoxy group.

For certain applications of the method according to the invention, it may be preferable for the surface to be coated to comprise no silanol groups. However, in other applications, this may be desirable.

In a further preferred embodiment of the method according to the invention, the liquid layer is applied under conditions under which no chemical reaction takes place between the inactive liquid precursors and the surface to be coated.

In the method according to the invention and the preferred method according to the invention, a liquid is therefore applied to the surface to be coated and crosslinked by high-energy radiation, in particular UV radiation. For crosslinking, this novel method requires neither photoinitiators to start a crosslinking reaction nor functional groups, i.e. it is sufficient to use compounds comprising merely single bonds. Such compounds are generally more economical, more environmentally friendly and non-toxic, properties which comply with the procedural and workplace safety and pricing of the coated product. The simplest embodiment of the coating process can be carried out under atmospheric conditions, thus allowing operation to be economical also from the point of view of industrial procedural implementation. The use of thin precursor layers (<10 μm) ensures that the precursor as a whole can be crosslinked in acceptable processing times (typically 10 secs-10 mins).

As indicated above, the method is conducted in such a way that the carbon content (C content) in the crosslinked layer comprises ≧10 atomic %, preferably ≧15 atomic %, preferably ≧20 atomic %, more preferably ≧25 atomic %, particularly preferably ≧30 atomic %, based on the quantity of the atoms contained in the layer without H and F.

The incorporation of carbon surprisingly allows a large number of coatings having different properties to be generated. For example, the following surface functions may be achieved by means of the coating: corrosion protection, easier cleaning (easy-to-clean), less clinging of plastics materials (release properties), etc. (cf. in this regard also the following). The residual content of carbon in the coating is significant to the extent that corresponding layers display a high mechanical loadability, i.e. flexibility. This is for example particularly advantageous in the production of flexible scratch protection layers which, in the case of an almost carbon-free coating, are very brittle and break under mechanical loading.

The loadability of the layers generated in the method according to the invention can be quantitatively detected by determining the layer hardness and the modulus of elasticity. The person skilled in the art is aware of various methods for this purpose, for example nanoindentation (Berkovich indentor, method of Oliver & Pharr: W. C. Oliver, G. M. Pharr; J. Mater. Res. Vol. 7, No. 6 (1992) 1564, multiple partial unloading method: K. I. Schiffmann, R. L. A. Küster; Z. Metallkunde 95 (2004) 311) or the analysis of laser-acoustic surface waves. Preference is given to layer hardnesses in the range of from 0.4 GPa to 4 GPa, more preferably 1 GPa to 4 Gpa, determined by nanoindentation in accordance with the aforementioned method.

It has surprisingly been found that in a preferred method according to the invention the method can be carried out in such a way that the resulting coating displays, at a bending radius of 2.5 mm, no cracks which may be optically discerned by the naked eye or up to a 1,000-fold resolution under a light microscope. More preferably, the method according to the invention is carried out in such a way that this applies to a bending radius of 1 mm, more preferably 0.5 mm (for determining the flexibility of the coating, reference is also made to Example 21 “flexible coating”).

In addition, certain tests have revealed that surprisingly not only the fact that carbon is contained in a crosslinked layer, but also the nature of the bonding of the carbon, is advantageous: the important thing for the layers generated in the method according to the invention is that key parts of the carbon (contents cf. also hereinbefore) are bound into the layer in a manner other than via a methoxy or alkoxy group. Particularly important in this regard are Si—C bonds which have a positive effect on the different layer properties. The person skilled in the art can control the bonds which are actually set by taking suitable measures (as indicated hereinbefore), such as for example selection of the precursors, degree of fragmentation of the precursors or possibly the atmosphere during the crosslinking process.

It was surprising that the method according to the invention allows a large number of different layers to be produced. It is particularly surprising that the layers produced by means of the method according to the invention may be formed rapidly and without cracks both under normal atmospheric conditions and under different types of atmospheres. In this case, the original thickness of the precursor layer applied can decrease during the curing by more than 50%. The layers generated by means of the method according to the invention can therefore preferably have, after the crosslinking, accordingly a thickness of from 2 nm to 5 μm, preferably 5 nm to 2 μm, more preferably 10 nm to 1 μm. Particularly preferred layers have a thickness of from 20 nm to 500 nm.

2.2.1 General Description of the Method:

In the method according to the invention, liquid precursors are, as indicated hereinbefore, excited by photons and converted into a crosslinked layer by means of high-energy radiation, particularly preferably high-energy UV radiation, preferably by excimer lamps. In this case, the excitation will be carried out for example by breaking chemical bonds. The substrate, on which the crosslinking reaction takes place, is in principle freely selectable. It will be readily comprehensible to the person skilled in the art that the number of precursors which may be used (liquid state) may be extended by way of suitable reaction temperatures (for example low temperature). However, under certain circumstances, the evaporation of specific contents of the originally liquid precursor layer may also be desirable.

It goes without saying that the precursors to be crosslinked must contain chain-forming atoms such as carbon and/or silicon. During the crosslinking reaction gas molecules may—depending on the conducting of the reaction—also participate in the reaction in the region of the surface of the layer to be crosslinked. These gas molecules may originate both from the atmosphere and from the originally provided mixture. This opens up for the person skilled in the art a number of possibilities for suitable conducting of the method.

As a result of the radiation used, in particular in the case of UV radiation of a wavelength of ≦250 nm, the precursors are fragmented. This produces excited radical or ionic molecular fragments which can react with one another and form, as the irradiation advances, a three-dimensional network on the surface to be coated. In the case of a suitable surface (if appropriate after preparation thereof, for example cleaning and/or activation), a reaction which binds the resulting layer to the surface also takes place at the same time as the crosslinking reaction. In particular, reactions with the surface to be coated can take place as a result of radicals or ions which are formed at the interface between the layer to be crosslinked and the surface to be coated and are generated from the precursors.

2.2.2 General Layer Properties:

The layers produced by the method according to the invention are similar to plasma polymers. They are amorphous and three-dimensionally crosslinked. In this case, the radiation sources to be used in accordance with the invention have an outstanding penetration depth in view of the layer thicknesses preferred in accordance with the invention, thus allowing a coating which is crosslinked comparatively homogeneously in the depth profile to be generated. The material composition of the layers generated is also surprisingly homogeneous.

The layers generated using the method according to the invention may be configured in a broad range of manners with regard to their properties: their thermal, mechanical and chemical properties can be configured in a broad range of manners by suitably conducting the method such as duration of the exposure to radiation, atmosphere under which the curing takes place, and of course the precursor material.

The layers generated in accordance with the invention may be very similar to plasma polymers, although they differ from plasma polymers inter alia in that they do not reproduce technical surfaces in the submicrometer range, as the starting material is, unlike in the plasma polymerization, a liquid.

Before the liquid has been crosslinked, it can migrate, as a result of the capillary effect, into pores which are present in the surface or fill up, following gravity, the troughs of a surface profile, so that a greater layer thickness is achieved in the troughs than on the profile peaks. The inverse case is also conceivable, in which the surface is oriented downward and thus the liquid collects preferably at the profile peaks and sheaths the peaks in a targeted manner. Furthermore, a liquid having low surface tension can spread over time over, i.e. uniformly cover, the entire surface or a liquid having high surface tension can contract to form droplets. The aforementioned phenomena may be recognized, for example in the case of reflective surfaces and a sufficiently thin coating under a light microscope, by way of corresponding interference colors. Likewise, a liquid which is initially applied at the start of the method may be recognized by way of characteristic interference colors around dust particles (cf. also the following in this regard).

However, depending on the starting material, crosslinked layers produced by the method according to the invention may be distinguished still further from plasma polymers, since the liquid precursors which may be used in the method according to the invention, in particular for (excimer-)crosslinked (excimer-cured) functional coatings, are preferably relatively long-chain precursors and have a low steam pressure, preferably at 23° C. of <0.5 HPa, more preferably of <0.25 HPa and particularly preferably <0.1 HPa. Therefore, if the crosslinking conditions are selected in such a way that only a low degree of crosslinking is produced (for example as a result of comparatively short irradiation), even longer chain segments of the precursor may be preserved in the crosslinked layer. This allows setting, for the layer, of properties which are similar to thermoset materials or else elastomers and also of those which are similar to plasma-polymeric layers. Corresponding diversity is possible, in particular, as a result of the provision of carbon in the layers produced by the method according to the invention.

Although layers which are more homogeneous than a number of crosslinking methods from the prior art are generated by means of the method according to the invention, these layers display, with regard to the degree of crosslinking in comparison to plasma-polymeric coatings deposited under constant conditions, a somewhat higher degree of crosslinking at the surface (that is the side from which the action of the radiation strikes the layer) than on the side remote from the surface to be coated (substrate).

It is also characteristic of layers crosslinked in the method according to the invention that they display, in particular at layer thicknesses of above 200 nm, in the case of a single coating at the upper side, a higher degree of crosslinking than on the side facing the substrate, albeit to a much lesser degree than comparable layers which were crosslinked with the aid of a plasma method.

2.2.3 Procedural Advantages

The coating method according to the invention combines many advantages over known coating methods (such as for example gas-phase plasma polymerization processes):
The radiation used for curing the coating, in particular UV light, can be applied in a locally limited manner as a result of the use of lasers or screens. Unlike in plasma-polymeric coatings, there is no need for covers which are flush with the gap.
The method can be conducted in the low-pressure range, although low pressure is not necessary. The person skilled in the art decides, depending on the manner in which the process is conducted, whether an inert gas atmosphere is if appropriate used.
Frequently, shorter processing times may be achieved, for example compared to plasma polymerization processes or sol-gel coatings.
The equipment cost is comparatively low or can be kept low.
The surface is not subjected to any electrons or ion irradiation.
Low heating of the surface.
In most cases, no toxic gases are produced or the gas load is very much lower. (Exception: the formation of ozone during treatment under ambient atmosphere)
As a result of the fact that no chain growth reactions are initiated during the curing, the curing is limited to the region subjected to the radiation.
It is thus possible to generate a high contour sharpness such as is required in particular in lithographic areas of application (for example nanoprint technology, step and flash implant lithography).
The liquid precursor also penetrates pores and depressions and also undercuts and thus allows, in contrast for example to plasma-polymeric coatings, error-free coatings.
Effects which are based on the use of the liquid precursor and influence the layer thickness distribution (homogeneous, pore-filling, spreading, droplet formation, etc.), may be utilized to increase the broad range of functionalizations.
Thin layers, preferably in the nanometer range, may be generated.
Greater layer thicknesses (1 μm and more) are easier and more economical to achieve than in plasma polymerization.
Fillers or additives may be incorporated into the layer.
The configuration of the layers is more variable with regard to its composition, as there is for example no need to take account of photoinitiators. The layers which are produced are free from reaction auxiliaries or the reaction products thereof. This relates in particular to photoinitiators as the reaction auxiliary.
Compared to conventional UV-curing paint systems, more economical coating materials may be used (for example no photoinitiators are required); their storage conditions are generally much more beneficial.
Environmentally friendly methods and contaminant-free coatings are possible.
Crosslinking by means of UV radiation is generally more economical than electron beam curing owing to more economical installations and fewer required safety precautions.
The properties of the layer which is produced are for example very broadly controllable by way of the parameters “precursor used” and “generated degree of crosslinking”.

2.3 Delimitation Against the Prior Art

Polymeric Layers

By way of prior art, a large number of layer-forming methods involve radical or ionic chain growth reactions which are commenced by a chain initiation reaction and are frequently ended by chain termination reactions. Typically, the free radicals for the chain initiation are provided by irradiated photoinitiators. They ensure a chain reaction of the principally present reactive molecules (precursors, frequently monomers or oligomers). Recent developments use UV radiation to ionize or to radicalize reactive precursors directly (without a photoinitiator) and to initiate the polymerization chain reaction. The layers produced from this method are polymeric layers in the conventional sense that differ, with regard to their structure/property relationship, from the crosslinked layers obtained in the method according to the invention.

Plasma-Polymeric Layers

Features distinguishing between a plasma polymer layer and a coating generated by the method according to the invention may be found primarily based on the production process:

Optical Distinction

Provided that the layer thicknesses are in the range below 5 μm, the coatings become optically perceptible to the viewer as a result of a color impression produced by interference. The color impression is dependent on the optical path which the light takes in the coating material. That is to say, the color impression is dependent on the index of refraction (this is defined by the coating material), on the viewing angle (this is dependent on the position of the viewer and of the surface normal (perpendicular line on the substrate surface)) and finally on the layer thickness. In an optimum, i.e. uniform, coating process, a smooth surface has homogeneous coloring, the color of which varies with the viewing angle.

The plasma polymer layer is deposited out of the gas phase and is a three-dimensionally strongly crosslinked macromolecule. The plasma polymer coatings are dimensionally stable, i.e. the contours are provided, into the submicrometer range, with a uniformly thick coating. Nevertheless, differences occur in the layer thickness that are determined above all by the component geometry and installation geometry which influence the distribution of the gaseous plasma and thus the local deposition rate.

In the case of a plasma-polymeric coating, the entire component surface which was subjected to the plasma is coated. Deviations in the layer thickness of the plasma polymer coating are closely linked to the symmetries of the components and the local regions of the surface with layer thickness gradients assume lateral extensions in the size range of the component. For example, an edge is a disruption of the smooth surface and is discernible inter alia as a result of the fact that a layer thickness gradient is produced toward the edge. Accordingly, a color course is optically perceived in accordance with the course of the edge. The behavior is similar in the case of a depression, a bore or a pore in the surface of the component.

For example, only a minor gas exchange takes place in blind holes or similar depressions, so that there the layer thickness decreases markedly. This produces layer thickness gradients which are symmetrical to the surface structure, i.e. in this case to the blind hole. It may be noted that the reactive plasma gas cannot penetrate in any desired fashion a bore or a pore and accordingly thinner layer thicknesses are produced up to the coating hole. On the other hand, edges or peaks are often coated particularly thickly, as there gas vortexes can form or the electrical radiation required for forming plasmas is effectively coupled in.

In addition, in practice, layer thickness gradients are produced as a result of the inhomogeneity of the plasma. Generally, there exist in a plasma chamber, as a result of the position of the electrodes, as a result of the position of nozzles for introducing process gases or as a result of pumping-off, sealing gradients which ultimately also lead to a differently thick coating. These sealing gradients are generally great compared to the dimensions of the components to be coated, so that these dimensions are negligible.

Furthermore, it is likely that dust will land during the coating process on the surface of the body to be coated. Dust does not influence the local coating rate. The dust particles cover the surface positioned therebelow so that, for example by wiping away, a locally lower layer thickness is identified, at the position of the grain of dust, as a narrowly delimited surface defect; a layer thickness gradient may not be discerned. If the layer thickness is sufficiently great, grains of dust may also be incorporated into the coating.

In contrast thereto, the method according to the invention uses a liquid film in the first method step. Provided that the layer forming this film is not completely crosslinked, the liquid film may be regarded as being liquid, and thus as being dynamic, and may cause, as a result of the existing energy balances, local differences in layer thickness in the system consisting of the surface, ambient gas and liquid. If the surface energy of the surface of the component is high and the surface tension of the liquid is low, then the liquid can for example spray, i.e. the liquid forms a very thin film. In the inverse case, the liquid forms drops having a contact angle which is characteristic of the energy conditions.

The dimensions of the regions within which layer thickness gradients occur, owing to the dynamic movement of the liquid, and which are perceived for the viewer, as a result of interference effects, as being different spectral colors, are dependent on the forces of cohesion and adhesion of the liquid or the surface of the component. Generally, lateral dimensions in the μm to mm range are to be expected for the regions within which layer thickness gradients occur.

The system of the applied but not yet crosslinked liquid may thus be regarded as being dynamic and local differences in layer thickness are formed, owing to the energy conditions, even in the case of a homogeneously drawn-up liquid film. These layer thickness gradients are frozen with the crosslinking as a result of irradiation in the coating. The differences in layer thickness become optically perceptible, as a result of interference effects, as differences in color.

In particular, minor differences in layer thickness, which cannot be resolved by eye, can form in the liquid over the entire surface over time on regions having a lateral extension of below 100 μm. The differences in color may be discerned with the aid of a microscope and also be recovered in the crosslinked coating. These layer thickness inhomogeneities may have a round shape, a locally limited statistical polygonal shape or be described as wave patterns or streaks.

In contrast to the plasma-polymeric coating, these local layer thickness inhomogeneities may be located on the entire surface of the component and are independent of the geometry of the component.

Dust on the not-yet-crosslinked liquid film becomes perceptible in the manner in which the three-phase system consisting of the surface, liquid and surrounding gas is disturbed and must be locally extended by the interaction with the grain of dust. A meniscus, which significantly changes the layer thickness locally to lateral dimensions of a few hundred μm, is generally formed around the grain of dust. Differences of several hundred nanometers can occur locally here, so that the interference colors on the smallest dimension pass through a plurality of colors.

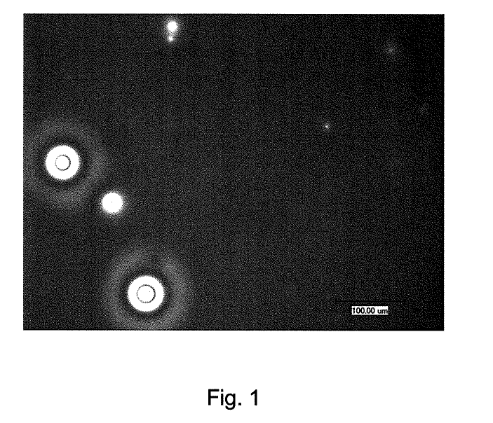

FIG. 1 shows a plurality of layer thickness inhomogeneities of this type through grains of dust.

FIG. 1 is a micrograph of the UV radiation-treated pattern B8 (from Example 1, see there) with typical coating inhomogeneities through particles of dirt.

Menisci are likewise produced in the region of edges and corners. The lateral extension of these menisci is independent of the dimension of the surface to be coated. The lateral extension is dependent on the forces of cohesion and adhesion of the liquid or the surface of the component and the lateral dimensions are generally in the μm to mm range.

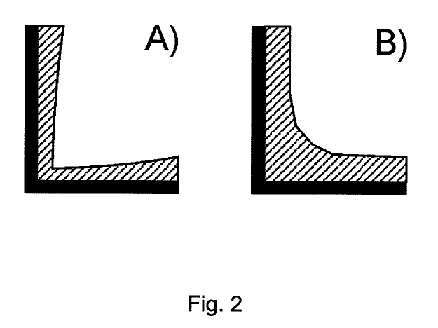

FIG. 2A shows the course of a plasma-polymeric layer in the region of a corner of the surface to be coated; FIG. 2B shows a corresponding layer generated by a method according to the invention.

Particularly clear differences are obtained during the coating of surfaces with structures in the μm range. Examples of this include technical surfaces having roughness, i.e. a non-uniform sequence of elevations and depressions on the surface of the component, or uniformly structured surfaces.

Surface structures of this type are coated in a dimensionally stable manner using the plasma method. The coated surface has almost the same roughness as the uncoated surface. If pores are located on the surface, then the aspect ratio (ratio between the depth and diameter) of the pore determines the deposited layer thickness of the plasma polymer layer. In the case of disadvantageous ratios, the base of the pore is not coated. A high plasma-polymeric layer thickness can, on the other hand, lead to the pore being closed at the surface.

During curing of a liquid film, marked influencing of the surface structure is to be expected. The applied liquid will preferably enter the depressions of the structures; if appropriate, complete but slightly inhomogeneous coverage is achieved. After crosslinking of the liquid, a smoothing of the structures, for example of the roughness, is to be expected; pores are closed.

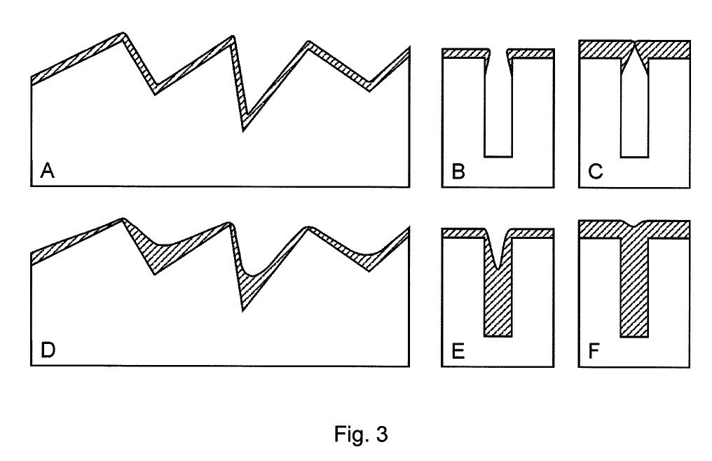

To demonstrate the differences, cf. FIG. 3:

FIG. 3 shows the coating of surface structures with a plasma-polymeric layer (A, B, C) and a layer (D, E, F) produced by a method according to the invention. In this case, FIGS. 3A and 3D each demonstrate the surface course of the respective layer on a rough surface, Figures B and E show an in each case comparatively thin layer in the region of a pore and Figures C and F show a comparatively thick layer in the region of a pore.

Distinguishing with the Aid of IR Spectroscopy

Furthermore, it is possible to distinguish between a plasma-polymeric coating and a coating generated by a method according to the invention with the aid of the examination of the IR spectra. The plasma-polymeric layer is deposited out of the gas phase. A short-chain, gaseous precursor is used for this purpose. The length of the molecule determines the ratio of the repetition unit groups to end groups of the precursor. For example, HMDSO (hexamethyldisiloxane), which is gaseous at room temperature, has two Si(CH₃)₃ end groups and no —O—Si(CH₃)₂ repetition units. The silicone oil AK10000, which is liquid at room temperature, has a much longer molecular chain. AK10000 also has two Si(CH₃)₃ end groups and ˜500 —O—Si(CH₃)₂ repetition units and thus a clearly distinguishable ratio of end groups to repetition units. The relative ratio between end groups and repetition units can be determined with the aid of IR spectroscopy. In principle, this thus provides a suitable tool which can be used to draw the distinction between the original use of a gaseous precursor and a liquid precursor.

During plasma polymerization the gaseous precursor is fragmented in an electrical field. A reactive plasma is shaped as a result. The reactive short-chain fragments form, after deposition on the component to be coated, a three-dimensionally crosslinked macromolecule. A hydrophobic plasma-polymeric coating is distinguished in that the gaseous precursor which is used is not fragmented too intensively and therefore a large number of Si(CH₃)₃ end groups are incorporated into the coating.

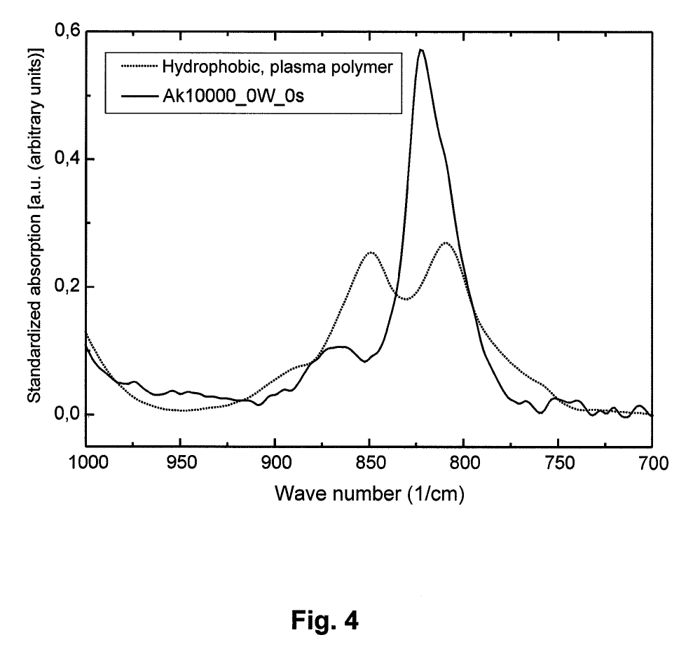

By way of illustration, reference is made to the example shown in FIG. 4 of a hydrophobic coating.

FIG. 4 shows the IR spectrum (ERAS) of a hydrophobic plasma-polymeric coating and of the untreated liquid silicon oil AK10000.

In the case of the hydrophobic plasma polymer coating, bands may clearly be seen for the Si(CH₃)₃ end group (monofunctional siloxane units) at approx. 850 1/cm and for the Si(CH₃)₂ bridges (difunctional siloxane units) at approx. 810 1/cm. The non-treated AK10000 silicone oil displays, on the other hand, in the IR spectrum substantially a signal at approx. 820 1/cm which can be assigned to the —O—Si(CH₃)₂ repetition units (difunctional siloxane units). The band at approx. 843 1/cm is to be assigned to the Si(CH₃)₃ end groups (monofunctional siloxane units). Owing to the low proportion of the end groups, only a very weak band is obtained here.

The coating method according to the invention starts from relatively long-chain precursors (molecules having a molecular weight of greater than 600 g/mol.). Plasma polymerization, on the other hand, operates with precursors having a lower molecular weight, as these precursors are supplied to the plasma via the gas phase. A feature distinguishing between both layers may be derived from the difference in molecular size. As stated above, the ratio between the end groups and the repetition units can be analyzed spectroscopically. This requires the associated bands first to be identified; this entails the meticulous assignment of all the bands in the IR spectrum in the environment to the bands in question (band positions are generally retrievable in the literature). With the aid of the band positions, the bands of the end groups and repetition units may be analyzed using recognized methods (curve fitting). Generally, the areas below the bands in the IR spectrum are determined.

For the coating according to the invention, a ratio of end groups (n_{End}) to repetition units (n_{WE}) of less than 0.1, particularly preferably less than 0.05, is preferred.

For organosilicon coatings based on PDMS (as the precursor), preference is given to a coating, the IR spectrum of which displays a ratio of the area under the band of the —O—Si(CH₃)₂ repetition units at approx. 845 cm⁻¹ (A_{845 cm-1}) to the area under the band of the Si(CH₃)₃ end groups at approx. 815 cm⁻¹ (A_{815 cm-1}) of less than 0.2. In this case, the wave numbers of the associated bands may vary by up to 12 cm⁻¹.

In the case of a hydrophobic, plasma-polymeric coating, the bands of the end groups (A_{845 cm-1}) and repetition units (A_{815 cm-1}) are, as shown in FIG. 4, clearly visible. In this case, the ratio without precise determination is about 1:1 and thus the hydrophobic, plasma-polymeric coating may be clearly distinguished from the layers generated in the method according to the invention. In the case of a coating according to the invention with AK50 as the base, the bands of the end groups (A_{845 cm-1}) are negligible compared to those of the repetition units (A_{815 cm-1}).

In the organosilicon plasma-polymeric coating, a reduced ratio between end groups and repetition units is, in the case of a hydrophilic coating, to be expected, compared to the hydrophobic coatings, owing to the more intensive fragmentation of the precursor. However, within the scope of the invention, the minimum content of carbon, for example the residual content of methyl groups, ensures that the ratio between end groups and repetition units may be determined, given suitable equipment and sufficient accuracy. This ratio is, even in corresponding hydrophilic, plasma-polymeric layers, above the specified value of 0.1, preferably below 0.05.

As a result, it is possible to distinguish, by way of inferences as to the precursors used, plasma-polymeric layers from layers produced in the method according to the invention.

As a result of high-energy, in particular excimer lamp, irradiation, the bonds of the applied silicone oil are broken open and the reactive groups which are produced lead to a three-dimensional crosslinking of the liquid film.

Owing to the properties of the layers generated in the coating method according to the invention, it is therefore in principle possible to distinguish, based on IR spectra, for example between a coating generated by the method according to the invention and a plasma-polymeric hydrophobic coating. The starting material of a plasma-polymeric coating is a gaseous short-chain precursor; the starting material of the coating generated in accordance with the invention is a liquid, preferably having much longer molecular chains (long-chain precursor). Accordingly, different ratios are provided in relation to the specific end groups and repeating units, which ratios may be distinguished based on IR spectroscopy.

In the plasma-polymeric coating and in the (UV) radiation-induced coating generated in accordance with the invention, a crosslinking of the individual molecular chains is generated. The degree of crosslinking determines to what extent end groups and repeating units occur in the IR spectrum as characteristic bands. In the case of hydrophobic plasma-polymeric coatings and coatings which are generated in accordance with the invention and have a moderate degree of crosslinking (and are also hydrophobic), both types of layer may therefore be clearly distinguished with the aid of IR spectroscopy.

This observation also applies to monomers other than the illustrated HMDSO or to liquids other than the PDMS silicone oils used.

Plasma-Crosslinked Layers

From the prior art, DE 40 19 539 A1 discloses in particular a plasma-crosslinked layer produced from the precursors to be used in the method according to the invention. Examples 1 and 2 (cf. DE 40 19 539 A1) point up possible distinctions, with the aid of which layers which were produced by means of the method according to the invention may be delimited. In this regard, reference is made to Examples 1 and 2.

In particular, layers produced by the method according to the invention are distinguished in that the C signal displays in the depth profile of the time of flight-secondary ion mass spectrometry (TOF-SIMS) profile, on standardization of the intensities to the silicon signal, a course which is substantially parallel to the X axis (sputtering cycles).

A further feature for distinguishing between a plasma-crosslinked coating and a coating according to the invention is obtained for an applied liquid layer thickness of above 300 nm. During the plasma crosslinking there occur in the aforementioned layer thicknesses major crosslinking differences between the surface-near and substrate-near regions of the thin layer, which differences lead, on complete crosslinking, to high layer stresses. In so far as complete crosslinking is to be implemented, with adhesive binding to the substrate, via a plasma, cracks occur owing to the stresses. The cracks may generally be perceived by the naked eye, but at the latest with the aid of a microscope. Crack structures of this type are not observed in the coating according to the invention owing to a much more intensive depth treatment.

Even if it is assumed that the plasma crosslinking of the precursors is carried out substantially using the UV radiation which originates from the plasma, clear differences may nevertheless be identified: In the plasma, electromagnetic radiation is generated in a very broad spectral range, from the hard VUV range (<100 nm) into the IR range. This broad bandwidth of the factually active wavelengths leads to a gradient in the depth profile of the resulting coatings (cf. also hereinbefore). Furthermore, rapid electrons, molecules, excited particles, ions and molecular fragments are also regularly active, during UV crosslinking by means of radiation from the plasma, as constituents of a plasma during the formation of layers. A surface, in particular a liquid precursor layer which is subjected to the plasma, regularly interacts with all of the constituents of the plasma. These total interactions lead to the production, as described above, of very intensive superficial crosslinking with a high stress gradient. These stresses are responsible for the regularly occurring visible cracks, in particular at applied precursor liquid layer thicknesses of more than 250 nm.

The person skilled in the art can already recognize the cracks without auxiliary means, at the latest with the aid of a microscope. Typically, a non-uniform network of cracks may be seen; the cracks have widths often in the μm range; the length of the cracks which may be seen under the microscope is in the μm to mm range. An example of microcrack formation of this type is shown in FIG. 10 which is a micrograph of a plasma-crosslinked oil layer (AK10000) having an average layer thickness of 250 nm.

The person skilled in the art may easily draw a distinction between plasma-crosslinked layers and layers produced using the method according to the invention based on the formation of cracks, for example by means of scattered light measurements (similar to the determination of scratch marks in the Taber abrasion test, DIN 52347) or in the sand trickling test for transparent materials (DIN 52348).

As it may be assumed that the results found in the examples (see below) may be generalized, layers produced by the method according to the invention, but in particular preferred hydrophobic layers which are produced by the method according to the invention and have water contact angles of >50°, may clearly be distinguished from the prior art. Of course, the person skilled in the art also has for this purpose a number of other methods for distinguishing with regard to the method for producing the respective layer that he will use, depending on the composition of the layer to be examined, for distinguishing layers which are produced or can be produced by the method according to the invention from other layers, in particular optical methods for assessing layer thickness gradients.

Accordingly, the invention also includes a crosslinked layer which can be produced by means of a method according to the invention.

Preference is in this case given to a layer of the type in which the C signal displays in the depth profile of the time of flight-secondary ion mass spectrometry (TOF-SIMS) profile, on standardization of the intensities to the silicon signal, a course which is substantially parallel to the X axis (sputtering cycles).

A preferred item according to the invention has a surface structured in the submicrometer range, comprising on this surface at least partially a crosslinked layer according to the invention which in the submicrometer range does not reproduce the contour.

More preferred is an item according to the invention, wherein for the crosslinked layer, the C signal displays in the depth profile of the time of flight-secondary ion mass spectrometry profile, on standardization of the intensities to the Si signal, a course which is substantially parallel to the X axis (sputtering cycles), particularly preferably down to a depth of 5 μm.

Preference is given to an item according to the invention or to a layer according to the invention, wherein the crosslinked layer is excimer-crosslinked.

3. Precursors which May be Used

Preferred precursors to be used are listed hereinafter:

3.1 Silicone Compounds

Synthetic polymeric compounds in which silicon atoms are linked in a chain-like manner via oxygen atoms and the remaining valencies of the silicon are saturated by hydrocarbon residues (in particular methyl groups, but also ethyl groups, propyl groups, phenyl groups and the like) or fluorohydrocarbon groups. In this case, the molecular chains may be linear, branched or cyclical. Non-functionalized silicones are preferred. Examples include PDMS silicone oils or corresponding fluorosilicones in which the methyl groups have been partially or completely replaced by fluoroalkyl groups.

3.2 Partially and Fully Fluorinated Carbon Compounds

Saturated and if appropriate fluorinated, perfluorinated hydrocarbons, for example polytetrafluorethylene, perfluoroethylene propylene (FEP), perfluorinated alkyl carboxylic acids, perfluoroalkoxy polymers.

3.3 Halogen-Free, Organic Liquids

Hydrocarbons, fatty acids, triglycerides, mineral oils, polyethers.

As will be apparent from the foregoing, the precursors, as starting substances for the method according to the invention, are not limited to organosilicon substances. The starting substances used may also be hydrocarbons, fatty acids, triglycerides, mineral oils, polyethers, fluorinated or partially fluorinated oils. In this case, the precursors may, within the scope of this invention, be a pure substance or else a mix of substances. The person skilled in the art will select the starting substances in particular in accordance with the function required for the corresponding layers. For example, the use of fluorinated oils as precursors allows the production of coatings having PTFE-like properties, such as for example acid resistance, repellent, parting properties or else sliding properties.

4. Fillers and Additive which May be Used

In the method according to the invention the mixture containing the precursors to be crosslinked can also comprise further constituents. Constituents of this type can purposefully be used to impart specific functions to the layers produced in the method according to the invention. The person skilled in the art will take care to ensure that the fillers and additives incur as little damage as possible during the curing of the precursors. This is particularly important if use is made of organic additives which are UV-sensitive. The precursor used in each case should start to crosslink much more rapidly than significant changes to the additives occur. The fillers and additives may for example be compounds or mixtures of compounds from the individual substances or substance groups listed hereinafter:
Marking substances, preferably selected from the group consisting of dyes, chromophores, magnetizable particles, complexed nanoparticles, light-scattering substances, dye pigments or luminescent pigments such as for example fluorescent or phosphorescent substances.
Parting agents or slip additives, in particular metal soaps of fatty acids, siloxane resins, paraffin waxes, fats, polymers or inorganic powders (such as graphite, talc and mica).
Substances assisting sliding of surfaces, antimicrobial active substances, fungicides, insecticides, bactericides, algicides, viricides, pesticides, (bio)catalysts, enzymes, hormones, proteins, nutrients, pheromones, medically effective substances, organoleptic active substances, in particular odorous and aromatic substances, emulsifiers, surfactants, growth substances such as growth regulators, in particular for bone growth, UV absorbers, photochromic or electrochromic substances, reflective substances, conductive substances, waxes, oils, lubricants, in particular metal soaps, organic soaps, sulfonated and sulfated compounds, quaternary ammonium compounds, phosphatides, amphoteric surfactants, bitterins, fatty alcohols, propylene glycol monostearate, partial fatty acid esters, polyhydric alcohols with saturated fatty acids, polyoxide ethylene esters of fatty acids, polyoxyethylene ethers of fatty acids and polymerization products of ethylene oxide and propylene oxide or propylene glycol, solid particles having primary particle sizes of up to 200 nm, in particular silver oxide or titanium oxide particles, conductive substances, corrosion protection inhibitors, dyes, luminescence dyes, in particular electroluminescent, cytoluminescent, chemiluminescent, bioluminescent, thermoluminescent, sonoluminescent, fluorescent and/or phosphorus luminescent luminescence dyes, organic or inorganic coloring pigments, magnetic substances, organic or inorganic solid particles having primary particle sizes of up to 100 μm, preferably up to 20 μm and particularly preferably up to 10 μm, in particular metals such as silver, copper, nickel, aluminum, metal alloys, semiconductor metal oxides such as those of titanium, tin, indium, zinc or aluminum, non-metals, non-metal compounds, salts (for example salts of organic and inorganic acids, metal salts), zinc sulfite, magnetite, silicon oxide, boron nitrite, graphite, organic solids, preferably nanofillers having a large number of crosslinking points, carbon particles, liquid crystals.
particles, organic or inorganic, preferably having a diameter in the order of magnitude of from 10 nm to 10 μm, preferably 20 nm to 5 μm, particularly preferably 50 nm to 2 μm. Particles, round shape or flat having a diameter of from 10 nm to 10 μm, preferably 20 nm to 5 μm, particularly preferably 50 nm to 2 μm. Particle agglomerates, round or flat having a diameter in the order of magnitude of from 10 nm to 10 μm, preferably 20 nm to 5 μm, particularly preferably 50 nm to 2 μm.

5. Coating Methods

The person skilled in the art is familiar with a number of coating methods to apply, when carrying out the method according to the invention, the liquid layer to the surface to be coated. Preferably, these methods are configured in such a way that the mixture, comprising or consisting of inactive liquid precursors, is applied uniformly.

Preferred application methods for this purpose are:
Spin coating, dip and drain coating, aerosol application methods, various spraying and atomization methods, for example using high-pressure nozzles, ultrasonic atomizers, rotary atomizers, additional introduction of gas, if appropriate using additional rapidly volatile compounds such as for example solvents or slowly evaporating substances such as for example water; doctor blades, brushes, also manual application by wiping, stamping, printing (for example pad printing), utilizing the spreading and migration properties of silicone oils and mineral oils.
Partial or local application: for example by printing, spraying, optionally with masks, partial dipping; also manual partial removal of the applied liquid film.
Planar application at a different layer thickness, for example induced by the roughness of the substrate (higher layer thickness in the troughs, low layer thickness on the peaks), induced by different pretreatment methods (for example by partial activation/partial cleaning); by a differing drawing speed in the dipping method (dip, drain coating), use of various doctor blades, etc.
Combinations of the aforementioned coating methods.

In the aforementioned methods, the surface to be coated can during the application of the liquid be displaced, be rotated or otherwise moved or the application unit can be moved relative to the substrate in order to apply the desired layer thickness homogeneously or inhomogeneously or with a layer thickness gradient to the entire area or to a partial area.

The application can be carried out can be carried out punctiformly, linearly, in a curved manner, 2-dimensionally, 3-dimensionally, in the shape of a regular pattern or statistically or with the aid of a mask or otherwise onto the selected regions.

Some of the aforementioned application methods apply the liquid film by way of a distribution of droplets. Although some of the orders of magnitude differ considerably, these methods have in common the fact that complete coverage of the surface is achieved by placing a large number of individual drops one above another and one next to another. Of course, this produces local differences in the layer thickness. It is quite possible for this distribution to be desirable, if this allows special layer properties to be realized. In order nevertheless to achieve compensation for the layer thickness, the substrate can be treated, following the actual application of liquid, with one or more of the following measures:
The substrate can be moved mechanically, i.e. shaken or rotated, in order to distribute the liquid uniformly.
The viscosity of the liquid can be lowered by heating, for example in an oven, by irradiation with IR light, by ion bombardment or other methods known to the person skilled in the art. This increases the flowability of the liquid film, so that the droplets can flow into one another.
The substrate can be subjected to a solvent-containing atmosphere, so that the liquid film is diluted and thus made more free-flowing. The dilution can be assisted by a lower temperature of the substrate compared to the atmosphere. The solvent subsequently evaporates after removal of the solvent-containing atmosphere.

6. Substrates/Surfaces

As described hereinbefore, the coating of a broad range of surfaces is possible on appropriate selection of the precursors. In this case, it may be preferable to activate (or passivate) the surfaces by way of a suitable method, thus providing improved (or, as required, weakened) adhesion of the crosslinked layer on the surface.

Suitable methods for the surface pretreatment are for example plasma activation, flame impingement, corona treatment, laser pretreatment, fluorination, also activation by irradiation with UV light, mechanical pretreatments (for example blasting, grinding, brushing, polishing), chemical pretreatments (for example cleaning, scouring, etching, passivating), electrochemical pretreatments (for example electropolishing, anodizing, electroplating), coatings (for example by means of PVD, CVD, plasma, sol-gel or painting methods).

Preferred surfaces (or substrates) are metals, glasses, ceramics, plastics materials, including in particular PTFE and PTFE-like substances, composite materials, natural substances (such as wood, paper, natural fibers), textiles, fibers, woven fabrics, and also glossy, highly reflective surfaces, rough surfaces, transparent materials such as for example glasses or polymers, dyed, partially transparent materials, non-transparent materials.

Further preferred surfaces are 2D bodies having (flat) surfaces for partial coating or coating on all sides, web materials, fibers, 2D surfaces having a slightly curved surface, 3D bodies having (flat) surfaces for partial coating or coating on all sides.

7. General Information Concerning the Conducting of the Method

In order to instruct the person skilled in the art to produce the coating according to the invention for the purpose of orientation, procedural assistance will be specified hereinafter:

Pretreatment of the Surface

Cleaning

Depending on the desired coating, it may be beneficial to pretreat the surface of the body to be coated. This refers substantially to the aspects of cleaning and activation.

In order to achieve good coating results, clean surfaces must generally be used. Dirt, finger marks, shavings, dust, etc. lead to coating errors and must generally be removed in accordance with the prior art. It is, for example, the case that solvents for cleaning must generally be selected as a function of the soiling and the surface to be cleaned. Mechanical pretreatments are for example blasting, grinding, brushing, polishing; chemical pretreatments are for example cleaning, scouring, etching, passivating; electrochemical pretreatments are for example electropolishing, anodizing, electroplating.

Provided that the surfaces to be coated are not tainted with fats, oils or other impurities, manual wiping with a soft, isopropanol-saturated cloth is sufficient for simple cleaning. Dust can for example be blown off with compressed air.

In so far as thin-layered organic impurities are present on the surface below 100 nm, these can be broken down by irradiation with VUV light (vacuum ultraviolet radiation at a wavelength of <190 nm), preferably from an excimer lamp in the presence of oxygen. It is possible for the person skilled in the art himself to select the radiation dosage as a function of the contamination and to evaluate the cleaning success.

Activation

As functional groups are incorporated by activation into the surface of the body to be coated, the functional groups generally have a positive effect on layer adhesion. Routine activation is therefore generally advisable.

In order to implement thin, uniform liquid layers, it is necessary for the precursor used to spread on the surface. In order to meet this condition, the person skilled in the art can, for example, determine the solid body surface tension of the substrate (the surface to be coated) and if appropriate increase it by way of an activation process. Irrespective of the material to be coated, a solid body surface tension of preferably above 45 mN/m, more preferably above 60 mN/m, is to be set. A number of technologies are available for activation. Activation in an oxygen plasma or activation of the surface by an excimer lamp (for example 120 secs under an ambient atmosphere or 60 secs irradiation in oxygen at a pressure of 100 mbar) are preferred.

Especially in the coating of polymers, an increase of the solid body surface tension is helpful; in metals, activation may, if no other reasons call for it, be dispensed with.

In particular, activation is preferable in the presentation of corrosion protection layers, tarnish protection layers, adhesion promoter and primer layers, electrical insulation layers, barrier layers, and smoothing or sealing layers.

For non-uniform, non-closed (partially closed) coatings, activation may be dispensed with. These include for example the anti-fingerprint coating.

For certain types of coating, such as for example the structured, topography-imparting coating, increasing the solid body surface tension can be counterproductive. This utilizes the effect that the precursor forms droplets on the surface. In the case of polymers to be coated, no pretreatment is therefore necessary owing to the low surface energy. Metals and glasses should, on the other hand, be additionally treated if necessary. If the droplet effect cannot be achieved by way of the selection of the precursor alone, a hydrophobic coating can be used instead (for example with the aid of a plasma deposition process).

Spreading of the Precursor

Spreading of a liquid on a solid body surface is observed only under specific preconditions. The behavior of a drop on a solid body surface is determined overall by the three-phase system consisting of the solid body surface, liquid and ambient atmosphere. The contact angle is generally striven for to describe the present energy conditions. The contact angle can be used as a measure to describe the extent to which a liquid tends to spread on the surface or to form droplets. The term “complete spreading” refers to the fact that an applied liquid drop has a contact angle of 0° degrees, meaning theoretically that the liquid covers an area of any desired size and an applied drop is automatically thinned indefinitely. Such behavior may be recognized to some extent for silicones which can spread over time over a large area. In the sense of this invention and in practical implementation, the term “spreading” refers to the fact that the static contact angle is less than 10° degrees. The person skilled in the art can determine the contact angle using a suitable measuring instrument.

A precondition for spreading is that the solid body surface tension of the surface to be coated be much greater than the surface tension of the applied liquid. For practical implementation, it is therefore recommended that the solid body surface provided have a solid body surface energy of at least 45 mN/m. A solvent or diluting agent used for applying the precursor should have a surface tension of ≦30 mN/m.

Selection of the Precursor

Preferably, only precursors having a molecular weight of greater than 600 g/mol are used.

The precursor has preferably a low steam pressure, so that it covers in a stable manner the solid body surface provided up to irradiating. The person skilled in the art selects a precursor of this type, inter alia, based on the planned time which is to elapse between the application of precursor and the irradiation, based on the process temperature and the process pressure. For relatively long times up to crosslinking of greater than 1 hour, use should preferably be made of a precursor having a high viscosity, for example static viscosity of greater than 10,000 mm²/s. Preferably, the precursor has a steam pressure of not more than 1 mbar at 25° C.; particularly preferably, the steam pressure is not more than 0.1 mbar at 25° C.

Silicone oils may be used for the presentation of an anti-fingerprint coating. Linear silicones having viscosity in the range of from 50 to 10,000 mm²/s have proven highly usable.

Likewise, silicones for the presentation of corrosion protection layers may be used as tarnish protection or as barrier layers. Owing to the spreading capacity, the silicones are also suitable as precursors for smoothing coatings.

Precursor Application Method

A suitable application method may be selected in consideration of the following aspects:

shape or 3D geometry of the solid body surface, precursor, costs, duration, desired surface coating, integration into the overall production process, working pressure, etc.

Certain details of preferred application methods will be presented and discussed hereinafter:

Spin coating methods are suitable preferably for flat, round substrates allowing the precursor to cover the entire surface very uniformly and homogeneously in the layer thickness. The method is thus suitable preferably for closed, homogeneous layers, for example for optical layers. With minor restrictions, slightly curved surfaces can also be coated by way of spin coating. The layer thickness is set via the rotational speed or by diluting the precursor with a volatile solvent. The person skilled in the art must take care to ensure that use is made of a suitable solvent which evaporates not too rapidly and not too slowly during spin coating. For example, linear, non-functionalized silicones from the AK Series (Wacker Chemie AG) with hexamethyldisiloxane (HMDSO) as the solvent may ideally be used. The small amounts of precursor and solvent lead to relatively low costs.

Dipping methods are suitable preferably in flat and slightly curved surfaces. A suitable dipping basin may be constructed almost in any desired size. The volume of the dipping basin results in some cases in considerable costs. The component to be coated is dipped into the liquid, subsequently withdrawn at a defined speed or the level of liquid is lowered. The speed and the ratio of the precursor relative to the solvent used determine the coating thickness. For example, the silicone oil AK50 and the solvent HMDSO in a ratio of from 1:5 to 1:10 and at lowering speeds in the range of from 1 to 10 cm/min can be used to generate precursor layer thicknesses in the range of from 50 to 500 nm. The method is ideally suited to layers in which the layer thickness is to be successively increased. These are homogeneous, closed layers. Undercuts, in which the precursor collects and is distributed, if appropriate after rotating the component, over the surface in an uncontrollable manner, can prove problematic.

Spraying methods are suitable preferably for presenting non-closed coatings having an inhomogeneous layer thickness. They can in principle operate all surface shapes, provided that the entire surface is accessible to the spray head. The spraying methods, if appropriate, dispense with solvents. They generate a droplet distribution on the surface. The person skilled in the art will in this case make allowance for the fact that the size of the droplets may vary greatly, depending on the spray technology used. For example, an ultrasonic atomizer is suitable to produce through the droplets covers having diameters of up to 100 μm (for example for anti-fingerprint coating). Nevertheless, suitable spray heads may also be used to generate closed layers having layer thickness deviations of below 10% (for example for corrosion protection, tarnish protection, etc.). Spraying methods should be used preferably in 3D coating and are well suited to coating web materials.

Aerosol methods are suitable for the coating of 2D and 3D bodies. The aerosol which is generated can be applied to the entire surface within one step. The necessary amounts of substance may be classified as being comparatively low. The aerosol method may be used to produce both closed covers and open covers. Aerosol methods are to be used preferably in 3D coating and are also well suited to coating web materials. Textiles may also be effectively coated using this method.

Roll-to-roll methods are suitable for the coating of flat substrates, for example of web materials.

Layer Thicknesses

The person skilled in the art must distinguish between the average layer thickness and the locally applied layer thickness. The term “the average layer thickness” refers to the layer thickness averaged over a large area. Nevertheless, the calculation includes in all cases only those regions of the surface of the coated substrate on which a (partial) coating is actually present. That is to say, backs or lateral surfaces which are not to be coated are, in particular, not included in this calculation. Instead, the total area of the partially coated regions is taken into account in its entirety, i.e. in a, for example, insular coating the proportion of the area between the coated islands is taken fully into account. The term “local layer thickness” means, on the other hand, that an actually covered region of a crosslinked coating is considered.

Unless there are specific requirements (for example in structured coatings), it may be assumed that an area segment 1 mm² in size is sufficient to be able to make a pronouncement on the typical layer thicknesses. The layer thickness determined via an ellipsometer or reflectometer may therefore be regarded as being the average layer thickness. For example, with the aid of a microscope, the person skilled in the art can make a pronouncement on the local layer thicknesses by considering the interference colors within the area segment which is measured out in advance.

The method according to the invention allows layer thicknesses of from 3 nm to 10 μm (layers without additives) to be effectively implemented. The layer thickness after irradiation is therefore crucial. The person skilled in the art must therefore determine the layer thickness after the irradiation and subsequently calculate, owing to the layer shrinkage which takes place, during the irradiation the layer thickness for the application of precursor.

The person skilled in the art sets the desired deviations from the local to the average layer thickness or the desired layer thickness homogeneity preferably via the selection of the application of precursor. Nevertheless, the person skilled in the art must consider that the liquid precursor layer behaves, up to the irradiation (excimer crosslinking), like a liquid. This can lead to desired effects: closing of pores as a result of migration; smoothing in that the precursor collects preferably in the troughs of the surface; droplet formation to provide the typography. If appropriate, it is possible to speed up the aforementioned effects with the aid of further technologies, for example by supplying heat (by means of, for example, IR emitters).

For layers which impart an impression which is optically homogeneous to the naked eye, use may be made, for example, of two strategies: On the one hand, it is possible to apply homogeneous layers which preferably display deviations, relative to the average coating thickness, of less than 10 percent. An average total layer thickness in the range of from 170 to 210 nm has, in particular, proven advantageous. This average total layer thickness generates a yellowish/light blue color impression which is barely perceptible on many surfaces, above all on metals. On the other hand, coatings having differences in local layer thickness of up to 200% may be used, the total range of variation in layer thickness being set within a lateral section of below 100 μm. Rapid variations in layer thickness of this type cannot, owing to their size, be resolved by the eye (generation, for example, by spraying methods or aerosol condensation).

It may be advantageous if corrosion protection layers and tarnish protection layers consist of a multilayer system. Especially good results were achieved with a two-layer system, wherein the base layer had a layer thickness of below 100 nm after excimer crosslinking and the cover layer had a layer thickness of above 200 nm after excimer crosslinking. Although the coating does not necessarily have to be homogeneous, it is generally closed.

For the production of parting layers, it is expedient to use at least a layer thickness of 100 nm. Higher layer thicknesses offer higher wear resistance. The person skilled in the art must set the layer thickness in accordance with the desired requirements.

For smoothing layers, layer thicknesses in the range of from 10 to 80 percent of the arithmetic roughness Rₐ should preferably be used. The result of the smoothing can be monitored after the coating, for example, with the aid of a profilometer for determining roughness (in transparent coatings, if appropriate, after vaporizing with a thin, light-reflective layer).

For optical layers, in particular transmission layers and reflection layers and also bandpass filters, the person skilled in the art can select the layer thickness with regard to the effect to be achieved. The layer thickness can be calculated as a function of the wavelength and the index of refraction (inter alia Fresnel formulae).

For scratch protection layers, higher layer thicknesses are preferably used or generated, for example for PC or PMMA a total layer thickness of greater than 2 μm, preferably between 4 μm and 10 μm or for aluminum a total layer thickness of above 2 μm. These layer thicknesses can be generated in one cycle or in a plurality of cycles.

For generating an anti-fingerprint coating, a local layer thickness in the range of from 150 to 250 nm will preferably be applied. A ratio between the open and closed coating of 1:1 produces preferably an average layer thickness of from 75 to 125 nm. It is preferable for the lateral dimensions of the insular covers to be 1 to 100 μm.

Handling of the Liquid Precursor Layer

Until irradiation of the liquid precursor, the film behaves like a liquid. Effects linked thereto may or may not be desirable. In particular, it is undesirable for dust to land on the surface; this causes the precursor to form a meniscus and the coating to have at worst a coating defect.

During handling care should be taken to ensure that the precursor distribution is not altered in an undesirable manner. This also applies to the surface to be factually coated (for example alteration can result from grains of dust, precursor contaminations, etc.) If appropriate, vents should be used and the components on which the precursors act should be stored in closed receptacles.

The times between the application and irradiation of the liquid film should be kept as short as possible (less than 1 hour, preferably less than 1 minute; more preferably, the irradiation is carried out immediately after the application).

Dealing with Fillers and Additives

If mixtures with fillers and additives are used, the person skilled in the art will consider the fact that these substances are present, on incomplete dispersion, as agglomerates. This has the consequence that the actual particle size (of the agglomerates) differs in some cases significantly from the primary particle size specified by the supplier. It is therefore not sufficient to use a desired primary particle size; the substances added must also be suitably dispersible (if appropriate by suitable stabilizers) in the precursor liquid; otherwise, the size of the agglomerates must be taken into account.

Fillers and agglomerates influence the actual layer thickness of the precursor. If the particle size of the substances added is well below the targeted layer thickness, then the influence of the particles on the layer thickness may be disregarded. If the particle size of the substances added is in the same order of magnitude as the targeted layer thickness, then menisci (accumulation of precursor material) form around the particles, resulting in a locally increased layer thickness (and thus an elevation based on the layer surface). The person skilled in the art observes the changes which occur. For example, it is possible to use for this purpose, with the aid of a microscope, the interference colors, which are typical of thin layers, for assessment. The particle size distributions can be examined with the aid of a microscope or using a scanning electron microscope.

The person skilled in the art selects the type of fillers and agglomerates with regard to the desired functionalities. The present text contains extensive information concerning this.

Selection of the Radiation Source and Wavelength Used

Only light sources having a wavelength of ≦250 nm are possible as the radiation source which is suitable in accordance with the invention. Appropriate light sources may for example be: excimer lasers, excimer lamps or mercury vapor lamps. The sources differ above all with regard to the energy provided, the spectrum and the coherence of the light. All the sources have in common the fact that they emit high-energy light having wavelengths of below 250 nm. This is necessary in order to apply, irrespective of the precursor in question, the required bond breaks (the energy required to break a single bond is sufficient). The radicals generated are the precondition for the necessary crosslinking of the precursor. The use of the aforementioned radiation sources is desirable also for the penetration depth of the radiation.

The person skilled in the art selects the radiation source with regard to the planned application. He will consider the fact that lasers generally provide very high powers or intensities, but process a very narrowly limited area segment. For small areas in the mm² to cm² range, a laser may be advantageous. For the processing of large areas (dm² to m²), a laser must scan the surface; this has an adverse effect on the total processing time. In addition, overlap of the individual pulses can produce inhomogeneities. Nevertheless, the result of the treatment is, owing to the coherence of the laser, independent of distance. This does not apply to excimer lamps which radiate incoherently, and the radiation power decreases, owing to the radial irradiation, in tandem with the distance. However, owing to the radial irradiation, the excimer lamps are extensive radiation sources and are therefore preferable in large areas and above all in flat substrates. Mercury emitters are, in contrast to the excimer sources, not line emitters, meaning that they emit a certain proportion of their total radiation in spectral ranges which are not below 250 nm. The person skilled in the art will therefore consider the fact, on the one hand, that only a proportion of the total power of the radiation source thus falls into the range of ≦250 nm and, on the other hand, that the radiation components having wavelengths of >250 nm can produce additional effects (for example undesirable heating caused by IR radiation components).

For the presentation of local coatings, the person skilled in the art may, for example, proceed as follows: He uses a laser and utilizes the small irradiation area to irradiate local surface elements in accordance with the invention or he uses masks which he irradiates over the entire area, for example, using an excimer lamp. For this purpose, the masks should be brought up as close as possible to the liquid precursor film (closer than 1 cm, preferably closer than 5 mm). The closer the mask is brought to the surface, the higher the contour sharpness which can be achieved.

Process Atmosphere

In principle, irradiation is possible at atmospheric pressure, at low pressure or in various process gases and also mixtures. The radiation power or dosage is the key factor governing the success of the coating. Although the process gas can jointly determine the layer properties (for example oxygen for hydrophilic layers), it is selected, in accordance with the invention, chiefly from technical perspectives.

The person skilled in the art will take account of the fact that gases at wavelengths of below 250 nm also absorb radiation and are, if appropriate, chemically converted. The absorption of radiation first causes the radiation intensity to decrease on the surface to be treated. The person skilled in the art should therefore check how high the actual radiation power is. This can be carried out by direct measurement using appropriate measuring apparatuses or the person skilled in the art takes the associated coefficient of absorption of the process gas as his basis and calculates the resulting radiation power. It is generally the case that the lower the working pressure is, the more radiation strikes the surface. Thus the person skilled in the art has, with the aid of the pressure, a process parameter which he can use to control the impinging radiation power. The effect of the absorption should not be disregarded, above all in the use of oxygen or oxygen-containing mixtures (including air).

The person skilled in the art must take care to ensure that chemical changes can occur in the gas atmosphere as a result of the absorption. In particular, radicals, including ozone molecules, can be generated in oxygen. Radicals pose a threat to health if mishandled. Precautionary measures must in this case be taken by way of vents, by rinsing the irradiation chamber, by enclosure, etc.

From a technical point of view, noble gases, nitrogen and CO₂ are preferable as process gases, as these irradiate the radiation from the aforementioned radiation sources almost without absorption losses. The use of such gases offers, without radiation loss, the possibility of carrying out the irradiation even at atmospheric pressure. This has the consequence that the production costs can if appropriate be reduced and it is entirely possible to construct a system without vacuum technology and in an in-line manner, for example by way of nitrogen curtains, CO₂ troughs or the like.

Processes which proceed at atmospheric pressure are preferred; generally, the use of an inert gas can replace the effect of a reduced pressure atmosphere. Nevertheless, the person skilled in the art must focus mainly on the residual oxygen content. It is for example recommended to pump out the process chamber to a reduced pressure of 10⁻² mbar and only then to fill it with the desired working gas atmosphere (or to ensure by way of technical measures that an appropriate residual oxygen content is present in the process gas atmosphere). In the production of hydrophobic coatings, this procedure should preferably be strictly adhered to. In the production of hydrophilic coatings, it is quite possible for a residual content of oxygen to be advantageous (for example 1 to 25% of oxygen in nitrogen or another inert gas or irradiation in air). The process gases will in this case react mainly with radicals generated by the radiation in the precursor. It is however also possible for the radiation to generate, as in oxygen, process gas radicals already in the gas phase. This produces not only the reactive ozone, but also the possibility of reaction with the precursor. The person skilled in the art can of course use these effects to cause, if appropriate, in a targeted manner incorporation of process gas into the layer to be generated. It is in this case even possible to control the amount of process gas incorporated via parameters such as the gas composition and gas pressure.

Irradiation Dosage (Selection of the Duration of Irradiation and of the Distance)

The key factor is the radiation dosage which strikes the precursor surface during the irradiation. The term “the radiation dosage” refers in this case to the product of the radiation intensity (i.e. energy per area and time) and the treatment duration.

In principle, the radiation dosage can be controlled by way of the duration, the distance (in the case of incoherent radiation sources) and by way of the absorption in the process.

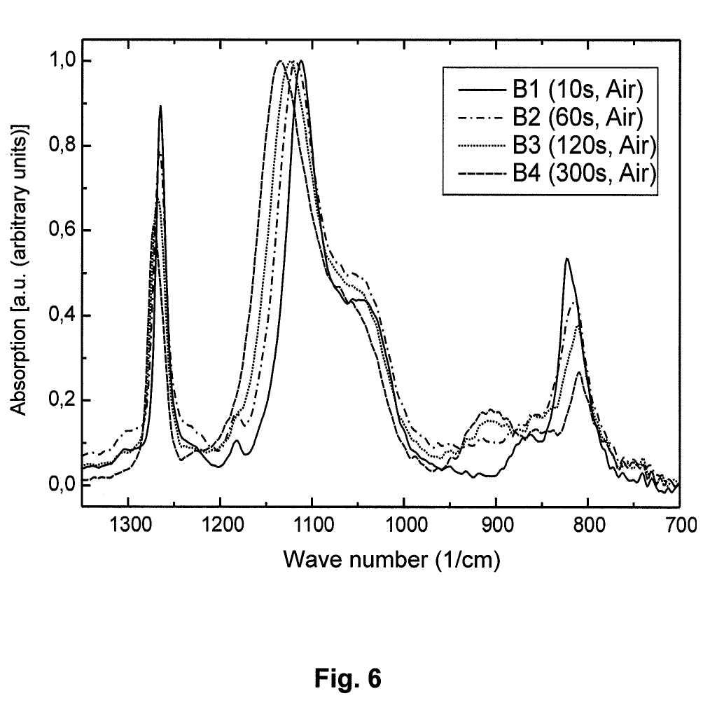

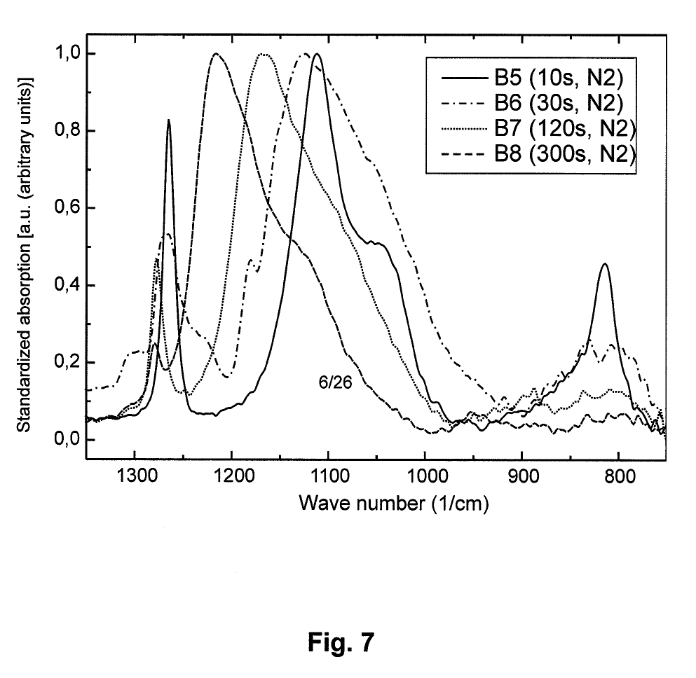

Control by way of the process gas (by absorption of radiation) is possible to a limited extent, provided that the gas composition does not have to be adhered to precisely. The diagrams FIG. 6 and FIG. 7 from Example 1 illustrate the effect of the process gas on the crosslinking of an oil layer: As a result of the high absorption of air, only a small portion of the emitter power reaches the surface and the crosslinking proceeds accordingly slower. In so far as the person skilled in the art also uses a suitable reference substrate in his coatings, he has, as indicated in the example, at all times the possibility of obtaining by way of IR spectroscopy an impression of the effect achieved. In this respect, reference may be made to the embodiments and parameters of this and further examples.

In order to give the person skilled in the art further assistance, certain estimations will in accordance with the invention be provided at this point for selecting a suitable radiation dosage:

Emitter power P=100 W to h=40 cm lamp length. For a distance of r=10 cm from the center point of the lamp, the radiation intensity is obtained as follows: The surface area of a cylinder at a distance of r=10 cm is A=2*Pi*r*h˜2500 cm², the intensity is thus I=P/A˜40 mW/cm². For a duration of irradiation of t=60 s, a radiation dosage of I*t˜2.4 Ws/cm² is thus obtained.

In Example 1 Table 2 and Table 3 mention certain parameters for irradiation:

For example, irradiation of a silicone oil in air at a dose of 65 mWs/cm² (including absorption) is sufficient to detect by IR spectroscopy a change in the layer properties; however, the dose is not sufficient to generate a solid layer. For a non-wipeable layer, at least 2 Ws/cm² are in this case necessary under an ambient atmosphere.

For the irradiation of a silicone oil under a nitrogen atmosphere, a wipe-proof coating can for example already be generated at a dose of 400 mWs/cm²; on irradiation at 12 Ws/cm², a wipe-proof, hydrophilic layer is obtained.

Reference is made in this regard to Example 1.

For the sake of orientation, the following parameter ranges are mentioned for irradiation with an excimer lamp at 172 nm (100 W, length 40 cm) in nitrogen to obtain a wipe-proof coating:

| Irradiation | Distance from the | Duration of | |
|---|---|---|---|
| dosage: | center of the lamp | irradiation | Intensity |
| 500 mWs/cm² | 3 cm | ~4 s | 130 mW/cm² |
| | 10 cm | ~13 s | 40 mW/cm² |
| 10 Ws/cm² | 3 cm | ~80 s | 130 mW/cm² |
| | 10 cm | ~250 s | 40 mW/cm² |

For practical application with a UV excimer lamp having a central emission wavelength of 172 nm, it is preferable to limit the working range for all of the applications to the following parameter range:

| Irradiation | Distance from the | Duration of | |
|---|---|---|---|
| dosage: | lower edge of the lamp | irradiation | Intensity |
| 200 mWs/cm² to | 0.1 to 10 cm | 0.5 s to 20 min. | 1 to 10,000 |
| 200 Ws/cm² | | | mW/cm² |

For the treatment of web materials, it is recommended to select the distance so as to be low as possible in order to implement, by way of high intensity, short durations of irradiation and thus to allow a high web speed.

For 3D objects or surfaces having differences of height in the cm range, it is recommended to select a higher working distance. This reduces the relative differences in the local radiation dosages compared to a low working distance.

Number of Cycles

As the radiation dosage is critical for the result of the coating, a 1-ply layer may selectively be irradiated within one cycle or, at the same total duration of irradiation, in any desired number of short cycles. If lasers are used, it should be ensured that they do indeed operate in pulsed mode. In this case, each individual pulse is to be regarded as an independent cycle. Unless there are any reasons to the contrary (for example heating at very high irradiation dosages), it is preferable to crosslink the coating within one cycle.

For certain coatings, good adhesion or a closed, error-free coating is crucial. For these layers, for example scratch protection layers, corrosion protection layers, tarnish layers, it is advisable to configure the coating as a multilayer system. In this case, the coating errors (uncoated surface segments) are reduced as a result of the multiple coating. Within each cycle, precursor material is applied and subsequently irradiated and thus crosslinked in a layer-forming manner. In this case, the first layer, the base layer, has after irradiation preferably a layer thickness of not more than 100 nm. The second layer, the cover layer, has preferably a layer thickness of above 200 nm after irradiation. Scratch protection layers require layer thicknesses in the micrometer range. In this case, it is preferable to configure these layers as multilayer systems, each layer preferably having a thickness in the range of from 500 nm to 2 μm after irradiation.

An anti-fingerprint coating can be irradiated within one cycle.

For the coating of web materials, continuous single treatment of each surface segment is recommended.

Carbon Content

The carbon content in the coating is dependent on the precursor material used and the intensity of the treatment. The content of carbon tends to decrease over the course of the duration of irradiation. The person skilled in the art can determine the carbon content with the aid, for example, of an XPS analysis.

It has been found that coatings having a carbon content of ≧10 atomic %, based on the quantity of the atoms contained in the layer without H and F, have special properties with regard to their flexibility. This property is highly relevant, in particular, to strongly crosslinked systems such as for example tarnish protection, corrosion protection or scratch protection, as the alternative methods generally offer layer functionalities of this type only as highly brittle systems providing no flexibility. Unless there are reasons to the contrary, it is therefore preferable to set layers of this type in such a way that the layers have a carbon content in the range of from 10 to 20 atomic %.

With regard to the configuration of an easy-to-clean layer, reference is made to the details of the carbon content in Section 8.6.

Furthermore, reference is made to the process parameter particulars, Table 7, of Example 4, which systematically presents the percentages of the atomic composition for the excimer irradiation of silicone oils.

For an anti-fingerprint coating, the carbon content is less relevant; in this case, the adhesion and the optical properties of the coating are foregrounded.

With regard to the configuration of a PDMS-like coating, reference is made in this connection to the details of the carbon content in Section 8.2.

8. Applications

Various particularly preferred embodiments of the invention will be described hereinafter. Further information concerning the embodiments may also be found in the figures, the examples and the claims. In this case, it will be readily comprehensible to the person skilled in the art that the information, features and procedures or parts thereof are applied with restriction not only to the respective application. On the contrary, the person skilled in the art will be able to combine the findings or parts of the findings disclosed in the present document with regard to individual applications with those of other applications disclosed in the present document.

8.1 Coating Crosslinked in Accordance with the Invention with Dispersed, Finely Divided Solids

It is possible to produce by means of the method according to the invention layers with nanoscale dispersed particles which are inorganic and in particular metallic (if appropriate magnetizable) and closely resemble the layers disclosed in DE 197 56 790 A1 with regard to their properties. Accordingly, the person skilled in the art obtains further information concerning the configuration of the method and the properties of the corresponding layers in DE 197 56 790 A1, the content of which forms part of the present application by way of reference. This applies in particular to the passages in column 4, line 66 to column 5, line 5; column 5, line 43 to column 5, line 46; column 6, lines 22-31.

It is accordingly possible to generate by means of the method according to the invention, including in particular its preferred embodiments, in a first application according to the invention crosslinked layers and items with crosslinked coatings comprising dispersed finely divided solids. Accordingly, the first preferred embodiment of the invention includes a layer according to the invention and an item according to the invention, the crosslinked layer comprising finely divided solids, characterized in that the solids have a particle size of <200 nm, preferably <100 nm, and are present substantially in chemically unbound form in the matrix of the crosslinked layer.

It is more preferable in this connection for the solids to have a particle size in the range of less than 20 nm, demonstrated for example by transmission electron microscopy (TEM).

It is particularly preferable for the solids to have a particle size in the range of from 5 to 10 nm.

More preferable is an item according to the invention as claimed in the first preferred application according to the invention, wherein the crosslinked layer comprises 0.1 to 30% by volume of finely divided solids of a particle size of <200 nm and wherein the crosslinked layer more preferably comprises 1 to 10% by volume of finely divided solids.

It is preferable in this connection for the finely divided solids to be metal particles which particularly preferably are magnetizable.

As an alternative to the latter provision, it may be preferable for the finely divided solids to be made of silver or copper.

Furthermore, it is also part of the preferred embodiment described here of the invention for the matrix to have been produced from silicone compounds or partially or fully fluorinated liquids.

The starting point for the production of the coating is a dispersion made up of inactive liquid precursors and the particles (finely divided solids). The selection of the particles is governed by the surface function which is desired later. For example, it is possible to select: photochromic and electrochromic substances, reflective and partially reflective substances, conductive substances, corrosion protection inhibitors, dyes, luminescence dyes, in particular electroluminescent, cathodoluminescent, chemiluminescent, bioluminescent, thermoluminescent, sonoluminescent, fluorescent and/or phosphorescent luminescence dyes, organic or inorganic coloring pigments, magnetic substances, salts (for example salts of organic and inorganic acids, metal salts). Examples include: copper, zinc sulfide, magnetite, zinc oxide, aluminum oxide, silicon oxide, boron nitride and graphite. With regard to the production of dispersions with nanoparticles, reference is made to the VERL method which is described in greater detail in Chapter 7.3.

The possible degree of filling of the dispersion with particles is governed by the particle size, the processing parameters such as for example viscosity and agglomeration behavior. The person skilled in the art will if appropriate dilute the mixture further with a suitable solvent, so that the application according to the invention becomes possible, for example, by way of a spraying method. Subsequently, the crosslinking is generated. In this case, it is advantageous to illuminate the surface from various angles in order to avoid shadowing. Otherwise, the irradiation intensity is oriented in accordance with the desired properties of the matrix. Imaging methods, such as microscopy, scanning electron microscopy and transmission electron microscopy, are suitable for assessing the particle distribution and particle size.

Preferably, the item which is coated in accordance with the invention and described in this section is a plastics material, metal, glass or ceramic item. Examples are items with surfaces requiring the following functions: improved abrasion and scratch protection properties as a result of the incorporation of particles; coatings allowing continuous, long-term discharge of functional substances: for example (bio)catalysts, enzymes, hormones, proteins, nutrients, pheromones, emulsifiers and surfactants, antimicrobial substances, medically effective substances (active substances), growth substances for bone growth, odorants and fragrants, pesticides, slip additives, edible oils/waxes; active coatings for preventing the accumulation of biological pests such as microorganisms, algae, plants and minute creatures; items having a changed feel, with electrostatic properties of components made up of non-conductors such as plastics materials; surfaces having a reduced tendency to dust accumulation; with novel decorative effects.

Surfaces which are coated in accordance with the invention and allow a discharge of functional substances may be used both in air, in liquid media and also (if appropriate) in vivo. For the use of these released substances, a large number of applications are provided, for example in the field of chemical, biotechnological or pharmaceutical production, analytics, agriculture or forestry, the manufacture of consumer or capital goods, human or veterinary medicine (medical engineering, pharmacology), the food industry, the conservation of valuable goods (works of art, archaeological finds, building stock). In this case, the coating according to the invention can be applied both directly to the desired objects and to support materials ranging up to foils (if appropriate coated as web materials) or powders.

8.2 PDMS-Like Coating:

According to a second preferred embodiment of the invention (referred to hereinafter also as the second embodiment), it is possible, by means of the method according to the invention, to generate layers and to apply them to products which closely resemble in their structure plasma-polymeric, PDMS-like coatings such as are described in German patent application 10 2006 018 491.2. The content of this application is incorporated into the present application by way of reference; this is intended to include, in particular, the ranges relating to the description of the recording of the ESCA spectra and the ESCA measurements.

For the production of PDMS-like coatings by means of the method according to the invention, it is expedient for the starting substance used to be simple, linear silicones of the structure

(CH₃)₃Si(OSi(CH₃)₂—)ₙOSi(CH₃)₃ wherein n>0

Likewise, it is also possible to use cyclic dimethyl silicones and/or silicones with short and/or long-chain branchings and/or copolymers having a content of more than 50% of dimethylsiloxane units. The selection of the materials is not limited to these materials; it is important to provide a high proportion of alkyl groups. This also allows other hydrocarbon groups, instead of methyl groups, to be bound to the siloxane skeleton.

During production it is essential to ensure that the radiation intensity is kept low and the radicals which are produced (in particular those at the surface) are not saturated with polar elements or substances.

Preferably, operation is carried out in an N₂ or H₂ gas atmosphere, more preferably under low pressure.

The person skilled in the art will proceed, in the production of the layer according to the invention, in such a way that he first sets, for a given type of precursor and at a given thickness, a working distance which is appropriate for the geometry of the component and then successively increases, for example at a given radiation intensity, the illumination time. He will ascertain that from a specific moment the liquid precursor begins to solidify. This is the relevant working range. In this case, the desired layer properties, such as non-stick behavior, hydrolysis stability or electrical insulation, should then be optimized by fine adjustment. Additional monitoring possibilities are provided by way of the measurement of the water contact angle on flat substrates, infrared spectroscopy and ESCA analysis.

Accordingly, the second embodiment of the invention includes a layer according to the invention and an item according to the invention, wherein the crosslinked layer is a layer consisting of carbon, silicon, oxygen and hydrogen and also if appropriate conventional impurities, wherein in the ESCA spectrum of the (excimer-)crosslinked product, on calibration to the aliphatic portion of the C 1 s peak at 285.00 eV, compared to a trimethylsiloxy-terminated polydimethylsiloxane (PDMS) having a kinematic viscosity of 350 mm²/s at 25° C. and a density of 0.97 g/ml at 25° C.,

the Si 2 p peak has a bond energy value which is shifted by at most 0.50 eV to higher or lower bond energies, and

the O 1 s peak has a bond energy value which is shifted by at most 0.50 eV to higher or lower bond energies.

Further preferred embodiments of the second embodiment, in particular, of the invention are described in greater detail in claims 28 to 36.

Layers (according to the second embodiment of the invention) produced in the method according to the invention are, in particular in their preferred configurations, hydrolysis-resistant, resilient and thus crack-free and also extensible up to extensions of >50% (in preferred configurations >100%). Crosslinked layers, as described in the second embodiment of the invention, are a flexible migration barrier. Furthermore, they have non-stick properties and improved sliding ability compared to a large number of elastomers (cf. in this regard the sliding properties of fluoroelastomers such as Viton®, silicone rubbers, rubber, etc.), as the surface tack which is conventional for elastomers of this type is missing or is greatly reduced.

Particularly preferred is an item which is produced in the method according to the invention and in which the crosslinked coating has a thickness in the range of from 1 to 2,000 nm. Preferably, the crosslinked layer can, within the scope of the second embodiment of the invention, be detached from the surface in a destruction-free manner and can thus be used if appropriate as a foil. Preferably, the layer is configured in such a way that it does not allow the passage of molecules having a molar mass of 100 g/mol or more, preferably 50 g/mol or more. It is thus a permeation barrier for molecules having a molar mass of 100 g/mol (or 50 g/mol) or more.

Independent tests have revealed that a crosslinked layer (or foil) of this type already completely prevents, at a very low thickness of in some cases well below 1,000 nm, the passage of molecules having a molar mass of 100 g/mol (preferably 50 g/mol). The foil or coating is in this case flexible and resilient, so that use thereof also does not lead to undesirable crack formations which might allow the said molecules to pass through the coating.

In particular, if the item according to the invention comprises a crosslinked layer as the permeation barrier, it is advantageous if the item is an elastomer with a layer which is crosslinked thereon and has a thickness in the range of from 1 to 2,000 nm. The layer can in this case be detachable in a destruction-free or non-destruction-free manner.

However, the advantage of an item of this type does not in all cases reside in its property as a permeation barrier. In other cases, the advantage of an item comprising an elastomer substrate and a crosslinked coating arranged thereon resides in the fact that the coating significantly increases the sliding properties compared to the untreated substrate, as the tack is minimized.

In particular, according to the second embodiment, the product according to the invention can be selected from the group consisting of (the (excimer-)crosslinked layer imparting in each case the function):
article, (item) with a block (migration barrier) preventing migration of molecules having a molar mass of 100 g/mol or more, preferably 50 g/mol or more, comprising a crosslinked layer as defined above as the migration block (migration barrier) or a part of a migration block,
article with a seal, comprising a crosslinked layer as defined above as the seal or sealing component,
optical element with a coating, comprising a crosslinked layer as defined above as the coating material,
article comprising a corrosion-sensitive substrate and an anticorrosive coating arranged thereon, comprising a crosslinked layer as defined above as the anticorrosive coating or part of the anticorrosive coating,
article comprising a substrate with an easy-to-clean coating, comprising a crosslinked layer as defined above as the easy-to-clean coating or part of the easy-to-clean coating, in particular for application in the field of adhesive and paint processing, rubber and plastics material processing and food processing,
article comprising a substrate (including in particular a (technical) textile) with a (hydrolysis-resistant) easy-to-clean coating, comprising a crosslinked layer as defined above as the (hydrolysis-resistant) easy-to-clean coating or part of the (hydrolysis-resistant) easy-to-clean coating,
article comprising a substrate (including in particular a membrane) with a (hydrolysis-resistant) easy-to-clean coating or water-repellent finish, comprising a crosslinked layer as defined above as the (hydrolysis-resistant) easy-to-clean coating or water-repellent finish or part of the (hydrolysis-resistant) easy-to-clean coating or water-repellent finish,
article comprising a substrate with an antibacterial coating, in particular according to or similar to DE 103 53 756, comprising a crosslinked layer as defined above as the (non-cytotoxic) antibacterial coating or part of the antibacterial coating,
article comprising a substrate for producing a packaging with an antibacterial coating, in particular according to or similar to PCT/EP 2004/013035, comprising a crosslinked layer as defined above as the (non-cytotoxic) antibacterial coating or part of the antibacterial coating,
article comprising a substrate, in particular a heat exchanger or parts of a heat exchanger, and a coating arranged thereon, comprising a crosslinked layer as defined above having hydrophobic, hydrolysis-stable, anticorrosive surface properties, which coating changes the thermal conductivity preferably only in a manner which can hardly be measured,
article comprising a substrate with a (preferably excimer-)crosslinked parting layer, comprising a crosslinked layer as defined above as the parting layer or part of the parting layer or a part of a UV-transparent parting layer,
article comprising an elastomer product and a sliding ability-increasing coating on the elastomer product, comprising a crosslinked layer as defined above as the coating or a part of the coating,
article comprising a substrate, in particular an optical component of a lithographic installation, and a coating arranged thereon, comprising a crosslinked layer as defined above as a hydrolysis-resistant, highly hydrophobic and substantially UV-transparent protective layer,
article comprising a substrate, in particular a stamp, more particularly a stamp for application in nanoimprint technology, and a coating arranged thereon, comprising a crosslinked layer as defined above as a substantially UV-transparent parting layer coating,
article comprising a preferably excimer-crosslinked coating with a defect and a repair foil for repairing the defect, comprising an excimer-crosslinked layer as defined above as the repair foil or a part of the repair foil,
article comprising at least two relatively hard layers or substrates, preferably having barrier properties, and at least one soft spacer layer between the relatively hard layers or substrates, comprising a crosslinked layer as defined above as the spacer layer or a part of the spacer layer,
article comprising a barrier coating or a substrate for reducing the migration of gases and vapors, in particular water vapor, carbon dioxide or oxygen, with a hydrophobic cover layer, comprising a crosslinked layer as defined above as the cover layer or a part of the cover layer,
article comprising a preferably electrical component and an electrically insulating foil or coating, comprising a preferably hydrophobic crosslinked layer as defined above as the insulating foil or insulating coating or a part of a foil or coating of this type,
article comprising a preferably implantable medicotechnical item comprising a crosslinked layer as defined above. Advantageously, the coating allows, owing to its dehesive surface properties, reduction of the adhesion of bacteria, proteins or other bodily substances (if appropriate modified by medicaments),
preferably implantable medicotechnical silicone article comprising as the coating a crosslinked layer as defined above. Advantageously, the coating allows, owing to its dehesive and/or expandable surface properties, an increase in body compatibility (in particular, the coating according to the invention is suitable to the extent that no low-molecular reaction end products are present).

These aforementioned embodiments are not limited to the second embodiment of the invention; on the contrary, the composition of the layer according to the second embodiment, which is crosslinked in the method according to the invention, is precisely a preferred embodiment of the article (item). Accordingly, the invention also includes the corresponding articles, such as those listed hereinafter, comprising a layer according to the invention which does not correspond in its composition to the second embodiment.

The invention accordingly also relates (preferably but not exclusively based on the second embodiment) to the use of a crosslinked layer, preferably as defined hereinbefore (as an item according to the invention or part of an item according to the invention), as
a block (migration barrier) preventing migration of molecules having a molar mass of 100 g/mol or more, preferably 50 g/mol or more,
cover layer on a barrier coating or a substrate for reducing the migration of gases and vapors, in particular water vapor, carbon dioxide or oxygen,
sealing material, in particular for seals having a thickness of at most 1,000 nm,
flexible coating of a flexible packaging material,
foil or coating for lumenizing optical elements,
hydrolysis-resistant coating,
hydrophobic coating,
antibacterial coating, in particular non-cytotoxic antibacterial coating,
anticorrosive coating,
easy-to-clean coating,
sliding ability-increasing coating on an elastomer product,
protective and/or UV-transparent, hydrolysis-stable foil, in particular for optical elements of lithographic installations, also preferably for optical elements of immersion-lithographic installations,
parting layer or a part of a parting layer or a part of a UV transparent parting layer for easier demolding of plastics material components or detachment of plastics materials,
repair foil, in particular for easy-to-clean or parting layer applications or optical applications,
foil or coating having dehesive and adhesive surface properties,
foil with a hole and/or strip pattern, in particular for coating hydrophilic substrates for producing local hydrophilic or hydrophobic regions,
soft spacer layer between relatively hard layers or substrates to be separated from one another, in particular barrier layers,
highly hydrophobic cover layer, in particular for preventing the adsorption of polar molecules or for improving the barrier properties of barrier coatings or ultra-barrier coatings from gases and vapors such as water vapor, carbon dioxide or oxygen,
insulator foil or coating, in particular in electrical components,
parting layer or highly hydrophobic layer on diamond-like coatings, in particular thin coatings chemically bound to the substrate.

### Field of Application: Migration Barrier

An item according to the invention can comprise, in particular within the scope of the second embodiment of the invention, a crosslinked layer as the barrier (migration block) preventing migration of molecules having a molar mass of 50 g/mol or more, preferably 100 g/mol or more. The barrier effect relative to organic molecules is in this case particularly important. Specific examples of the application as the migration barrier are migration barriers to prevent undesirable substances from issuing from a substrate, such as for example the barrier to additives (for example plasticizers) from a plastics material substrate (this application is particularly important for food product and pharmaceutical packagings). An item according to the invention may accordingly be or comprise a food product packaging, to the side of which facing the food product a crosslinked layer is applied. The food product packaging itself serves in a product of this type as a substrate; examples of food product packaging materials which can be sealed from the food product by a crosslinked coating generated in accordance with the invention include soft PVC, polyurethane foams, etc. In these examples the crosslinked layer serves to prevent an undesirable substance from issuing from the substrate into the food product. However, as the migration barrier, a crosslinked layer according to the invention is of course equally good at preventing an undesirable substance from entering a substrate.

An example of a migration barrier of this type to prevent an undesirable substance from entering a substrate is a migration barrier which is arranged on a plastics material substrate and prevents solvents, toxins or dyes from a liquid, which might curtail the useful life of the plastics material substrate, cause undesirable contamination of the substrate or dye the substrate, from entering the substrate.

The use of the crosslinked layer is particularly advantageous if, in addition to the barrier effect, one or more of the technical requirements mentioned hereinafter is met: transparency; low coating thickness of for example less than 0.5 μm; high UV stability.

Typical substrates to which a crosslinked layer generated in accordance with the invention may be applied, in order to function there as the migration barrier, are foils, sealing materials (for example PVC seals in screw caps, in particular in the food product sector) rubber seals, packagings (food products, pharmaceuticals, cosmetics, medical engineering, etc.), textiles, illumination matrixes for UV curing, etc. The crosslinked migration barriers are physiologically acceptable and have a very good life cycle assessment.

In relation to the “migration barrier” field of application, it should be noted that the transparent barrier coatings used are nowadays in many cases inorganic layers such as for example SiOₓ or AlOₓ. These coatings can be produced by various vacuum methods, for example with PVD, CVD or plasma-assisted CVD (PE-CVD). Although the said coatings allow good barrier properties to be achieved on suitable substrate surfaces from a coating thickness of 20 nm, from a thickness of approx. 100 nm there occur in the said coatings cracks which make the coatings more permeable again. This also applies to plasma-polymeric barrier layers of a previously conventional structure. In addition, the said coatings are brittle and therefore fragile. The view is therefore held that a very good barrier requires, based on the known coating methods, an almost defect-free inorganic coating.

A further drawback of the known inorganic coatings consists in the fact that they are comparatively inflexible. However, a large number of applications involve deformation of the substrate surface, leading, on use of the said conventional coatings, to the formation of cracks and thus to the loss of the barrier property. In contradistinction to the previously known inorganic migration barriers, for example based on SiOₓ, the crosslinked layers produced in accordance with the invention are softer and more flexible.

The present invention thus also achieves the object of providing an improved thin layer coating system which is a suitable migration barrier.

For the provision of especially good barrier coating systems, for example what are known as ultra-barriers, including for gases and vapors having a low molecular weight, a layer generated in accordance with the invention may be used as an intermediate layer (spacer layer) in a composite of thin layers. For example, the layer generated in accordance with the invention may be used in combination with thin layers which are applied using PVD, CVD or plasma-assisted CVD (PE-CVD) (like the above-described highly inorganic SiOₓ or AlOₓ coatings). In this case, the layer generated in accordance with the invention can for example reduce the tendency to crack formation owing to internal (mechanical) stresses in thicker “total layer thicknesses”. In addition, the flexibility of a layer composite of this type is increased compared to a barrier layer without the intermediate layer according to the invention.

A further improvement of barrier layers or ultra-barrier layers for gases and vapors having a low molecular weight can be made as a result of the use of the crosslinked layer as defined above as the cover layer. Owing to its highly hydrophobic surface, the crosslinked layer reduces the adsorption of polar molecules such as for example water, which often decisively influence the speed of the migration.

### Field of Application. Hydrolysis Resistance

Hydrolysis-resistant coatings are required in various technical fields of application.

For example, hydrolysis-resistant, hydrophobic anticorrosive thin layer coatings, which do not impede the conduction of heat, are required in the field of heat exchangers. Saturated water vapor atmospheres at elevated pressures often occur in heat exchangers. The heat exchanger surfaces, on the other hand, are comparatively cool, so that moisture (which is in some cases highly acidic) is condensed out. In order to prevent a water film from forming on the heat exchanger surfaces and to prevent, if appropriate, corrosion from taking place, it is advantageous if these surfaces have a hydrophobic finish to prevent the formation of a water film which would have additionally to be cooled and would impede the conduction of heat. A heat exchanger, the heat exchanger surface of which is provided with a crosslinked layer which is produced in accordance with the invention and is composed as described in the second embodiment, is an example of a preferred product according to the invention.

A further field of application for hydrolysis-resistant coatings resides in the field of paper production. In the field of paper production, hydrolysis-resistant coatings having non-stick properties are required to prevent adhesion of what are known as stickies. It has been found that the adhering of stickies is completely or at least very substantially prevented by equipping the relevant parts of a paper production installation with a crosslinked layer produced in accordance with the invention as defined above.

Hydrolysis-resistant, chemically inert hydrophobic coatings are also required in the field of the production of filter materials. For example, filters of this type (known as HEPA filters) are used in installations in which food product packagings are sterilized prior to filling with H₂O₂. Corresponding vapors and also cleaning media can alter a non-protected filter and render it unusable.

The aforementioned crosslinked layer can also be applied as a hydrolysis protection cover layer to other thin layer systems which were, in turn, applied for example using PVD, CVD, plasma-assisted CVD (PE-CVD), plasma polymerization, by electroplating or in a sol-gel process. In particular, inorganic coatings, such as SiOₓ and AlOₓ coatings, display, despite their good corrosion protection properties, for example on anodized aluminum substrates, comparatively low hydrolysis resistance and are preferably equipped with a preferred crosslinked layer according to the invention as defined above.

### Field of Application: Non-Stick Property, Easy-To-Clean-Properties

Non-stick properties and/or easy-to-clean-properties are desirable in a large number of tools and machines. Mention may be made in this connection, in particular, of tools and machines (such as book binding machines, adhesive application appliances, sealing installations, printing units, laminating installations, painting installations, components for painting installations, food processing installations) which enter into contact with adhesives (for example hot melts, 1-component and 2-component adhesive with and without solvent or cold glue), paints, colorants, plastics materials or food products; examples include storage containers, pumps, sensors, mixers, pipelines, application heads, gratings, paint spray guns, baked goods carriers, car parts, such as for example screens, etc. In particular in the field of sensors, there is a special need for non-stick coatings or easy-to-clean coatings which cover the entire sensor and do not impair the sensor properties. The application of a crosslinked layer as defined above and produced in accordance with the invention is particularly advantageous here, as it allows the entire sensor to be coated without impairing the sensor properties. In addition, the surface energy of a coating of this type is frequently so low that even some common solvents, such as acetone, no longer spray over the surface—the surface energy of the coating is below that of the solvents. This also improves the run-off behavior and the cleaning behavior of solvent-containing adhesives.

A product according to the invention may for example be a molding tool with a permanent demolding layer, the permanent demolding layer itself being a crosslinked layer as defined above and produced in accordance with the invention. Molding tools with a permanent demolding layer and also methods for the production thereof are disclosed in EP 1 301 286 B1, although it was established as being fundamental therein that a gradient layer construction be generated in the demolding layer as a result of variation over time of the polymerization conditions during the plasma polymerization. However, a gradient is not necessary in a corresponding configuration of the crosslinked layer (cf. also Chapter 7.5).

It may also be advantageous to provide, in addition to a permanent demolding layer on a molding tool, a crosslinked layer which is produced in accordance with the invention and displays in an ESCA test the above-specified bond energy values. In such a case, a layer of this type also has, when configured accordingly, the function of a flexible cover layer, assisting the sliding properties, on the permanent demolding layer which itself has parting properties.

Owing to the extensibility of the crosslinked layer as defined above, it is possible to provide flexible products, such as foils (in particular extensible foils), with a corresponding non-stick or easy-to-clean surface.

### Field of Application: Improved Sliding Properties

This aspect of the invention relates to, in particular, items according to the invention comprising an elastomer product and a sliding ability-increasing coating on the elastomer product, comprising a crosslinked layer as defined hereinbefore as the coating or a part of the coating.

Many elastomer products, for example O-rings or seals, can be equipped with a crosslinked layer generated in accordance with the invention as the coating or a part of the coating, without the coating becoming cracked when the resilient properties of the substrate (of the elastomer product) are subjected to stress.

A large number of the elastomers currently used display poor sliding properties, so that the corresponding elastomer products can be processed only with difficulty in automatic loading machines. The elastomer products have a disruptive surface adhesiveness (tack). For example in the technical field of valves, such tack can become negatively apparent if just slight detachment forces are expected. A further complicating factor for this field of application is the fact that the substances which cause the tack are transferred to the valve seat and over time may lead to leaky valves. It is therefore advantageous to provide the elastomers used with a crosslinked layer as defined above and generated in accordance with the invention, as this provides special sliding and also parting properties at high extensibility. The elastomer and coating in this case jointly form an item according to the invention.

A further specific field of application is the improvement of the sliding properties of silicone rubber; this leads to a number of advantageous products both in the industrial/technical field and, for example, in the field of medical engineering. A corresponding item according to the invention comprises in this case a silicone rubber product and a crosslinked layer (as described above).

In addition, for both the aforementioned fields of application, the crosslinked layer ensures that these products cannot diffuse any vulcanization residue products, any plasticizers or other additives having a molar mass of, for example, greater than 50 g/mol (cf. also the migration barrier field of application). This provides improved suitability in the field of food processing, pharmaceutics and medical engineering.

### Field of Application: Antibacterial Coatings

Non-cytotoxic, antibacterial coatings according to DE 103 53 756 are produced preferably with the aid of SiOx-like coatings. Although previously known SiOx-like coatings are, in the preferred layer thickness of from approx. 30-60 nm, to a certain extent flexible and can be placed on a foil for application, in no way is a coating of this type able to withstand loads such as are produced, for example, by a deep drawing process or during buckling or reshaping or injection molding or back injection molding or laminating. Furthermore, corresponding surfaces define specific adhesion properties (for bacteria, fungi, bodily substances, etc.). The application of crosslinked layers as defined above and produced in accordance with the invention, in addition to an SiOx coating, extends the possible uses. In particular, the high flexibility and extensibility of the layer allow substrate-deforming further processing procedures such as deep drawing, beading, embossing, etc. Even tubes, closures, spouts or foam foils, for example, can be finished in this way.

Furthermore, a layer of this type, applied to a corresponding laminating foil or else directly, is also suitable for food product packaging. Use in the composite foils sector is of particular interest, as this allows, for example, blocking layer properties to be combined with antibacterial properties.

### Further Fields of Application

A crosslinked layer produced in accordance with the invention may advantageously be used in a large number of further products (according to the invention). Mention may be made, in particular, of: seals (as the crosslinked layer) in the submicrometer range; coatings (as the crosslinked layer) of metallic components or semifinished products, in particular as the anticorrosive coating and/or hydrophobic coating on metallic components or semifinished products of this type, in particular for structural parts or semifinished products which are subjected to deformations in further processing or in normal use; coatings (as the crosslinked layer) which cling to a plasma-assisted pretreated substrate surface and form, together with the substrate, a product according to the invention.

8.3 Antimicrobial, Preferably Non-Cytotoxic Coating

According to a third preferred embodiment of the invention (referred to hereinafter also as the third embodiment), it is possible, by means of the method according to the invention, to produce layers and to apply them to products which are antibacterial, preferably non-cytotoxic coatings.

An antimicrobial, non-cytotoxic coating is distinguished, according to DE 197 56 790, by:

1. antimicrobial and non-cytotoxic layer material, comprising
a) a biocide layer with a biocidal active substance, and
b) a transport control layer which covers the biocide layer and has a thickness and a porosity which are set to discharge the biocidal active substance from the biocide layer through the transport control layer in an antimicrobial and non-cytotoxic amount.

The production of a layer of this type requires a two-stage coating method. WO 2005/049699 additionally describes how a layer of this type can be produced, for example, using plasma or sputtering methods.

In the prior art, liquids filled with biocide nanoparticles are produced, for example, in what is known as the VERL method. In this case, the production and the stabilization of nanosuspensions are rendered possible by what is known as VERL (vacuum evaporation on running liquids) technology. In this case, a metal is sputtered onto a displaced liquid. Non-agglomerated particles having diameters of a few nanometers are formed in this liquid matrix. In this method, dispersions of isolated, nanoparticulate particles are accordingly produced in a carrier liquid. In many cases, this carrier liquid is a simple, linear silicone oil. Nevertheless, the invention is not limited to the suspensions produced by the VERL method.

Corresponding dispersions can be crosslinked using the method according to the invention. This produces a crosslinked transport control layer which is uniformly permeated by biocide nanoparticles. The layer produced in this way differs fundamentally from the polymers produced in DE 197 56 790, as these polymers do not contain a transport control layer and contain, as a result of the dilution effect, a much smaller amount of biocide per volume. The layers also differ fundamentally from the layers produced in accordance with DE 197 56 790, as the biocide nanoparticles are distributed uniformly in the coating. As a result of the crosslinking of the matrix, the density of nanoparticles is further increased compared to the starting dispersion. The material selection, as well as the setting of the crosslinking intensity, controls the transport control properties.

The described procedure according to the invention allows in a simple manner both local and extensive coating of items and of complex geometries which are not accessible to the sputtering method or are accessible to it only with great technical effort.

DE 103 537 56 A1 discloses antimicrobial, preferably non-cytotoxic coatings which resemble in their composition the crosslinked layers which can be produced by means of the method according to the invention. The aforementioned Offenlegungsschrift forms part of the present application by way of reference. Reference is made, in particular, to Sections 11 and 20 to 22 in relation to the transport control layer and to Sections 12 to 15 with regard to the nature and form of the biocidal nanoparticles. Section 26 provides the person skilled in the art with information concerning the amount of nanobiocide required to configure non-cytotoxic surfaces.

In accordance with the foregoing, the third, preferred embodiment of the invention includes a layer according to the invention or an item according to the invention, wherein the crosslinked layer comprises biocide nanoparticles and the layer without the nanoparticles is a matrix material for the nanoparticles having a porosity which is set in such a way that the biocidal active substance can be discharged from the matrix material.

Preferably, items according to the invention of the third embodiment of the invention are characterized in greater detail in claims 37 to 48.

8.4 Corrosion Protection and Tarnish Protection

According to a fourth preferred embodiment of the invention (referred to hereinafter also as the fourth embodiment), the layers produced in the method according to the invention are used as corrosion protection layers. Similar corrosion protection layers are disclosed in EP 1 027 169 which is incorporated into this application by way of reference. This applies in particular to the references to the properties and compositions of the respective corrosion protection layers.

The crosslinked coatings generated in the method according to the invention are ideal for producing anticorrosive coatings. In this case, the following aspects are relevant:
a.) Crosslinked layers are chemically and thermally particularly stable owing to their three-dimensional crosslinking.
b.) In contrast to plasma-polymeric coatings, crosslinked layers can coat defects, in particular undercuts, pores and other “cavities”, more effectively. They are therefore also well suited to ensuring effective corrosion protection on rough surfaces so that, compared to plasma-polymeric coatings, less stringent requirements must be placed on smoothing as a pretreatment. In addition, they incorporate dust, thus allowing further defects to be avoided.
c.) Crosslinked layers can be filled with corrosion protection inhibitors in a simple manner.
d.) The precursors for crosslinked layers may advantageously be applied in cleaning baths, so that they uniformly wet the surface of the component after the cleaning.
e.) Crosslinked layers are tolerant to a large number of metal working auxiliaries, such as for example mineral oils, as these substances can in many cases also be crosslinked and incorporated into the coating.
f.) The liquid precursor can penetrate eloxal pores, so that the crosslinked layer is a new type of seal of the eloxal surface. In addition, the base resistance of this new type of eloxal surface is significantly improved. Combination with both colored eloxal and sandoral methods is provided.

Therefore, according to the fourth embodiment of the invention, the invention includes an item comprising a corrosion-sensitive surface on which the crosslinked layer is arranged.

Preferred embodiments are characterized in greater detail in claims 49 to 53.

The fact that the coating method can be carried out at room temperature is advantageous when attaching the crosslinked layer, produced in the method according to the invention, as the corrosion protection layer.

It is in this case preferable for the surface to be coated (the substrate) to be subjected to mechanical, chemical and/or electrochemical smoothing in a pretreatment step.

Furthermore, it is advantageous for the substrate to be able to be coated with the liquid precursor during the cleaning and for the precursor to be able to be directly crosslinked in the cleaning equipment by means of the method according to the invention, as low equipment costs are required for the method. For example, the liquid precursor may be a part of a cleaning bath or a cleaning liquid in a cleaning installation. The crosslinking can be carried out, for example, within a drying oven or else directly in the cleaning installation.

In a preferred coating method corresponding to the fourth embodiment of the invention, a reducing or oxidizing plasma is used for the cleaning and activation of the surface.

In a likewise preferred coating method corresponding to the fourth embodiment of the invention, UV radiation, in particular UV radiation from excimer lamps, is used for the cleaning and activation or for the solidification of (excimer-)crosslinkable contaminations of the surface. For example, liquid contaminations, such as for example mineral oils, act in this case as precursors.

In a further preferred method, the substrate to be coated is subjected to a combination of mechanical surface treatment and scouring before it is coated.

In any case, the person skilled in the art will take care to ensure that sufficient crosslinking takes place and, in particular, optimum adhesion to the base is produced. Good adhesion of the coating to the base is provided, for example, when cross-hatch adhesion values of GTO are achieved. Especially adhesively secure layers are, after a cross-hatch adhesion test of this type, not subverted even under corrosive loading, for example in a salt spray test.

It is advantageous that, within the scope of the crosslinking of the liquid precursors by means of UV radiation from excimers, eloxal surfaces can at the same time be compacted.

Preferably, for the fourth embodiment of the invention, the crosslinking process is carried out as a result of the UV irradiation in an atmosphere made up of oxygen and/or nitrogen and/or a noble gas and/or dried air or a corresponding mixed gas atmosphere, the atmosphere preferably being pressure-reduced. The reduction in pressure may also be advantageous irrespective of the selected atmosphere.

In a preferred method according to the invention as claimed in the fourth aspect of the invention, the liquid precursor is applied at a thickness of from 5 nm to 10 μm; more preferably, the liquid precursor comprises a corrosion protection inhibitor.

The fact that the mixture applied in the method according to the invention comprises, in addition to the liquid precursor, compounds having cleaning functions for the surface to be coated is also advantageous for this aspect of the invention.

Also advantageous is a mixture for the method according to the invention that contains constituents which lead to compacting of the surface of the substrate within the scope of the irradiation and display a kinematic viscosity of ≦100,000 mm²/s at 25° C., for example a corresponding PDMS silicone oil such as for example Wacker silicone oil AK 25 or AK 10000.

Preference is given to a method in which the precursor is applied by an aerosol method, a dipping method, a spraying method or a roll-to-roll method. Particularly preferred are in this case anticorrosive coatings on flat substrates and web materials made of metals.

For the purposes of corrosion protection, it is preferable to generate a closed coating according to the invention on the surface to be protected. Local differences in layer thickness are initially to be regarded as being of secondary importance, provided that comparable layer properties with respect to corrosion protection are set over the entire surface.

However, the differences in layer thickness influence the optical appearance of the coating, as the applied thin layers convey a color impression to the viewer as a result of interference. Closed coatings having local layer thickness deviations of below 10%, based on the average layer thickness, are therefore particularly preferred. These coatings convey an optically unitary coating color to the viewer.

Uniform liquid layers can be applied by dipping methods, by roll-to-roll systems or other methods known to the person skilled in the art.

Also particularly preferred are closed coatings having local differences in layer thickness in the range of from 20% to 200%, based on the average layer thickness, the entire range of variation in layer thickness within a lateral section of 100 μm being assumed on the surface of the crosslinked layer. Such rapid variations in layer thicknesses cannot, on account of their magnitude, be resolved by the naked eye. Whereas under a microscope the various layer thickness ranges are clearly discernible as a result of the associated interference color, macroscopically the coating appears almost colorless. Layer thickness distributions of this type can be implemented preferably by way of spraying methods or aerosol condensation.

More preferred are closed coatings having local differences in layer thickness in the range of from 50% to 100%, based on the average layer thickness, the variation in layer thickness within a lateral section of 200 μm being assumed on the surface of the crosslinked layer.

Also preferred is a coating method according to the invention in which a plurality of cycles of the method according to the invention (alternating application of the liquid layer and subsequent curing) are carried out and in this way a multilayer system is implemented. In this case, it is quite possible for the same precursor material to be used in the various cycles. It is possible to reduce coating errors in this way. Coating systems having successively rising layer thickness are preferred. Particularly preferred is a two-layer system consisting of a base layer having a layer thickness of below 100 nm after UV crosslinking and a cover layer having a layer thickness of above 200 nm after crosslinking. An average total layer thickness in the range of from 170 to 210 nm is also preferred.

8.5 Parting Layers

According to a fifth preferred embodiment of the invention (also referred to hereinafter as the fifth embodiment), it is possible, by means of the method according to the invention, to produce layers according to the invention and to apply them to products, the layers having a parting function. Certain parting layers have already been described within the scope of the second preferred embodiment in the invention and are also to be understood as being a special embodiment of the fifth embodiment of the invention.

Permanent Parting Layer:

Parting agents are conventionally used, for example in the molding of plastics materials, to facilitate the parting of the molded item (molding) from the molding tool.

Parting agent systems are known in the prior art, for example in the form of solutions or dispersions which are normally sprayed onto the surface of the molding tool. These parting agent systems consist of parting active substances and a carrier medium, generally organic solvents, such as for example hydrocarbons (including in some cases chlorinated), and water. Sprayed-on parting agent systems of this type part substantially always separate the molding from the molding tool by way of a mixture of a cohesive failure and an adhesive failure, although usually parting agent remains on the molding to be parted. In many cases, this can lead to difficulties in further processing, for example during adhesive bonding, laminating, painting or metal coating of the molding. A cleaning step must therefore be interposed, causing additional costs. In addition, prior to each removal from the mold (or at least regularly), parting agent must be applied to the surfaces of the molding tools; this is also cost-intensive and can lead to non-uniform demolding results. Finally, these parting agent systems emit large amounts of solvents into the environment.

Accordingly, the invention includes the use of an (excimer-)crosslinked layer, produced in a method according to the invention, for reducing the adhesion of a molding tool in relation to a molding. Thus, the coating acts as a semi-permanent or permanent parting layer or as a parting aid in relation to reduced amounts of parting agent or simplified parting agents or internal parting agents. The invention therefore also includes an item according to the invention, wherein the item is a molding tool coated with a crosslinked layer.

The layers applied by means of the method according to the invention are suitable not only for the coating of metallic molds, but also for the coating of plastics materials and glasses. The latter aspect is especially important because these materials are required as part of molding tools to process UV-curing paints or plastics materials. In this case, preferably at least a part of the molding tool is designed as a glass component so that, after the injection/flooding of the mold with the photocurable mass, the irradiation can be carried out through the crosslinked layer and the coated glass mold for the purposes of curing. For high-quality component surfaces, use is expediently made of a permanent parting layer, as a permanent parting layer, unlike conventional liquid parting agents, does not discharge any substances to the component to be produced.

In addition to good parting properties, a corresponding coating must have very high transparency in the UV range used. This can be presented using both plasma-polymeric parting layers and the crosslinked layers which can be produced in the method according to the invention. However, the method according to the invention has the advantage of being much simpler, quicker and more economical to carry out. It is even possible to coat the surface of the mold without dismantling the mold from the installation.

For the production according to the invention of a parting layer of this type, use is expediently made of silicone oils as the precursor. The AK Series from Wacker Chemie AG, for example, offers products which differ with regard to chain length and viscosity. In general, all products from AK1 may be used, including in any desired mixture with one another. The low surface energy of the oils ensures good wetting of the cleaned surface of the workpiece. If necessary, the surface of the component is suitably cleaned prior to the application of precursor.

When applying the oils, it is expedient to operate at layer thicknesses of between 100 and 1,000 nm. Nevertheless, lower or higher layer thicknesses are also possible. The person skilled in the art will orient the layer thicknesses in accordance with criteria such as wear resistance or the need to precisely image contours. Higher layer thicknesses offer higher wear resistance.

During the crosslinking, preferably by means of excimer lamps, care should be taken to ensure that the irradiation intensity is selected in such a way that, on the one hand, a sufficiently rigid network is produced but, on the other hand, not too many organic groups are removed from the surface.

Fluorinated silicone oils and fluoro-organic oils may be used as an alternative to the aforementioned silicone oils. In the production of layers from these material classes too, the person skilled in the art will take care to prevent an excessively large number of CF₃ groups from becoming lost by way of excessively intensive crosslinking. Furthermore, he will characterize in greater detail the resulting layer by means of contact angle measurement or ESCA analysis. Good parting layers display in any case on smooth surfaces water contact angles of >100°, preferably >105°.

Furthermore, it is advantageous if oxygen/air can be excluded on the surface during the curing. This can be achieved, for example, with the aid of nitrogen gassing.

A further advantage is obtained if it is possible to operate within low-pressure equipment and, after the curing, the remaining radicals can be abreacted in a targeted manner. The use of H₂ or compounds with conjugated or non-conjugated C—C double bonds, such as vinyltrimethylsiloxane VTMS, C₂H₄, isoprene, methacrylates, is for example expedient in this regard. These gases or vapors can be brought into contact with the surface both as pure gases and in mixtures, for example, with inert gases such as nitrogen or noble gases such as argon.

In the coating according to the invention of UV-transparent materials, it is procedurally advantageous if the liquid precursor is crosslinked through the UV-transparent material. The arrangement is therefore selected in such a way that the UV light first strikes the material to be coated, penetrates the material and then crosslinks the liquid precursor applied thereto.

In the coating of molds which were operated using conventional parting agents, it is expedient to crosslink the remnants of parting agent, which remain despite cleaning, with the aid of UV radiation, preferably radiation at a wavelength of <250 nm, particularly preferably radiation from excimer lamps, at high intensity, so that they lose their parting properties and provide a suitable adhesive base.

As conventional liquid or paste-like parting agents are in many cases produced on the basis of waxes or silicone oils, substances of this type are also suitable as precursors for the production of crosslinked permanent parting layers.

8.6 Easy-to-Clean Layers

8.6.1 Surfaces which are Easy to Clean by Way of Suitable Surface Chemistry

According to a sixth preferred embodiment of the invention (also referred to hereinafter as the sixth embodiment), it is possible, by means of the method according to the invention, to generate and to apply (to products) layers according to the invention which are similar in their structure to easy-to-clean layers such as are disclosed in the application in WO 03/002269 A2. The aforementioned Offenlegungsschrift is thus incorporated into the present application by way of reference; this applies in particular to the advantages of the aforementioned layers and their properties, such as they are disclosed in the aforementioned document.

The (excimer-)crosslinked easy-to-clean layers which are generated, in accordance with the sixth embodiment of the invention, in the method according to the invention are constructed on an organosilicon or fluoro-organic basis. They correspond in their properties to the layers disclosed in the aforementioned WO specification. In particular, they are easy to clean. The person skilled in the art is capable of generating, by selecting the suitable precursors and by setting suitable UV crosslinking conditions in the method according to the invention, in particular by means of excimer lamps, layers or items according to the invention as described hereinafter:

Accordingly, the sixth embodiment of the invention includes a layer according to the invention or an item according to the invention, wherein the crosslinked layer is a silicon, oxygen, carbon and hydrogen and/or fluorine-comprising layer for which, during determination by means of ESCA, the following applies:
The ratio of the quantities of substances O: Si is >1.25 and <2.6
and the ratio of the quantities of substances C: Si is >0.6 and <2.2.

Preference is given to an item according to the invention as claimed in the sixth embodiment of the invention, wherein the crosslinked layer contains, based on its total atomic number without hydrogen
at least 20 and at most 30 atomic percent of Si,
at least 25 and at most 50 atomic percent of O and
at least 25 and at most 50 atomic percent of C.

More preferred is an item according to the invention, wherein the crosslinked layer comprises hydrogen and/or fluorine, wherein the following applies:
1.8:1 n(H and/or F):n(C)<3.6:1 preferably
2.2:1 n(H and/or F):n(C)<3.3:1.

More preferred is an item in which the crosslinked layer has a water contact angle of above 90°, preferably above 95° and more preferably above 100°. According to the invention, preference is given to an item comprising a crosslinked layer, as defined above in the sixth embodiment of the invention, which is selected from the group consisting of: rim, hub cap, aluminum profile, anodized aluminum component, in particular for fittings, windows, showers, cars; windows, linings, wind turbine blades, metal facing, in particular for houses, in particular for kitchens or kitchen appliances; display, in particular for kitchens, in particular for cell phones; glazings, car body parts, car interior parts, rim, motorcycle parts, beverage container, colorant container, ink container, ink cartridge, bottle, kitchen appliance, frying pan, information sign, warning sign, reusable vessels for food products, such as for example bottles or vats; wood surfaces, lacquered or varnished wood surfaces, textiles, baked goods carriers, components for paint booths, gratings, coating racks and hooks, molds for producing food products, such as for example chocolate or gummy bear molds, molds for producing rubber, in particular tires and condoms, pacifiers, teats.

Preferred easy-to-clean layers are fluorine-free and/or have a roughness value Rₐ of <1 μm, preferably ≦0.3 μm, preferably <0.1 μm at their surface.

The easy-to-clean layers described in this chapter are preferably easy to remove paint from and redesigned for simple cleaning with dry ice; this makes them particularly readily usable as an easily cleanable protective layer within painting installations or for items used in painting.

8.6.2 Surfaces which are Easy to Clean by way of Smoothing or Sealing of surface Unevenness

In surfaces having open pores or other forms of surface unevenness, it should be noted that impurities are deposited in depressions and thus act as an anchor which is often not reached by the cleaning process. In disadvantageous cases, the contamination produces in this way a permanently visible contrast.

The method according to the invention allows surface pores or depressions to be closed: The applied liquid preferably tends to enter, following gravity, the depressions or is sucked into the surface pores as a result of the capillary effect. Surface sealing and smoothing can be achieved in this way. Impurities cannot, as in the past, penetrate the surface structure or become caught at exposed sharp edges.

Transparent, smoothing, hydrophobic, organosilicon-based coatings are preferred.

8.7 Integration of Solid Particles

According to a seventh preferred embodiment of the invention (also referred to hereinafter as the seventh embodiment), the method according to the invention is used to produce layers or items according to the invention comprising in the crosslinked layer solid particles which were applied at the same time as the liquid precursor. Examples of particles of this type are also described hereinbefore.

In particular, the method according to the invention allows particles having a size of between 10 nm and 20 μm to be applied in a coating. It is possible to generate, in a manner which may be adjusted by way of the irradiation parameters, in particular the UV process parameters such as the duration of treatment, intensity, the composition of the atmosphere and the distance from the radiation sources, crosslinked layers which are bound to the (original) solid particles or into which the corresponding particles are merely embedded. In addition, by conducting the process accordingly, it is possible to configure the layers in such a way that the embedded particles protrude beyond the surface of the crosslinked layer produced in the method according to the invention.

Alternatively, it is also possible to re-remove parts of the crosslinked layer using suitable abrasion methods, wherein care should be taken to ensure that the particles themselves are not removed. This allows parts of the surfaces of the particles to be exposed. The total area exposed can be set, for example, by way of the particle size, by way of the concentration of the particles in the matrix of the layer crosslinked in accordance with the invention or by way of the UV process parameters.

It is thus possible to provide laterally isolated particle surfaces which are suitable for a large number of applications:
for heterogeneous catalysis through corresponding catalytically active particles.
as an anchor point for the fixing/heterogenizing of homogeneous catalysts, for example for enzymes or other biocatalysts, or other active substances for example for chemical, biochemical or biotechnological reactions or for a functionalization of technical surfaces, for example for reduced drop (fog) or frost formation or reduced adhesion/growing of microorganisms or algae. In this case, the active substances can also be fixed via spacer molecules.
as an anchor point for the fixing of sensor substances, for example biosensors such as antibodies as immunosensors, for chemical, biochemical or (micro)biological analysis or molecular diagnosis such as, for example, for detecting antibodies in the blood or detecting pathogens in aqueous liquids. In this case, the active substances can also be fixed via spacer molecules. A specific example of this is the fixing of antibodies or oligonucleotides to exposed nickel particle surfaces via nickel chelates such as nickel nitrilotriacetic acid (Ni—NTA).
as an interface for a (minimal) discharge of active substances from the particles; for example antimicrobial active substances, pesticides, homogeneous (bio)catalysts, enzymes, hormones, nutrients, odorous and aromatic substances, surfactants. This discharge of substances may be presented in a flexible manner: both in such a way that over a relatively long period of time just tiny traces of active substances migrate and also in such a way that after an initiation, for example contact with a suitable medium and/or as a result of heating and/or as a result of light, the discharge comes to a standstill within a short time. This can be implemented both in such a way that the particles themselves are consumed during the discharge and also in such a way that the particles, in turn, function as a matrix in which the active substances are stored.

8.8 Adhesion Promoter Layers, Primer Layers, Functionalized Surfaces

According to an eighth preferred embodiment of the invention (referred to hereinafter also as the eighth embodiment), a method according to the invention allows adhesion promoters and primer layers to be generated and/or applied to a surface or functionalized surfaces to be generated.

Adhesion promoters and primer layers are distinguished in that they themselves build up good adhesion to the base and at the same time provide at the surface functional groups which allow optimum binding of further substances such as adhesives, colorants, paints or metal coats.

They are used in all cases in which simple cleaning or activation is not sufficient because special functional groups are required or additional protection of the surface is necessary.

Such layers can be produced in an ideal manner with the aid of the crosslinked layer produced in the method according to the invention. The procedure is in this case as follows:

1. cleaning and if appropriate surface functionalization of the component

2. wetting with a liquid precursor at the desired layer thickness

3. crosslinking by means of radiation of ≦250 nm, preferably excimer lamp radiation, wherein

a.) the surrounding gas atmosphere is selected in such a way that suitable groups are available for the subsequent adhesion promoter and primer function and

b.) the irradiation conditions of the liquid precursor are selected in such a way that radicals are generated at its underside and, if possible through the wetted material, at its surface.

Steps 1 and 2 can also be combined in a cleaning installation into one step. If there is defined soiling, for example an oil from a preceding metalworking step, then the oil may be used if appropriate also directly as the precursor.

The person skilled in the art will take care to ensure that the liquid precursor to be crosslinked is applied preferably at layer thicknesses of up to 100 nm. This will generally enable him easily to ensure that a sufficient number of radicals are produced also on the underside of the layer made up of liquid precursor. If the wetted material is a plastics material, then the radiation can also produce on its surface radicals which can interact with the radicals in the liquid precursor. This allows a good material composite to be produced. Furthermore, simple variation over time will enable the person skilled in the art to establish optimum adhesive strength between the base material and the (previously) crosslinked liquid precursor. Overtreatment, as a result of, for example, an excessively long action time, will, again, lead to a weakened composite, as the base may become badly damaged as a result of too many chain breaks and on the other side the liquid precursor may become overhardened and cracked, for example if organosilicon precursors are used because the C content in the layer becomes too low.

When selecting the surrounding gas atmosphere, the simplest possibility is to use oxygen-containing gases such as air, oxygen, CO₂ or N₂O. These gases can also be excited as a result of the radiation used and must react with the radicals at the precursor surface. In addition, O₂, in particular, is known as a so-called radical scavenger, as a substance which reacts with radicals and leaves behind oxygen-containing functionalities. The “functionalizing” gases are mixed, as required, with other gases, in particular nitrogen and/or noble gases or supplied in a suitable order to the region of interaction between the surface and radiation source. In specific cases, the “functionalizing” gases are not added to the gas atmosphere until the end of the crosslinking process.

However, use is also made of other gases, such as NH₃ for generating nitrogen-containing functionalities. The aim is in any case to generate functional groups such as hydroxy, amino, ester/acid, keto, aldehyde, cyano or ether, thus allowing a suitable interaction of the above-mentioned polymer systems (adhesives, paints, colorants) or metals on the layer crosslinked in accordance with the invention.

If an adhesion promoter is to be produced for rubber materials, then a large number of carbon double bonds should be introduced into the surface. For this purpose, it is expedient to generate gas atmospheres having a content of conjugated or non-conjugated substances such as conjugated or non-conjugated dienes such as, for example, 1,4-hexadiene, 1,3-butadiene or isoprene.

In addition to the functionalization as a result of the presence of corresponding gases throughout the excimer crosslinking, the functionalization can also take place, for a more intensive concentration on the surface and/or a lower density of the occupancy with functional groups, in the sense of a grafting following the actual excimer crosslinking. For this purpose, suitable gases are brought into contact with the substrate surface after the crosslinking without prior venting. Suitable gases are for example:
conjugated dienes such as isoprene or non-conjugated dienes such as, for example, 1,4-hexadiene for providing double bonds
styrene for providing phenyl groups
acrylonitrile for providing cyano groups
acrylic acid for providing acid groups
tribromomethane for providing bromine groups
glycidyl methacrylate for providing epoxide functionalities
vinyl sulfonic acid or a mixture of chlorine and sulfur dioxide for generating sulfonic acid groups

Likewise, this functionalization can be carried out by adding the gases at the end of the coating method according to the invention. For more efficient surface functionalization, use may also be made of, instead of the gases, corresponding liquids, for example the solutions of corresponding substances in organic solvents.

Furthermore, for certain combinations of the substrate surface and adhesive or coating substance, the fact that the coating according to the invention allows in the first place a leveling or smoothing of the surface to be achieved may be advantageous.

A spreading of the liquid can be achieved using liquids having low surface tension and/or surfaces having high surface energy. That is to say that the liquid tends to cover the surface uniformly. Furthermore, in the non-crosslinked state, the liquid will be able to fill up, following gravity, depressions more effectively than peaks in the surface profile; pores are filled up as a result of the capillary effect. Thus, an at least partially smoothed and sealed surface is available after crosslinking of a liquid layer of this type.

The effect of the smoothing can be influenced by the applied layer thickness and must be compared with the average roughness of the uncoated surface. Layers according to the invention having an average layer thickness in the range of from 10 to 80 percent of the arithmetic roughness Rₐ of the untreated surface are preferably used. The roughness values are determined before and after the coating. In this case and throughout the text, unless otherwise indicated, the roughness is determined in accordance with DIN EN ISO 4287. In particular for highly viscous adhesives and/or coating substances which copy the surface topography only to a limited extent, this smoothing effect can be advantageous in order to increase the effective adhesive area. Thus, the coating according to the invention serves as an intermediate layer compensating for unevenness in ranges of below 100 micrometers.

The adhesion between two layers is influenced not only by chemical bonding but also by physical interaction. As a result of the use of liquids having a thorough wetting effect, the coating according to the invention generates a smoothing intermediate layer which is in very close contact with the substrate surface. As a result of the very close contact, the layer according to the invention obtains the necessary high adhesion to the substrate surface. For high adhesion of the adhesives and/or coating substances subsequently to be applied, use is made of preferably a layer according to the invention having high surface energy, particularly preferably a hydrophilic layer.

8.9 Electrical Insulation Layers

According to a ninth preferred embodiment of the invention (referred to hereinafter also as the ninth embodiment), it is possible to produce, by means of the method according to the invention, items with an electrical insulation layer, the insulating layer being a hydrophobic layer crosslinked in accordance with the invention. The latter aspect is also part of the invention.

For the production of electrical insulation layers in the method according to the invention, silicone oils are preferably expedient as liquid precursors, since crosslinked silicones are known for their excellent electrical properties. However, partially or fully fluorinated oils are, for example, also possible.

The person skilled in the art will use, for the method according to the invention as claimed in the ninth embodiment, preferably long-chain polymethylsiloxanes or polymethylphenylsiloxanes and subject these to a short crosslinking reaction by means of UV radiation, preferably radiation at a wavelength of <250 nm, particularly preferably radiation from excimer lamps, in order to crosslink them just enough and, if appropriate, to establish sufficient adhesion to the base. Furthermore, he will take care both to ensure that he generates a layer thickness which is sufficient for the application and to ensure production which is as defect-free as possible. He will therefore take care to ensure excellent surface wetting by the liquid precursor of the surface to be coated and attach importance to dust-free machining.

8.10 Locally Located Coatings

According to a tenth preferred embodiment of the invention (referred to hereinafter also as the tenth embodiment), the (excimer-)crosslinked layers produced in the method according to the invention are used as locally located layers.

The purposeful construction of three-dimensional microstructures, for example by a multilayer construction, is possible with the aid of UV lasers but also UV excimer lamps, for example in lithography installations. In this case, a “rapid prototyping on the micrometer and nanometer scale” could for example be carried out. This would allow, for example, a rapid examination of microstructured surfaces for their properties, for example for the optimization of structures for generating flow-favorable surfaces (both in gases and in liquids) and also the production of matrixes for plastics material processing.

Locally located coatings are required in a large number of technical applications. In this case, a distinction must be drawn between statistically distributed locally located coatings (for example an anti-fingerprint coating) (see also hereinafter) and locally precisely defined regions in which the coating is required (for example in the manufacture of integrated circuits). Large user industries are for example the semiconductor and photovoltaic industry, micromechanics and microsystems engineering, but also the industry for manufacturing LEDs.

In particular in the case of microsystems engineering and the semiconductor industry, a coating of this type according to the invention or a coating crosslinked in a method according to the invention can be applied, quite particularly as a configuration according to the tenth embodiment of the invention, in a photolithographic method. In this case, in accordance with the invention as claimed in the tenth embodiment of the invention, the (excimer-)crosslinked layer produced in the method according to the invention renders the use of a photoresist (photographic layer construction) superfluous. This greatly simplifies the manufacture of integrated circuits, as a multistage procedure (for example in a simplified account: production of an insulation layer, coating with a photoresist, local curing of the photoresist (photolithography process), removal of the non-cured photoresist, etching of the insulation layer in the non-covered region, removal of the cured photoresist) can be replaced by a much less complex process as the method according to the invention (application of the liquid precursor, local crosslinking in a photolithography process, removal of the superfluous precursor). The dimensions which can be produced by this photolithographic layer application are sufficient for those in conventional technology.

Likewise, what is known as nanoimprint technology (“Providing a Direct-LIGA Service—A Status Report”; BERND LOECHEL, Anwenderzentrum Mikrotechnik—BESSY and M. Colburn et al., “Step and Flash Imprint Lithography: A New Approach to High-Resolution Printing,” Proc. SPIE, 1999, p. 379. and U.S. Pat. No. 7,128,559), of which there are various variants, can be simplified. The basis for nanoimprint technology is a UV-transparent embossing mold which must preferably also have good release properties so that the embossing mold may be re-removed from the UV-cured paint. The demolding leads again and again to quality problems, in particular in small structures.

In accordance with the method according to the invention of the tenth embodiment, the embossing mold is dispensed with, the substrate is wetted uniformly with the desired precursor. Afterwards, the exposure by means of UV radiation takes place, for example by excimer lamps, preferably in a lithography installation (with a photomask) or by excimer lasers. Crosslinking takes place only in the exposed regions. The non-crosslinked precursor can easily be re-removed by means of solvents.

The coating sharpness is promoted in particular as a result of the fact that the liquid precursor does not use any photoinitiators which activate a chain reaction. In contrast to polymerization, no dark reaction takes place in the absence of radiation. On the contrary, crosslinkings are carried out only where individual radicals, which can react with one another, are generated. No distant effect takes place.

The coating is in particular in the form of insulating coatings, such as are discussed in the electrical insulation layers section.

In order to optimize specific coating properties, such as for example conductive properties, it may be necessary, after the crosslinking, to purposefully modify the coating crosslinked in accordance with the invention under oxygen or inert gas and in particular to (partially) remove organic residues.

Locally located coatings according to the invention can of course also be carried out by means of a laser having radiation emission in the wavelength range of below 250 nm. In this case, the laser light is guided over the surface, which was provided beforehand with liquid precursor, or the surface itself is moved in a suitable manner relative to the laser beam, so that only the exposed regions cure. In this case, care must be taken to ensure that the supplied energy does not lead to local overheating and thus to extensive destruction of the precursor.

8.11 Optical Functional Layers

According to an eleventh preferred embodiment of the invention (referred to hereinafter also as the eleventh embodiment), it is possible, by means of the method according to the invention, to generate layers according to the invention and to apply them to products which impart optical functions to be surface to which they were applied. In this case, it is possible to produce coatings having different optical properties such as, for example, in the index of refraction (cf. Example 4 in this regard). In this way, it is possible to generate, in particular, optical functional layers such as, for example, filters, bandpass filters, anti-reflection (AR) layers or high-reflection (HR) layers, amplitude and phase gratings, coatings having non-linear effects, etc.

On appropriate selection of the process parameters, it is in accordance with the invention possible to purposefully set the index of refraction for the crosslinked layer. The optical properties of the coatings can be controlled in this way.

The measurements in the examples demonstrate that it is possible to produce coatings having different optical properties, in this case the index of refraction. On skilled selection of the process parameters, it is possible to purposefully set the index of refraction for the crosslinked layer. The optical properties of the coatings can be controlled in this way.

Applications according to the invention as claimed in the eleventh embodiment of the invention will be described hereinafter by way of example:

Wavelength-Specifically Reflective Coating

The method according to the invention can be used to produce a thin layer coating which is transparent or partially transparent, i.e. preferably the coating is transparent for a part of the infrared, the visible and the UV spectral range. In addition to the transmitted radiation, a part of the radiation striking the layer is reflected. By selecting the index of refraction and the applied layer thickness, a high degree of reflection can be achieved for individual wavelengths or for a wavelength range. The index of refraction and layer thickness can be determined by way of known formulae of optics (including Fresnel formulae). For example, at a layer thickness of 160 nm and an index of refraction of n=1.4, light of the 448 nm wavelength can be effectively reflected. In this case, the surface appears blue owing to interference effects under an incidence of light of 0°.

A coating of this type can be used as a color-imparting coating, for example in the design field. A substrate coated in this way can be used as a filter to filter out specific wavelengths.

It is also possible to provide regions of a surface with coatings of different layer thickness or to carry out the application of the liquid precursor or the exposure to radiation only locally, so that locally different wavelengths are preferably reflected. These locally wavelength-specific reflection properties can be used to implement beam formers for optics or to produce locally selective filters, beam splitters for optics, or “multicolored” decorative coatings.

Further exemplary aspects of the eleventh embodiment of the invention will be addressed hereinafter:

Wavelength-Specifically Transmitting (Anti-Reflective) Coating

In accordance with the foregoing example of a reflective coating, the coating parameters may be designed in such a manner that an individual wavelength or a wavelength range is effectively transmitted. For example, a coating having a layer thickness of 130 nm and an index of refraction of n=1.4, applied to a glass substrate, can effectively transmit light of the 728 nm wavelength. In this case, red light is effectively transmitted owing to interference effects under an incidence of light of 0°.

A coating of this type can be used as an anti-reflection coating, for example for spectacles, windows, panes of glass, objectives, copiers, scanners, screens or glossy, polished, flat surfaces. A substrate coated in this way can be used as a filter to effectively transmit specific wavelengths.

Likewise, it is possible to provide limited regions of a surface with coatings of different layer thickness, so that different wavelengths are preferably transmitted. This produces locally wavelength-specific transmission properties which can be used to implement locally selective filters or beam splitters for optics or general modification of the intensity in the beam profile of a striking light beam (beam shaping).

Phase Objects and Phase Gratings

Phase objects are distinguished in that they introduce phase differences between the local partial beams in the transmitted light; the intensity is not altered.

If use is made, in the exposure to radiation (crosslinking), of masks or filters or technical auxiliary devices which ensure that the applied liquid precursor is locally exposed or crosslinked at different intensity or for a different duration, then local differences in the index of refraction can be generated in the coating. These cause different optical paths within the coating according to the invention and thus lead to a phase difference after issuing from the layer.

Coatings of this type can be used in optics to carry out purposeful modification in a light beam, for example Fourier transformations, or for generating beam shaping optics, holograms, phase gratings, etc.

Amplitude Objects and Amplitude Gratings

Amplitude objects are distinguished in that they introduce differences in intensity between the local partial beams in the transmitted light.

After application of the liquid precursor, the applied liquid film can be only locally exposed or crosslinked with the aid of masks or filters or other technical auxiliary devices. If the precursor layer, which is still liquid, is subsequently removed from the non-exposed regions, then local changes in amplitude can be generated in the coating for radiation striking the substrate.

Alternatively, it is possible first to carry out the method according to the invention without the use of masks or filters and subsequently to post-treat the coating with the aid of masks or filters in order to implement the necessary local changes in intensity. Such post-treatment may be for example a layer ablation, layer shrinkage or secondary crosslinking, including by renewed irradiation with UV light sources such as excimer lamps or lasers, or include other processes such as for example etching, etc.

A further alternative is the local application of the liquid precursor prior to the crosslinking.

All three variants lead to local changes in amplitude for radiation striking the substrate, which changes may be utilized in optics for beam modification or analysis, for example beam shaping, Fourier transformations, generating of holograms, amplitude gratings, etc.

8.12 Anti-Fingerprint Coatings

According to a twelfth preferred embodiment of the invention (referred to hereinafter also as the twelfth embodiment) it is possible, by means of the method according to the invention, to generate layers according to the invention and to apply layers to products which display what is known as the anti-fingerprint effect:

The method according to the invention allows layers to be generated in an alternative method to the plasma method which was described in PCT/EP2006/062987. This application describes a method in which a surface having an anti-fingerprint effect is generated. The cited application is incorporated into the present application text by way of reference.

The anti-fingerprint effect is based on producing a coating which reduces the optical contrast of a finger mark to the extent that the contrast is barely optically perceptible to the human eye. The reduction in perceptibility is based on providing a coating consisting of a thin, non-uniform, insular cover having lateral dimensions in the range of from 1 to 100 μm. The thin, insular coating having an average layer thickness preferably in the range of from 10 to 300 nm causes, as a result of interference, a microscopic play of colors that imitates the effect of a covering of a finger mark.

The thin-layered, insular coating can be generated if the surface with the liquid precursors are only partially covered and crosslinked, or the precursor is applied over the entire area and is crosslinked only locally, for example by masks or targeted irradiating with a laser, or the precursor is applied over the entire area and crosslinked over the entire area and subsequently is locally re-removed, for example by masks or targeted irradiating with a laser.

The physical and chemical properties of the liquid precursor can be utilized for generating a local cover. For example, a precursor having a low surface tension can be used to achieve, by spreading, very thin covers of below one micrometer (area-to-height ratio: large). Precursors having high surface tension tend, on the other hand, to form droplets (area-to-height ratio: small), so that the droplet pattern which is produced provides at the same time local covering of the still-liquid precursor. In addition, it is possible to draw on the fact that a liquid precursor is deposited more intensively in the depressions of a surface than on the profile peaks. Finger fat is, on the other hand, preferably transferred to the peaks of a surface profile. The resulting placing-next-to-one-another of the anti-fingerprint coating in the depressions and the finger fat on the profile peaks, both types of layer having similar optical properties, allows the targeted contrast reduction to be achieved.

It has proven possible to effectively produce corresponding anti-fingerprint coatings by means of the method according to the invention, the crosslinking according to the invention of a layer on a liquid precursor by means of radiation of ≦250 nm, in particular by excimer lamps (cf. also the “Locally located coatings” section in this application. This contains further information for generating anti-fingerprint coatings according to the invention).

In this case too, preference is given to surfaces for coating that have naturally or by corresponding preprocessing an average roughness Ra of from 0.3 to 1.2 μm. The layer crosslinking with UV radiation of below 250 nm is able to crosslink insular liquid covers effectively, i.e. within a much shorter time compared to plasma curing, and also under atmospheric conditions, i.e. under an ambient atmosphere.

Areas of use of the twelfth embodiment are coatings in the field of domestic and sanitary items such as screens, handles, drain plugs, housings, for example for fittings and mixer batteries, furniture mountings and decorative strips. Items in the automotive sector, in particular in bodyworks, for door and trunk handles, for screens and decorative strips and also in architecture or in the clinical field.

More preferred are metallically glossy surfaces in the aforementioned preferred range of roughness values, particularly preferably electroplated or radiated, metallically glossy surfaces.

Reference is made in this case to the examples.

8.13 Smoothing and Sealing Coatings

According to a thirteenth preferred embodiment of the invention (also referred to hereinafter as the thirteenth embodiment), it is possible, by means of the method according to the invention, to generate layers according to the invention and to apply layers to products which aim to change the topography of a surface.

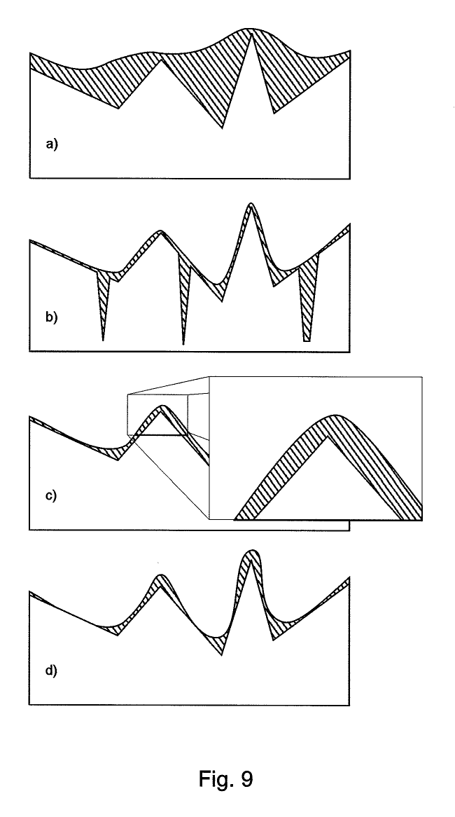

This includes the sealing and the filling-out of submicrometer depressions (pores). It is also possible to achieve a smoothing of the surface roughness or a partial filling-up of the surface topography. A further possibility is the sheathing of sharp edges in the submicrometer range. Certain examples of layers are illustrated schematically in FIG. 9.

FIG. 9 shows schematically:
a) smoothing of the roughness,
b) filling-up of pores and depressions,
c) sheathing of sharp edges,
d) sheathing of profile peaks by “nose formation” on inverted suspension during the crosslinking.

The background of these coating effects is the use of liquid media as the starting material. The liquid media are applied as a thin liquid film to the surface to be coated. Provided that no curing has been carried out, the liquid film may be regarded as being dynamic, i.e. movable. This has the consequence that

a) The liquid infiltrates or is sucked into open pores of the surface as a result of the capillary effect. As a result of irradiation, the pore is subsequently permanently superficially closed.

b) The liquid can collect, following gravity, in depressions of the surface, so that after curing a leveling of the surface topography, in particular of the microscopic roughness values, can be achieved. This is particularly the case when layer thicknesses, comparable to the arithmetic roughness Rₐ (determination of the roughness in accordance with DIN EN ISO 4287) of the uncoated surface, are applied. Preferably, layer thicknesses in the range of from 10 to 80 percent of the arithmetic roughness Rₐ are used for this purpose.

c) Microscopically sharp edges are sheathed by a superficially spreading liquid film. This effect occurs above all on use of liquids having a very low surface tension (less than 30 mN/m) and surfaces having high surface energy (greater than 60 mN/m). This is particularly the case when layer thicknesses much less than the arithmetic roughness Rₐ of the uncoated surface are applied. In this way, the characteristic surface appearance of the uncoated substrate is preserved. Preference is in this case given to layer thicknesses in the range of below 10 percent of the arithmetic roughness Rₐ and/or

d) the liquid can collect, following gravity, on inverted suspension during the crosslinking at the profile peaks and thus forms “noses”. A sheathing of the profile peaks, in particular on very pointed edges, can be achieved in this way.

Coatings of this type display corrosion-inhibiting properties, are suitable as seals, have easy-to-clean properties, as dirt can no longer penetrate the depressions, or edges are smoothed and have a particularly pleasant feel. Furthermore, the roughness of the surface can be smoothed.

The coating can be used as an anticorrosive coating, in particular for metal surfaces, as an easy-to-clean surface, for example in the kitchen, sanitary, automotive, aviation sector, as a primary layer to compensate for the roughness for subsequent painting, adhesive bonding or other successive coatings, as a sealing layer, barrier layer or as a surface coating having pleasant haptic properties for items of daily use such as, for example, office articles, car interiors, control elements, telephones, remote controls, fittings, etc.

In addition, the smoothing of the surface can allow an improvement of the flow conditions as fluid media flow over the surface according to the invention. This applies in particular to the flowing of liquids, for example in the field of microfluidics for applications in areas such as biotechnology, medical engineering, process engineering, sensor technology and in consumer goods.

Accordingly, the invention includes the use of a method according to the invention as described above or a layer according to the invention for smoothing and/or sealing a surface to be coated.

8.14 Structuring, Topography-Imparting Coatings

According to a fourteenth preferred embodiment of the invention (referred to hereinafter also as the fourteenth embodiment), it is possible, by means of the method according to the invention, to generate layers according to the invention and to apply layers to products which aim to create structured topography-imparting layers, i.e. to provide the products with structures which stand out from the uncoated surface.

This type of structuring coating differs from the locally located coating, described as the tenth embodiment, in that, rather than the lateral placing-next-to-one-another of the coating or non-coating being foregrounded, the surface topography is purposefully altered. A desired topography is implemented by applying local coatings having a different layer thickness.

On the one hand, the structuring, topography-imparting coating can be achieved by way of the properties of the precursor used; on the other hand, laterally limited differences in layer thicknesses can be generated via fillers.

The invention also includes a method for generating a surface topography on a surface to be coated by means of carrying out a method according to the invention, wherein the ratio of the liquid surface tension of the liquid precursor to the surface energy of the surface to be coated is selected in such a way that a partially closed layer, which marked by an insular appearance, is generated in step c), the layer thickness in the region of the insular appearance being preferably at most 10 μm, more preferably at most 5 μm.

The dynamic behavior of the liquid used is utilized to generate these structurings. In particular, an insular cover can be obtained in a combination of sufficiently high liquid surface tension and sufficiently low surface energy of the surface to be coated. Preference is, as stated, given to insular regions of relatively high layer thickness having a total height of less than 10 μm, so that the regions can be completely crosslinked with excimer lamps. Particularly preferred are insular regions of relatively high layer thickness having a height of less than 5 μm. Use is preferably made of liquids which form on the substrate surface a contact angle of from 10°-140°, particularly of from 10° to 90°.

A further method is the use of fillers. Particles, introduced into the liquid precursor, cause a meniscus, i.e. a local increase in the liquid layer thickness, to form around the particles. In so far as the height of the particles is comparable to the applied average layer thickness, then the meniscus is a marked layer thickness deviation. A purposeful surface structuring can be brought about by way of the local layer thickness deviation. Preferably, particle diameters of from 20 percent to 1,000 percent of the average layer thickness are used; particle diameters of from 50 percent to 500 percent of the average layer thickness are particularly preferred.

Accordingly, the invention also includes a method for generating a surface topography on a surface to be coated by means of carrying out a method according to the invention, wherein in step b) a mix is provided, comprising particles having a particle diameter of from 20% to 1,000%, preferably of from 50 to 500% of the average layer thickness based on the average layer thickness after the crosslinking.

Additional shrinkage of the crosslinkable precursor allows the particles which are introduced to protrude well beyond the crosslinked layer and thus to act as the actual structuring. As a result of splitting of the UV-crosslinkable precursor layer and as a result of ablation, the particles can even be exposed at the surface. In this way, it is possible to generate surface structurings as a result of the properties of the particles. It is thus possible to generate, in addition to the topographical structuring, also a chemically laterally structured surface.

Preferably, particles made of the following substances are used:

Medicinal or (bio)catalytic active substances, metals such as silver, copper, nickel, aluminum, metal alloys, metal oxides, semiconductor metal oxides, such as those of titanium, tin, indium, zinc or aluminum, non-metals, non-metal compounds, salts (for example salts of organic and inorganic acids, metal salts), zinc sulfite, magnetite, silicon oxide, boron nitrite, graphite, organic solids, carbon particles and also further ceramic materials.

Layers of this type can be used in particular as a scratch protection coating, as hydrophobic coatings, to improve pour-out behavior, for the purposeful discharge of active substances, as photocatalytic layers or as antibacterial layers.

### 9. GENERAL INFORMATION

The breakdown of the present application into individual preferred embodiments is not intended to serve to relate the applications described in these embodiments solely to this embodiment. A large number of applications and uses, methods and devices corresponding thereto can be carried out by means of the method according to the invention also with features other than those described in the respectively preferred embodiment. In many cases, the corresponding possibilities for use may also be generalized beyond the respectively preferred embodiment according to the invention within the scope of the most general form of the invention, so that the uses described under the respectively preferred embodiment are merely a preferred variant of the idea according to the invention. In addition, it will be clear to the person skilled in the art that the embodiments or individual measures/features of the individual embodiments may also be combined with one another, depending on the aim of the application. Certain layers, uses or methods according to the invention also fulfill the features/functions of more than one preferred embodiment simultaneously.

The invention will be described hereinafter in greater detail by means of examples, figures and claims. The following section may not be understood as limiting the invention itself.

### 10. EXAMPLES

### Example 1

### Comparison of Plasma-Crosslinked Layers According to DE 40 19 539 A1 with Layers Produced by the Method According to the Invention using IR Spectroscopy

Following the method described in DE 4019539 A1 for producing a decrosslinking coating, various exemplary patterns were produced. For this purpose, thin silicone oil layers were applied to aluminum-vacuum-coated silicon wafers with the aid of a spin coater. Subsequently, the samples were treated with a low-pressure oxygen plasma and the contact angle relative to water of the resulting coatings was determined and also the associated IR spectra (recording method ERAS: external reflection absorption spectroscopy) were recorded.

The details concerning the production are listed in Table 1.

It should firstly be noted that the silicone oils used in Offenlegungsschrift DE 40 19 539 A1 from the DC Fluid Series of the manufacturer Dow Corning (trimethylsiloxy-terminated polymethylsiloxane, PDMS) provide, within the IR spectroscopic tests carried out, identical results to the oils used from the AK Series of the manufacturer Wacker AG (trimethylsiloxy-terminated polymethylsiloxane, PDMS). The tests with the oils from the DC Fluid Series will therefore not be separately examined any further.

In addition, within the limits of the experimental accuracy of the IR measurements, no significant differences may be identified between the AK50 and AK10000 oils used (AK50: kinematic viscosity of approx. 50 mm²/s at 25° C., density of approx. 0.96 g/ml, AK10000: kinematic viscosity of approx. 10,000 mm²/s at 25° C., density of approx. 0.97 g/ml). The basic comparisons will therefore be limited to the presentation of the results with the AK10000 oil.

TABLE 1
Designation and parameters of the silicone oil layers treated in the
oxygen plasma

| | | Layer | | | | |
|---|---|---|---|---|---|---|
| | Silicone | thickness | Power | Treatment | Mechanical | Water contact |
| Designation | oil | [nm] | [W] | time [s] | stability | angle [°] |
| 1A | DC Fluid | 140 | 0 | 0 | liquid | 90 |
| | CST50 | | | | | |
| 1B | DC Fluid | 140 | 500 | 60 | easily | 98 |
| | CST50 | | | | wipeable | |
| 1C | DC Fluid | 140 | 500 | 1,200 | wipeable | 59 |
| | CST50 | | | | | |
| 1D | DC Fluid | 140 | 2,000 | 60 | easily | 44 |
| | CST50 | | | | wipeable | |
| 1E | DC Fluid | 140 | 2,000 | 1,200 | wipeable | 50 |
| | CST50 | | | | | |
| 2A | AK50 | 140 | 0 | 0 | liquid | 108 |
| 2B | AK50 | 140 | 500 | 60 | easily | 103 |
| | | | | | wipeable | |
| 2C | AK50 | 140 | 500 | 1,200 | wipeable | 60 |
| 2D | AK50 | 140 | 2,000 | 60 | easily | 43 |
| | | | | | wipeable | |
| 2E | AK50 | 140 | 2,000 | 1,200 | wipeable | 46 |
| 3A | AK10000 | 140 | 0 | 0 | liquid | 104 |
| 3B | AK10000 | 140 | 500 | 60 | easily | 57 |
| | | | | | wipeable | |
| 3C | AK10000 | 140 | 500 | 1,200 | wipeable | 68 |
| 3D | AK10000 | 140 | 2,000 | 60 | easily | 26 |
| | | | | | wipeable | |
| 3E | AK10000 | 140 | 2,000 | 1,200 | wipeable | 29 |

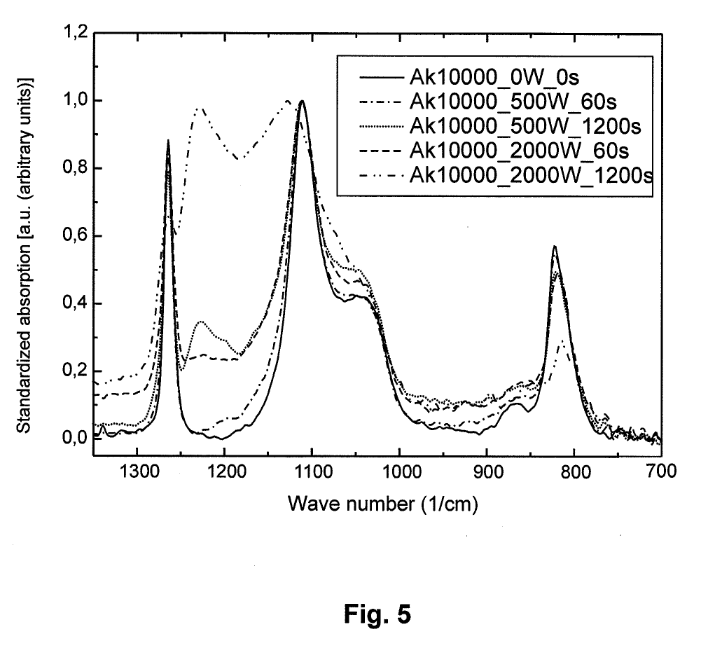

FIG. 5 shows the IR spectra (ERAS) in the range of from 700 to 1,350 1/cm for the oil AK10000 for the applied process parameters after plasma treatment corresponding to the parameters of Table 1. To allow comparison with the respective maximum value in the range, the spectra are standardized by 1,111-1,128 1/cm.

Pattern without Plasma Treatment or with a Short Treatment Time

The untreated oil on the pattern 3A and also the patterns 3B and 3D, which are subsequently plasma-treated for 60 s, are characterized in the illustrated spectral range by four significant bands:

band 1 (P): by 1,264 1/cm,

band 2 (P): 1,111-1,128 1/cm

band 3 (P): by 820 1/cm

band 4 (P): by 1,030 1/cm (may be seen as the shoulder in 2 (P))

The ranges which are significant in the spectra may be assigned specifically to the following band vibrations:

| | |
|---|---|
| Symmetrical deformation vibration | approx. 1,250 1/cm |
| of CH₃ in Si—CH₃: | |
| Si—O stretching vibrations of Si—O—Si | approx. 1,070-1,135 1/cm |
| and Si—O: | |
| Deformation vibration of CH₂ in | approx. 1,030 1/cm |
| Si—(CH₂)_{1o.2}—Si: | |
| Si—C stretching vibrations of (Si—CH₃)₃: | approx. 840 1/cm |
| Deformation vibration of CH₃ in Si(CH₃)₂: | approx. 820 1/cm |

Pattern with a Long Treatment Time

In addition to the four previously cited significant regions or the shoulder, an additional band emerges in patterns with a long treatment time, patterns 3C and 3E:

band 5 (P): by 1,225-1,230 1/cm

The relative intensity of the band 5 (P) increases with the treatment time and is ultimately comparable to the intensity of the band 2 (P). The relative intensity of the band 1 (P) and the band 3 (P) compared to the band 2 (P) decreases, conversely, over the course of the treatment.

These observations may be interpreted as follows: From the decrease in relative intensity (the integral under the band(s) is adduced here) of the ranges 1 (P) and 3 (P) in relation to 2 (P), it may be concluded that the relative content of CH₃ groups is reduced as a result of the plasma treatment. The occurrence of the new band 5 (P) with the simultaneous decrease of 2 (P)—without a significant shift from 2 (P) to 5 (P)—suggests a non-complete penetration depth of the crosslinking method.

The results become comprehensible on the assumption that the radiation generated in the plasma and the electrons act only very close to the surface. A modification, which may be measured in the IR spectrum, of the applied oil may be achieved in the depth over the course of the treatment and by way of the power coupled into the plasma. Provided that the treatment intensity is sufficient, the plasma-treated, modified oil (crosslinked oil) is responsible for the occurrence of the additional band 5 (P). Uncrosslinked or partially crosslinked oil from the bottom layers of the oil film applied still provides the IR spectrum of the untreated oil. In principle, it is conceivable that, after sufficiently long irradiation or on use of a sufficiently thin oil film, all of the oil is crosslinked and the spectrum of the uncrosslinked oil is no longer visible. However, the results clearly reveal that such intensive crosslinking of the oil film is not achievable using the parameter range claimed in DE 40 19 539 A1 (the aforementioned maximum values for the power coupled into the plasma and for the duration of the treatment have already been used).

In addition, a long, intensive plasma treatment of the oil layers is linked to marked activation of the surface, as the measurements of the water contact angle show. In this respect, long treatment times in the plasma are not compatible with the claim of a decrosslinking coating. In addition, the tests obviously reveal that it will not be possible to produce, using the methods described in the patent specification, a decrosslinking coating which at the same time displays adhesion to the base. On the one hand, it was not possible to generate a coating of this type (see Table 1 in relation to mechanical stability and water contact angle). On the other hand, it is, on account of the conclusion that the plasma treatment acts very close to the surface, not possible to build up adhesion in lower layers to the substrate without modifying the top layer in such a way that the top layer reacts hydrophilically.

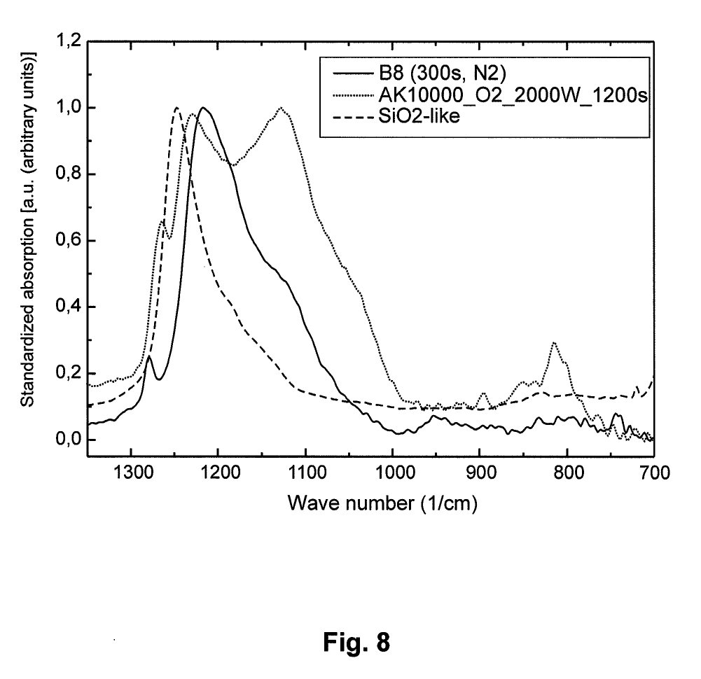

The resulting band 5 (P) may also be assigned to the Si—O—Si and Si—O bands although, compared to the untreated oil, these bands must be associated with a network. This network is produced by crosslinking reactions during the plasma treatment. A band in a similar wave number range becomes visible during the layer deposition in the low-pressure plasma to produce a hard, SiOₓ-like coating. This coating is a highly three-dimensional, inorganic, hydrophilic network. FIG. 8 shows the comparison of the pattern 3E, which is plasma-treated over a long period of time, and a plasma-polymeric SiOₓ-like coating.

For comparison, a series of pattern coatings was produced in accordance with the method according to the invention. The base material used was, again, aluminum-vacuum-coated Si wafers. The Si wafers were provided with a ˜140 nm-thick silicone oil layer by means of spin coating (AK10000, Wacker Chemie AG). Subsequently, the layers were subjected for different times to the radiation of an excimer lamp (manufacturer: Radium, Xeradex emitter, 172 nm). One series of the pattern coatings was produced under atmospheric conditions, a second under a nitrogen inert gas atmosphere. The distance between the surface of the wafer and the lower edge of the lamp was in each case 10 mm. Further relevant process parameters are listed in Tables 2 and 3.

TABLE 2
Designation and parameters of the “atmosphere” series

| Designation | B1 | B2 | B3 | B4 |
|---|---|---|---|---|
| Irradiation intensity | 6.5 mW/cm² | 6.5 mW/cm² | 6.5 mW/cm² | 6.5 mW/cm² |
| Duration of irradiation | 10 | 60 | 120 | 300 |
| in seconds | | | | |
| Mechanical stability | wipeable | wipeable | wipeable | non-wipeable |
| Layer thickness after | 139 | 136 | 123 | 121 |
| irradiation [nm] | | | | |
| Water contact angle [°] | 105 | 99 | 95 | 61 |

Excimer Lamp-Irradiated Patterns Under a Normal Atmosphere

FIG. 6 shows the IR spectra (ERAS) of the excimer lamp-irradiated patterns during treatment under atmospheric conditions. The coatings B1 to B4 are in the illustrated spectral range substantially characterized by the following significant bands:

| | |
|---|---|
| band 1 (E): | by 1,264-1,270 1/cm: |
| band 2 (E): | 1,111-1,134 1/cm: |
| band 3 (E): | range around 810-820 1/cm: |
| band 4 (E): | range around 1,030 1/cm (may be seen |
| | as the shoulder of the band 2 (E)) |

The bands which may be seen in the spectra may be assigned, like the plasma-treated oil layers, to the following band vibrations:

| | |
|---|---|
| Symmetrical deformation vibration of | approx. 1,250 1/cm |
| CH₃ in Si—CH₃: | |
| Si—O stretching vibrations of Si—O—Si | approx. 1,070-1,135 1/cm |
| and Si—O: | |
| Deformation vibration of CH₂ in | approx. 1,030 1/cm |
| Si—(CH₂)_{1o.2}—Si: | |
| Si—C stretching vibrations of (Si—CH₃)₃: | approx. 840 1/cm |
| Deformation vibration of CH₃ in Si(CH₃)₂ | approx. 820 1/cm |
| Si—C stretching vibrations of (Si—CH₃)₂: | approx. 805 1/cm |

It may be seen that in particular the band 2 (E) migrates over the course of the irradiation into the range of higher wave numbers; started with 1,112 1/cm for pattern B1 onto 1,134 1/cm for the pattern B4. The relative intensity of the band 1 (E) and the band 3 (E) compared to the band 2 (E) also decreases over the course of the irradiation. This observation may be interpreted to mean that the number of CH₃ end or side groups is reduced.

TABLE 3
Designation and parameters of the “N₂ inert gas atmosphere” series

| Designation | B5 | B6 | B7 | B8 |
|---|---|---|---|---|
| Irradiation intensity | 40 mW/cm² | 40 mW/cm² | 40 mW/cm² | 40 mW/cm² |
| Duration of irradiation | 10 | 60 | 120 | 300 |
| in seconds | | | | |
| Mechanical stability | non-wipeable | non-wipeable | non-wipeable | non-wipeable |
| Layer thickness after | 124 | 104 | 98 | 81 |
| irradiation [nm] | | | | |
| Water contact angle [°] | 59 | 55 | 31 | 38 |

Excimer Lamp-Irradiated Patterns Under a Nitrogen Atmosphere

FIG. 7 shows the IR spectra (ERAS) of the excimer lamp-irradiated patterns during treatment under a nitrogen atmosphere. The coatings B5 to B8 are in the illustrated spectral range substantially characterized by the following significant bands:

| | |
|---|---|
| band 1 (E): | by 1,264-1280 1/cm, |
| band 2 (E): | 1,111-1,216 1/cm |
| band 3 (E): | by 810-820 1/cm |
| band 4 (E): | additional shoulder in the band 2 (E) |

It may be seen that in particular the band 2 (E) migrates over the course of the irradiation into the range of higher wave numbers; started with 1,111 1/cm for pattern B5 onto 1,216 1/cm for the pattern B8. Compared to the patterns irradiated under atmosphere, the drift is much more distinctly pronounced. In addition, the intensities of the band 1 (E) and the band 3 (E) decrease over the course of the irradiation until they are barely apparent (see pattern B8). This may be interpreted to mean that, compared to the oil films irradiated under atmosphere, the number of the CH₃ end or side groups is much more greatly reduced.

The IR spectrum of the oil film (B8) which is treated under a nitrogen atmosphere and for a long irradiation time becomes comparable to that of the SiOₓ-like coating during the layer deposition in the low-pressure plasma (see FIG. 8). FIG. 8 shows the IR spectrum (ERAS) of the plasma-treated silicone oil AK10000 (pattern 3E), an excimer lamp-irradiated pattern with silicone oil AK10000 (B8, see below) and a plasma-polymeric, SiOₓ-like coating deposited in the low-pressure plasma.

It has surprisingly been found that even these highly crosslinked coatings according to the invention nevertheless contain a high content of carbon and this content is also necessary, thus giving the layers according to the invention new, special properties in relation to a plasma-polymeric SiOₓ-like coating.

In addition, the observation of the drift of the band 2 (E), i.e. the stepwise crosslinking of the oil film, and the disappearing of the measurement of an IR spectrum which is characteristic of uncrosslinked oil, obviously suggests the interpretation that the applied oil film was homogeneously modified in the entire depth as a result of the irradiation.

If the results of the different treatment methods for the oil films (plasma treatment and excimer lamp irradiation) are now compared with one another, then a fundamentally different behavior is observed, in particular on examination of the patterns with a long treatment time (plasma-treated: 3E; excimer/atmosphere: B4; excimer/nitrogen: B8): Whereas in the plasma treatment an additional band in the range of from 1,225-1,230 1/cm (5 (P)) is produced over the course of the plasma treatment and the wave number of the band which may be seen in the untreated silicone oil remains fixed at 1,111 1/cm (2 (P)), the band at 1,111 1/cm (2 (E)) migrates during excimer lamp irradiation over the course of the treatment to the value 1,225-1,230 1/cm. In this case, the shift for irradiation under nitrogen is much more pronounced. In addition, the relative decrease in the intensity of the band 1 (P) and the band 3 (P) in relation to the band 2 (P) during the treatment in the plasma is much less pronounced than during the irradiation with the excimer lamp, in particular during irradiation under a nitrogen atmosphere (decrease in the intensity of the band 1 (E) and the band 3 (E) relative to the band 2 (E)).

All of the observations may be understood on the assumption that the depth to which the excimer lamp radiation penetrates the oil film is much greater than the penetration depth of the plasma treatment.

After plasma treatment, as disclosed in DE 40 19 539 A1, a two-phase system consisting of a crosslinked cover layer and an almost unaltered, i.e. liquid, oil film positioned therebelow is generated at all times at the selected oil film thickness and the process parameters: A high crosslinking gradient is present in the plasma-treated layer. This statement is consistent with the observation that, in the case of thicker oil films (>250 nm), almost no adhesion to the substrate can be built up, while the top cover layer already displays cracks owing to internal stresses.

On the other hand, owing to the greater penetration depth, the excimer lamp radiation allows the applied 140 nm-thick oil film to be modified homogeneously into the depth. In this case, there is a comparatively low crosslinking gradient. Accordingly, it may be assumed that overall higher layer thicknesses can be effectively crosslinked using this method.

### Example 2

### Comparison of a Plasma-Crosslinked Layer with Excimer Lamp-Crosslinked Layers by Means of Time of Flight-Secondary Mass Spectroscopy

In order to further understand the results shown in Example 1, TOF-SIMS depth profiles of certain applied and treated layer systems from Example 1 were additionally carried out (TOF-SIMS: time of flight-secondary ion mass spectrometry).

The TOF-SIMS tests were carried out using a TOF-SIMS IV apparatus (from ION TOF). Parameters: excitation with a 25 keV Ga liquid metal ion source, bunched mode, analysis area 60.5×60.5 μm², charge compensation with pulsed electron source. Sputtering parameters: 3 keV argon sputtering source, 25.8 nA, sputtering area 200×200 μm². The figures show the intensity of the positive ion signals, which are characteristic of the corresponding elements, over the sputtering cycles (Cycle).

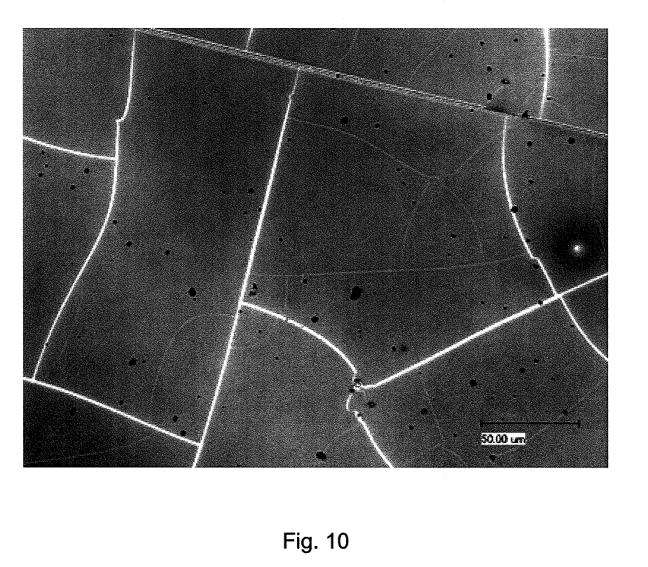

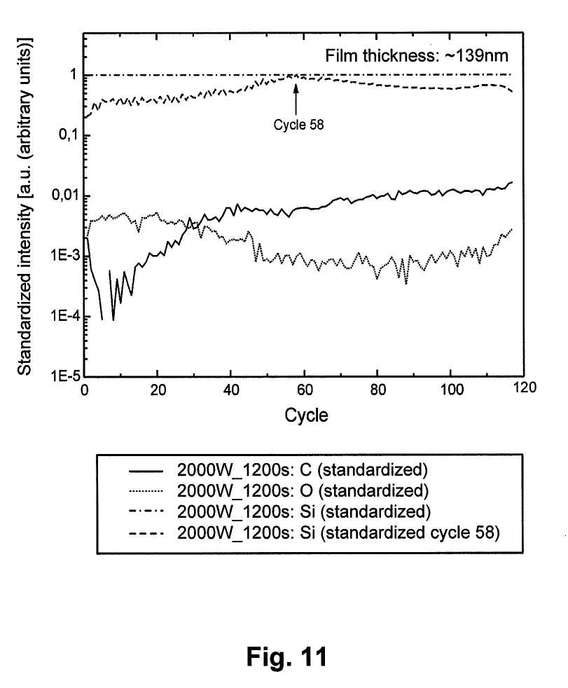

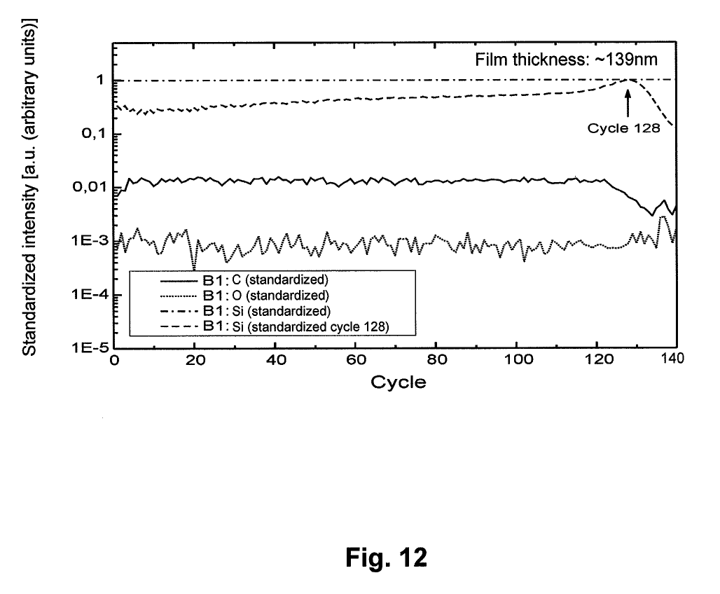

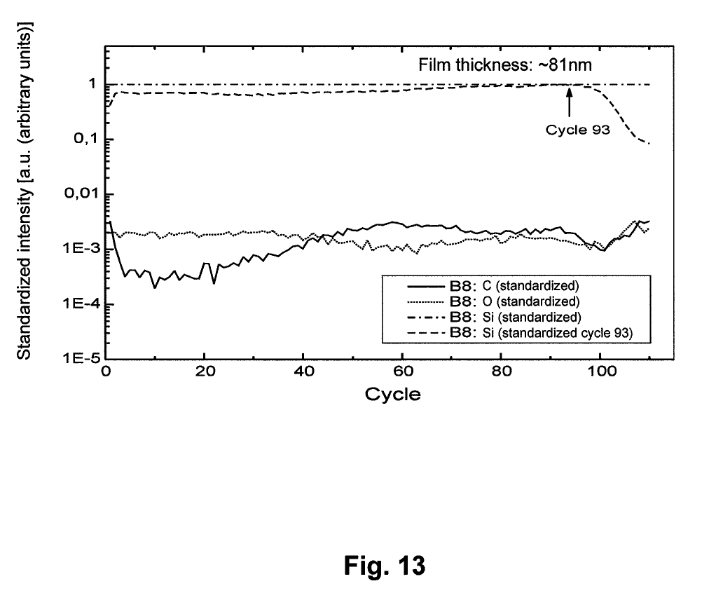

This measurement is shown for the pattern 3E (plasma-treated silicone oil) in FIG. 11, for the pattern B1 (weakly crosslinked, excimer lamp-irradiated silicone oil) in FIG. 12 and for B8 (strongly crosslinked, excimer lamp-irradiated silicone oil) in FIG. 13 (see below).

The figures show the relative change of the material constituents carbon (C), oxygen (O) and silicon (Si) with the depth of penetration into the coating. It should be noted that, in TOF-SIMS tests, the intensities of the detected ions do not allow any pronouncement to be made on the absolute distribution of elements. Therefore, only the changes in the individual ion signals will be analyzed hereinafter. The “cycle (Cycle)” parameter, which specifies the number of TOF-SIMS sputtering cycles, wherein one sputtering cycle includes both the sputtering and the neutralizing and the measuring, has been selected as the penetration depth, starting from the surface of the coating. The individual signal courses are standardized to the course of the respective Si signal. Also shown is the course of the Si signal which is standardized to one in relation to the absolute maximum. It is possible to tell from the course of this Si signal whether the carrier material, Si wafer, has already been reached in the measuring process. Generally speaking, a marked drop of the Si signal may be seen on reaching the Si carrier material.

FIG. 11 shows a TOF-SIMS depth profile; course of the carbon, oxygen and silicon intensity for the plasma-treated pattern 3E. The intensities are standardized to the silicon signal for each cycle. The course, standardized to the absolute maximum of the Si signal (cycle 58), of the Si signal is also shown.

FIG. 12 shows a TOF-SIMS depth profile; course of the carbon, oxygen and silicon intensity for the excimer lamp-irradiated pattern B1. The intensities are standardized to the silicon signal for each cycle. The course, standardized to the absolute maximum of the Si signal (cycle 128), of the Si signal is also shown. This course represents the end of the coating and the start of the Si wafer positioned therebelow.

FIG. 13 shows a TOF-SIMS depth profile; course of the carbon, oxygen and silicon intensity for the excimer lamp-irradiated pattern B8. The intensities are standardized to the silicon signal for each cycle. The course, standardized to the absolute maximum of the Si signal (cycle 93), of the Si signal is also shown. This course represents the end of the coating and the start of the Si wafer positioned therebelow.

FIG. 11 shows the course of the plasma-treated oil film with the designation 3E from Example 1. The film has a layer thickness of 139 nm and ends within the TOF-SIMS measurement after the cycle 117. The measurement shows a constant drop of the O signal and a rise of the C signal roughly up to cycle 50 (˜40 nm). From cycle 50, both signals remain almost the same. The course of the Si signal displays no anomalies.

In addition, the carbon signal displays a marked drop at the beginning. In samples which were in contact with the ambient air, it is usually possible to detect a carbon signal on the surface, although the carbon signal is not related to the actual layer composition. The carbons are artifacts from the air and are discernible even on non-carbon-containing materials. In this respect, the initially marked drop of the C signal is disregarded.

FIG. 12 shows the course of the weakly crosslinked, excimer lamp-irradiated oil film, pattern B1 from Example 1. Cycle 128 marks the end of the approximately 139 nm-thick coating and the beginning of the Si wafer. The courses of the O and the C signal display no significant changes in the depth profile.

FIG. 13 shows the course of the strongly crosslinked, excimer lamp-irradiated oil film, pattern B8. Cycle 93 marks the end of the approximately 81 nm-thick coating and the beginning of the Si wafer. In this case too, it is possible to see, initially very close to the surface, a marked drop of the carbon signal which is then disregarded for the above-mentioned reasons. A constant rise of the C signal up to about cycle 60 may also be seen. The O signal remains almost constant over the entire measurement. Overall, the level of the C signal, in particular in the lower layers, is well below the level of the layer B1.

The results of the measurements may be classified as follows: The excimer lamp radiation penetrates deep into the oil film, as a result of which the composition of the film changes owing to irradiation. Generally, the number of CH₃ groups in the film is reduced. As a result of the deep penetration, the level of the C signal changes over the entire depth. Starting from the level of the C signal for B1, almost uncrosslinked silicone oil, this level drops markedly for B8 owing to the reduction of the CH₃ groups.

The effect of the plasma treatment is, by contrast, much closer to the surface. In this case, a high gradient is identified for the C signal. The reduction of the carbon from the oil film is responsible in this case too. In contrast to the strongly crosslinked coating B8, the lower layers contain the same C level such as may be found in the weakly crosslinked coating B1. This observation is consistent with the foregoing conclusions, according to which the plasma treatment causes a superficial crosslinking, while deeper down an uncrosslinked, liquid oil film remains.

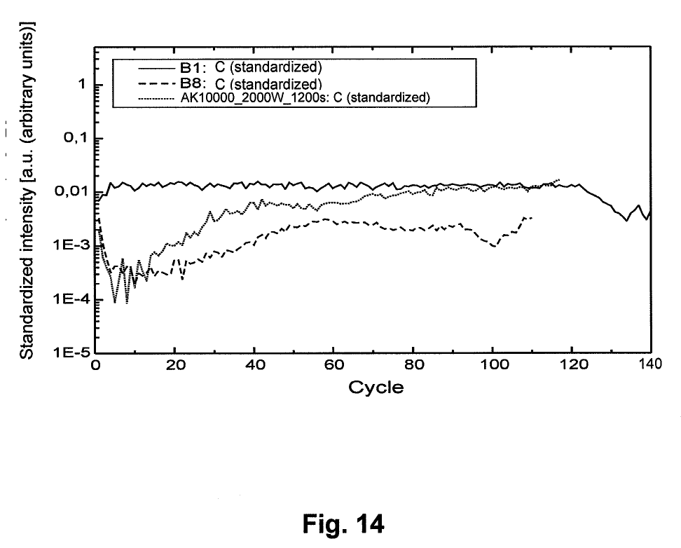

FIG. 14 illustrates the different behavior of the C signal for the three layer variants.

FIG. 14 shows a TOF-SIMS depth profile; comparison of the carbon intensities (in each case standardized to the associated Si signal of each cycle) between the excimer lamp-irradiated pattern B1 (weakly crosslinked) and B8 (strongly crosslinked) and also of the plasma-treated silicone oil AK10000 (pattern 3E).

### Example 3

### Anticorrosive Coating or Tarnish Protection

A) Corrosion Coating

Aluminum sheets which had been precleaned with acetone were provided on one side, at layer thicknesses of 100 nm, 150 nm, 200 nm and 250 nm, with the silicone oil AK50 in the drain coating method. Subsequently, the metal sheets were subjected with the liquid oil layer to light of the 172 nm wavelength from an excimer lamp (Xeradex emitter, 50 W, Radium Lampenwerk GmbH). The distance between the surface of the aluminum and the lamps was approx. 10 mm; 20 secs, 60 secs, 120 secs and 360 secs were set as treatment times. For a complete series with the aforementioned durations of the treatment and layer thicknesses, the irradiation took place under a nitrogen atmosphere; a series was carried out under air while varying the layer thickness for a treatment time of 360 secs.

The coatings produced were dipped for 5 minutes into 25% sulfuric acid at 65° C. and photographed to document the corrosion attack.

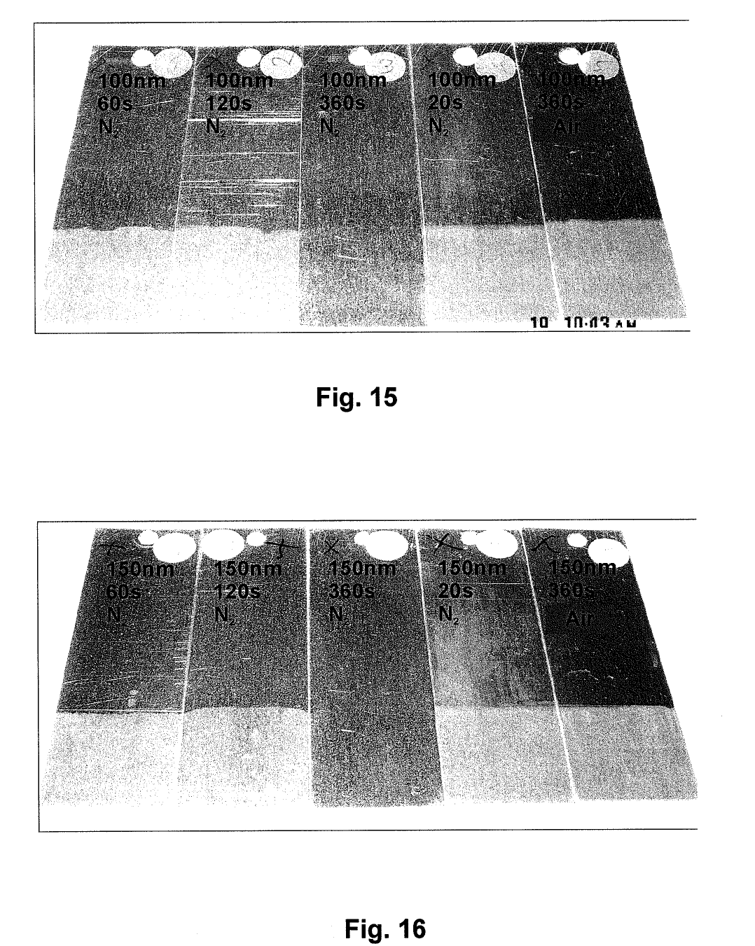

FIG. 15 shows the corrosion attack for the patterns having the 100 nm layer thickness.

FIG. 16 shows the corrosion attack for the patterns of the 150 nm layer thickness.

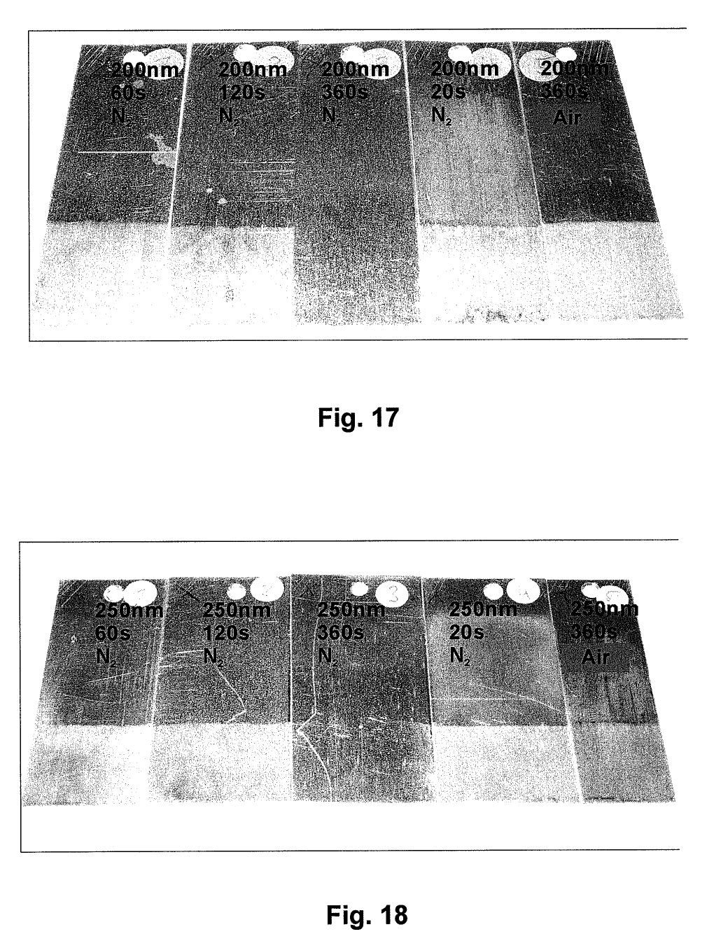

FIG. 17 shows the corrosion attack for the coating of the 200 nm layer thickness.

FIG. 18 shows the corrosion attack of the coatings having the 250 nm layer thickness.

The results show the tendency that the corrosion attack can be reduced over the course of the irradiation and the higher degree of crosslinking, resulting therefrom, of the coating. This becomes apparent above all from the measuring series having a duration of irradiation of 360 secs under a nitrogen atmosphere. Atmospheric oxygen reduces the effective irradiation intensity for the same treatment time.

The applied layer thickness displays in the illustrated range only an inappreciable influence on the corrosion resistance.

The described findings may be transferred to other surface materials.

After a repeated sulfuric acid test with an additional dwell time of 10 minutes, i.e. a total duration of 15 minutes, a first corrosion attack is observed on the patterns having a duration of irradiation of 360 secs.

B) Tarnish Protection

Tarnishing is also a corrosion attack which may first be identified optically and is generally caused by gases. For example, silver tarnishes under an H₂S atmosphere and turns brown.

In this case, the surface of a red gilded ring was first cleaned with isopropanol and subsequently activated for 120 secs with the aid of an excimer UV lamp under an ambient atmosphere, ozone being formed. Subsequently, an approximately 400 nm-thick liquid layer made up of AK50 was applied to the surface of the ring using an aerosol method.

The applied oil film was crosslinked by irradiation with UV light of the 172 nm wavelength (Xeradex emitter, from Radium). In this case, the ring was constantly rotated about one of its axes in the plane of the ring. For this purpose, the ring was suspended centrally between two lamps. The average distance was in this case approximately 25 mm. The irradiation was carried out under a nitrogen atmosphere at atmospheric pressure. The duration of the irradiation was 600 secs. The layer thickness of the coating according to the invention was, after crosslinking, approximately 170 to 200 nm.

The coating could not be optically perceived as a difference in color (neither interferences nor loss of gloss). In contrast thereto, plasma-polymeric layers of comparable layer thickness would, for example, display these optical effects and have a much more discernible influence on the optical appearance. As a result of the increased layer thickness in relation to the plasma polymers in which, for non-visibility of the coating, the layer thickness may be just 10-40 nm (optically non-discernible layer thickness range), there is provided higher mechanical wiping resistance which may be seen from the fact that the surface can now be cleaned using conventional commercial polishing cloths (at moderate pressure). Plasma-polymeric layers having a layer thickness of from 10-40 nm do not allow this.

The tarnish protection was assessed with the aid of the thioacetamide test (TAA test) in accordance with EN ISO 4538:1995. In this case, a coated ring and an uncoated ring were subjected to a hydrogen sulfide-containing atmosphere. As a result, the uncoated ring displayed after 3 days the first signs of corrosion and was after 7 days corroded uniformly over the entire surface. The coated ring, on the other hand, did not display incipient local corrosion until 7 days, mainly at coating defects as a result of the suspension. The majority of the surface displayed, as at the beginning, a glossy surface.

C) Aluminum-Coated Foil

On a 19 μm PETP foil (from ROWO Coating), one side of which had been aluminized, an approximately 100 nm-thick liquid layer made up of AK50 was applied to the surface by way of a spin coating method.

The applied oil film was crosslinked by irradiation with UV light of the 172 nm wavelength (Xeradex emitter, from Radium). The distance between the underside of the lamp and the foil was, on production of a plurality of patterns, 0.1 to 3 cm.

The irradiation was carried out under a nitrogen atmosphere at atmospheric pressure. The duration of the irradiation was 600 secs. The layer thickness of the coating according to the invention was, after crosslinking, approximately 50-70 nm for the various patterns.

Drops of solutions having different pHs were applied to the surface of the patterns produced, or the patterns were dipped into the corresponding solution.

The aluminum layer of the untreated reference surface is completely dissolved after just 5 minutes, after a drop of a solution having a pH of 12 was added to the surface. The coated patterns displayed, irrespective of the degree of crosslinking or the distance from the UV lamp during the crosslinking, no corrosion attack at pH 12.

On dipping of the patterns into a solution having a pH of 13, the aluminum layer of the untreated substance is completely dissolved after just 90 secs. The coated patterns displayed, as a function of their irradiation parameters, the following resistances:

TABLE 4

| Distance of the lamp | First signs | Complete |
|---|---|---|
| from the substrate | of corrosion | dissolution |
| during the crosslinking | after | after |
| 3.0 cm | 7 mins | 15 mins |
| 2.0 cm | 7 mins | 20 mins |
| 1.0 cm | 10 mins | 25 mins |
| 0.5 cm | 10 mins | 25 mins |
| 0.1 cm | 30 mins | n/a |

D) Highly Reflective Aluminum

The coating of a highly reflective aluminum sheet is described hereinafter. The underlying uncoated surface (manufacturer: Alanod) is extremely susceptible to corrosion and very sensitive to mechanical wear, so that the surface requires a suitable coating prior to technical use.

For this purpose, the surface of the aluminum sheet was first activated for 120 secs with the aid of an excimer UV lamp under an ambient atmosphere, ozone being formed. Subsequently, on one side, an approximately 20 nm-thick liquid layer made up of AK50 was applied to the surface by way of an aerosol method.

The applied oil film was crosslinked by irradiation with UV light of the 172 nm wavelength (Xeradex emitter, from Radium). The distance between the underside of the lamp and the aluminum sheet was 2, 10, 15 and 35 mm. The irradiation was carried out under a nitrogen atmosphere at atmospheric pressure. The duration of the irradiation was 300 secs. The layer thickness of the coating according to the invention (adhesion promoter coating) was, after crosslinking, approximately 14 nm.

A second layer of the coating according to the invention was applied to this base layer. For this purpose, a 420 nm-thick liquid film was applied to the first layer with the aid of the aerosol application method. The first layer was, in turn, irradiated and crosslinked for 600 secs under the aforementioned distances and process conditions. The layer thickness of the second applied coating according to the invention was, after crosslinking, approximately 270 nm.

A precondition for functioning corrosion protection is a closed coating. The person skilled in the art can achieve a closed coating without difficulty by way of the aerosol method. However, owing to the aerosol method used, there are often differences in layer thickness on the coated surface. In particular at the points at which relatively large condensation droplets land, locally higher layer thicknesses are achieved. The layer thickness deviation becomes perceptible by way of the interference color. Whereas macroscopically just a slight mottling is visible, the test with the microscope shows that there are round regions within which the layer thickness increases toward the center. Accordingly, rings having the various interference colors are visible. The flecks can have diameters of from a few micrometers to several hundred micrometers. The increase in layer thickness within these flecks can be several hundred percent compared to the average layer thickness.

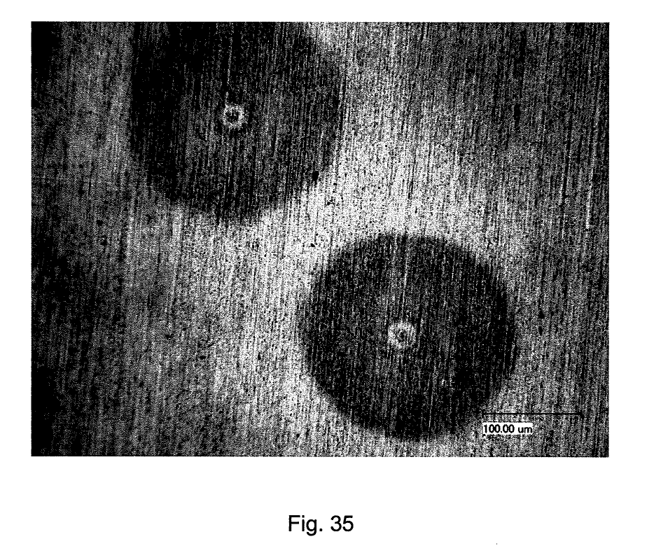

FIG. 35 shows deviations in the coating thickness caused, as a result of the aerosol method, through condensation of relatively large drops.

A non-coated aluminum sheet and the coated aluminum sheets were dipped into a 25% sulfuric acid solution having a temperature of 65° C. The uncoated metal sheet displayed corrosion over the entire surface after 2 minutes. The coating crosslinked at the distance of 35 mm displayed initial corrosion after 5 minutes; all the remaining metal sheets displayed first signs of corrosion only after 60 mins.

In addition to the corrosion-inhibiting property of the coating, it was possible to observe that the coatings provide improved wear protection. The untreated surface displayed clear scratch marks just as a result of gentle, manual cleaning. The coating allows careful manual cleaning without leaving behind scratch marks.

E) A glossy polished aluminum rim is also treated using the procedure recited under D). This component also displays a marked improvement in corrosion resistance. In addition, the surface becomes easier to clean.

F) A glossy anodized aluminum decorative strip is also treated using the procedure recited under D). This component also displays a marked improvement in corrosion resistance. In addition, the surface becomes easier to clean.

### Example 4

### Excimer Irradiation of Silicone Oil

In order to demonstrate the properties of the coating according to the invention, exemplary base tests were carried out on a series of pattern coatings. The patterns were produced on Si wafers as the base material. For this purpose, the Si wafers were first activated with the aid of a plasma treatment and provided with a ˜140 nm-thick silicone oil layer by means of spin coating (AK10000, Wacker Chemie AG). Subsequently, the layers were subjected for different times to radiation from an excimer lamp (manufacturer: Radium, Xeradex emitter, 172 nm). One series of the pattern coatings was produced under atmospheric conditions, a second under a nitrogen inert gas atmosphere. The distance between the surface of the wafer and the lower edge of the lamp was in each case 10 mm. Further relevant process parameters are listed in Tables 5 and 6.

TABLE 5
Designation and parameters of the “atmosphere” series

| Designation | B1 | B2 | B3 | B4 |
|---|---|---|---|---|
| Irradiation intensity | 6.5 mW/cm² | 6.5 mW/cm² | 6.5 mW/cm² | 6.5 mW/cm² |
| Duration of irradiation | 10 | 60 | 120 | 300 |
| in seconds | | | | |
| Wiping test | wipeable | wipeable | wipeable | non-wipeable |
| Layer thickness after | 139 | 136 | 123 | 121 |
| irradiation [nm] | | | | |

TABLE 6
Designation and parameters of the “N2 inert gas atmosphere” series

| Designation | B5 | B6 | B7 | B8 |
|---|---|---|---|---|
| Irradiation intensity | 40 mW/cm² | 40 mW/cm² | 40 mW/cm² | 40 mW/cm² |
| Duration of irradiation | 10 | 60 | 120 | 300 |
| in seconds | | | | |
| Wiping test | non-wipeable | non-wipeable | non-wipeable | non-wipeable |
| Layer thickness after | 124 | 104 | 98 | 81 |
| irradiation [nm] | | | | |

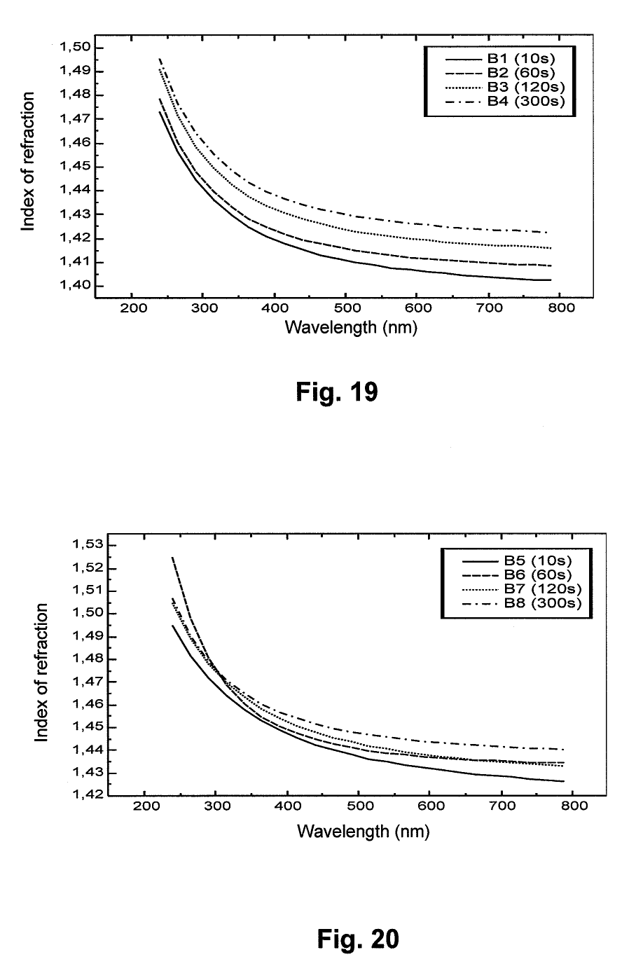

FIG. 19 shows the index of refraction of the silicone oil layers, which are UV radiation-treated under an ambient temperature, of the patterns B1 to B4.

FIG. 20 shows the index of refraction of the silicone oil layers, which are UV radiation-treated under an N₂ inert gas atmosphere, of the patterns B5 to B8.

FIG. 19 and FIG. 20 show the course of the index of refraction of the coatings produced in the wavelength range of from 240 to 790 nm (ellipsometrically determined). Although certain coatings, in particular B1 to B3, can still be wiped manually using a cloth, i.e. the layers have not yet built up sufficient cohesion in the coating film itself and also adhesion to the Si carrier material, the effect of the irradiation may be seen on comparison of the indices of refraction: It may be seen that the index of refraction increases over the course of the irradiation under atmospheric conditions. For the patterns during irradiation under a nitrogen atmosphere B5 to B8, a degree of crosslinking is achieved that offers sufficient adhesion to the base, so that the coating may no longer be cleaned down using a cloth. In this case, the differences in the course of the indices of refraction are less pronounced.

In order to further characterize the patterns, the atomic composition of the irradiated surfaces was determined with the aid of ESCA. In this case, it must be borne in mind that merely the top surface layer having a layer thickness of approx. 10 nm is detected using this measuring method. The measured data, Table 7, show clearly the effect of the irradiation: Over the course of the irradiation, the relative oxygen and silicon contents increase, whereas the carbon content decreases. The layer becomes inorganic. The carbon-to-silicon ratio decreases over the course of the irradiation; a decrease may be seen in the oxygen-to-silicon ratio. These findings may be generalized beyond the specific example.

TABLE 7
Percentage element composition and element ratios of the UV radiation-
treated silicone oil layers, measured using XPS (X-ray photoelectron
spectroscopy).

| Designation | O1s | N1s | C1s | Si2p | C/Si | O/Si |
|---|---|---|---|---|---|---|
| B1 | 25.28 | 0.06 | 52.50 | 22.16 | 2.37 | 1.14 |
| B2 | 29.15 | 0.05 | 46.97 | 23.83 | 1.97 | 1.22 |
| B3 | 37.34 | 0.00 | 39.22 | 23.44 | 1.67 | 1.59 |
| B4 | 47.15 | 0.29 | 28.10 | 24.46 | 1.15 | 1.93 |
| B5 | 41.12 | 0.02 | 34.30 | 24.56 | 1.40 | 1.67 |
| B6 | 40.96 | 0.16 | 32.96 | 25.91 | 1.27 | 1.58 |
| B7 | 55.48 | 0.34 | 19.29 | 24.88 | 0.78 | 2.23 |
| B8 | 61.81 | 0.39 | 10.49 | 27.32 | 0.38 | 2.26 |

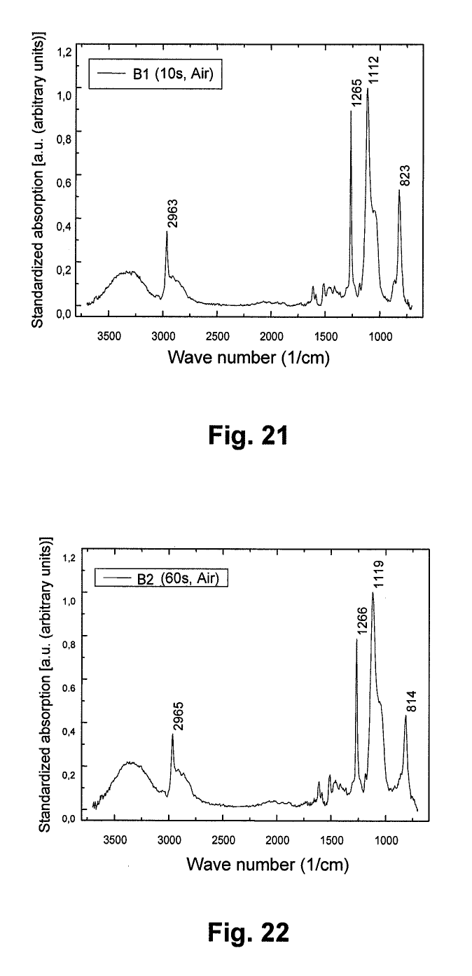

The changes in the ratios between carbon and silicon also become clear on examination of the IR spectra of the irradiated coatings. These are individually represented in FIGS. 21 to 28, or 7 and 8 (see above).

FIG. 21 shows the IR spectrum (ERAS) of the UV radiation-treated pattern B1.

FIG. 22 shows the IR spectrum (ERAS) of the UV radiation-treated pattern B2.

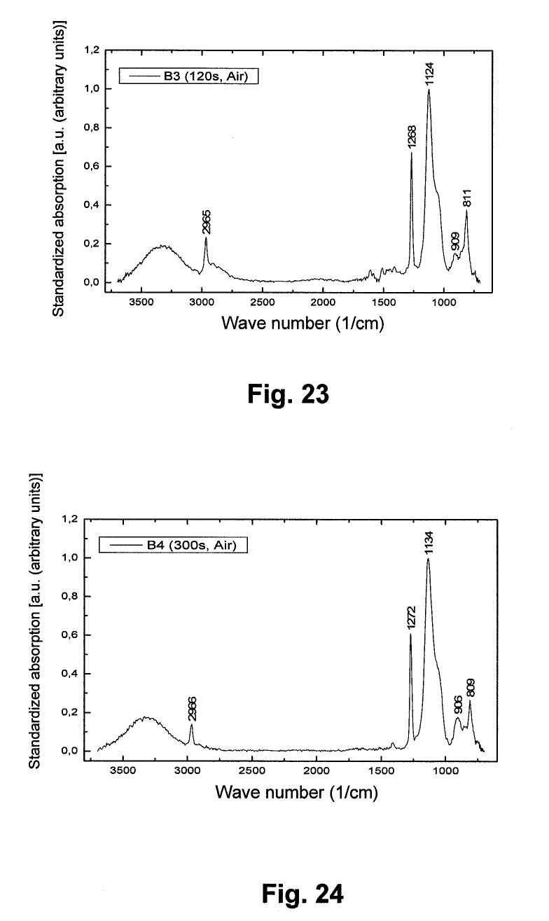

FIG. 23 shows the IR spectrum (ERAS) of the UV radiation-treated pattern B3.

FIG. 24 shows the IR spectrum (ERAS) of the UV radiation-treated pattern B4.

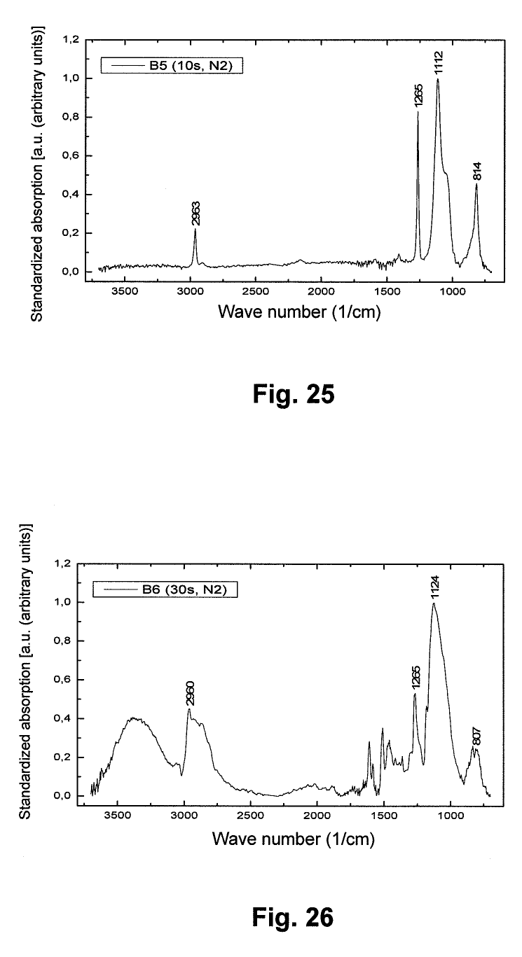

FIG. 25 shows the IR spectrum (ERAS) of the UV radiation-treated pattern B5.

FIG. 26 shows the IR spectrum (ERAS) of the UV radiation-treated pattern B6.

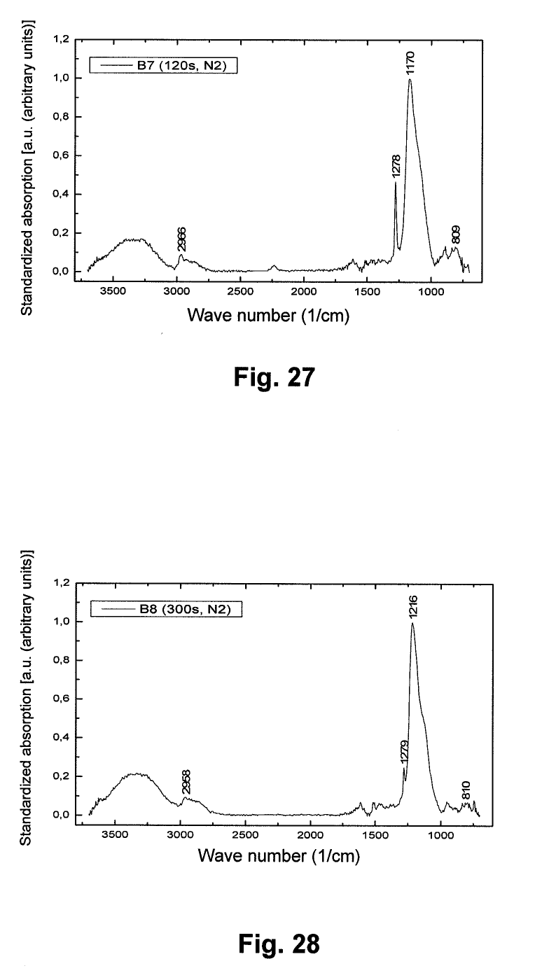

FIG. 27 shows the IR spectrum (ERAS) of the UV radiation-treated pattern B7.

FIG. 28 shows the IR spectrum (ERAS) of the UV radiation-treated pattern B8.

The illustrated data were recorded using ERAS (external reflection absorption spectroscopy) and standardized, for comparability, to the respective maximum in the wave number range of between 1,112 and 1,216 1/cm. In order to record the IR spectra, the uncoated Si wafers were aluminized beforehand and the oil was subsequently applied, as previously, to the Al layer by spin coating.

The irradiation parameters are identical to those of Tables 5 and 6. The maxima of the band in the range of between 1,112 and 1,216 1/cm can be assigned mainly to the carbon-free Si—O—Si compound; the maxima in the range of 1,250 1/cm (Si—CH₃) or 805 1/cm Si(CH₃)₂ and 840 1/cm Si(CH₃)₃ have, on the other hand, carbon contents. The comparison shows that in both cases, during irradiation both under atmosphere and under nitrogen, the ratio between carbon and silicon decreases.

### Example 5

### Comparison of the Layers from Example 4 with Plasma-Polymeric Layers

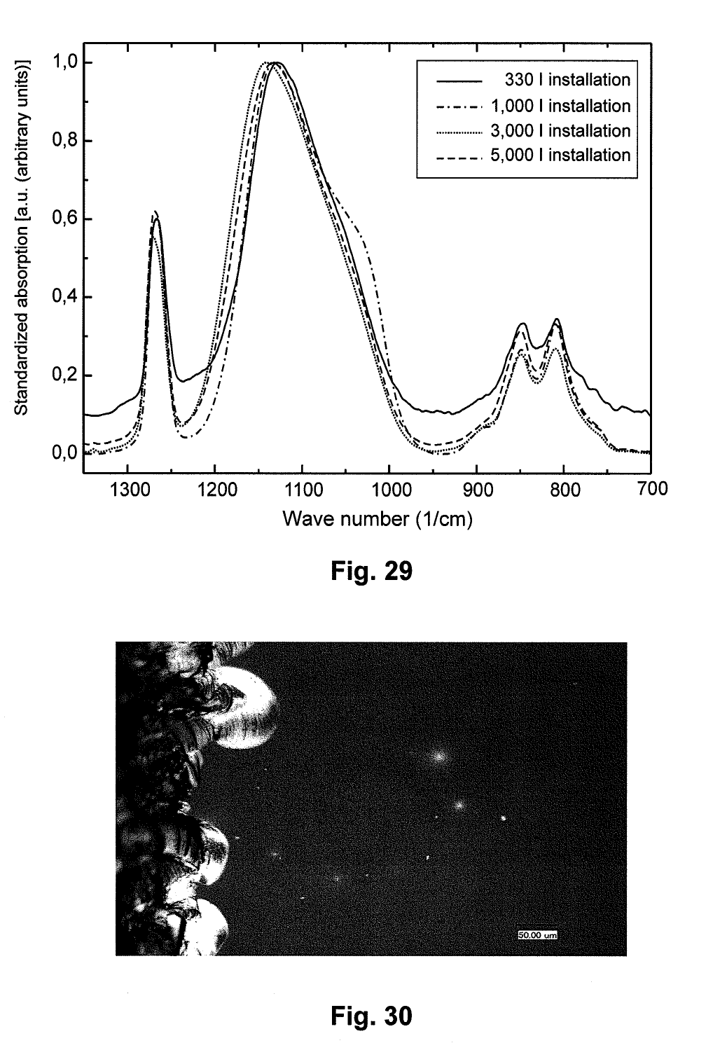

FIG. 29 shows, by way of comparison, the IR spectra of plasma-polymeric parting layers which were produced with the aid of a low-pressure plasma method (at a different reactor volume of from 330 l to 5,000 L). The spectra are standardized to the respective maximum value. All of the spectra display a band both for Si(CH₃)₂ (805 1/cm) and for Si(CH₃)₃ (840 1/cm). The presence of these double bands is characteristic of hydrophobic plasma-polymeric coatings. The pronounced band at 840 1/cm is due to the fact that, with HMDSO as the process gas, use is made of a monomer having, owing to the shortness of the molecule, a relatively high content of Si(CH₃)₃ end groups.

In contrast thereto, in all of the excimer lamp-irradiated patterns, the band associated with the Si(CH₃)₃ end groups is much less pronounced or may be identified only with difficulty. The reason may be identified above all in the fact that liquids are initially taken as the starting point in the coating according to the invention. These liquids have much longer molecular chains, thus greatly reducing the relative proportion of the end groups. This statement applies irrespective of the duration of irradiation or the degree of crosslinking, as FIG. 6 and FIG. 7 show, and thus to both hydrophobic and hydrophilic coatings. As the duration of irradiation or degree of crosslinking increases, the band for the Si(CH₃)₂ group is additionally reduced for the radiation-crosslinked coatings; this is a sign that these groups are broken open with the aid of the high-energy excimer lamp radiation. The same applies to the CH₃ band in the range of ˜2,960 1/cm.

These results may also be generalized.

### Example 6

### Degree of Crosslinking

The method according to the invention allows the degree of crosslinking of the applied liquid to be varied over a broad range by way of the intensity of the irradiation. In addition to the degree of crosslinking of the liquid itself, the adhesion to the substrate material is also technically important. By way of demonstration, FIG. 30 shows a micrograph of a breaking edge of the pattern B8 from Example 4. Although strong mechanical loads acted on the substrate and on the coating, there are no apparent stress cracks or detachment in the coating—the coating boundary runs exactly along the breaking edge. Cracks produced by the mechanical loads in the substrate are, on the other hand, also visible in the coating, FIG. 31. Additional cracks resulting from the short-term stresses do not occur.

FIG. 30 is a micrograph of the UV radiation-crosslinked pattern B8 along a breaking edge after intensive mechanical loading.

FIG. 31 is a micrograph of the UV radiation-crosslinked pattern B8 along a breaking edge after intensive mechanical loading.

### Example 7

### Embedding of Titanium Dioxide Particles

A pattern with embedded titanium dioxide particles was produced in accordance with the method according to the invention. For this purpose, the diluting agent used was a liquid composition made up of the silicone oil AK50 and AK0.65 in a ratio of 1:50, to which titanium dioxide particles were subsequently added. As an on average ˜140 nm-thick liquid film, the composition was applied to an Si wafer by spin coating. Menisci, which had a much higher layer thickness and enclosed the particles in a mountain of oil, were formed in the region of the particles.

The patterns were irradiated for 5 minutes with UV light of the 172 nm wavelength under a nitrogen atmosphere; the distance of the lamp from the surface was ˜10 mm.

Finally, the surface was cleaned with IPA by manual wiping. The aim of the cleaning was to examine whether the coating was sufficiently crosslinked to build up adhesion both between the precursor molecules of the liquid itself and to the base and the TiO₂ particles; particles or large particle agglomerates which could not be sufficiently embedded into the matrix were, in addition, wiped out by the cleaning.

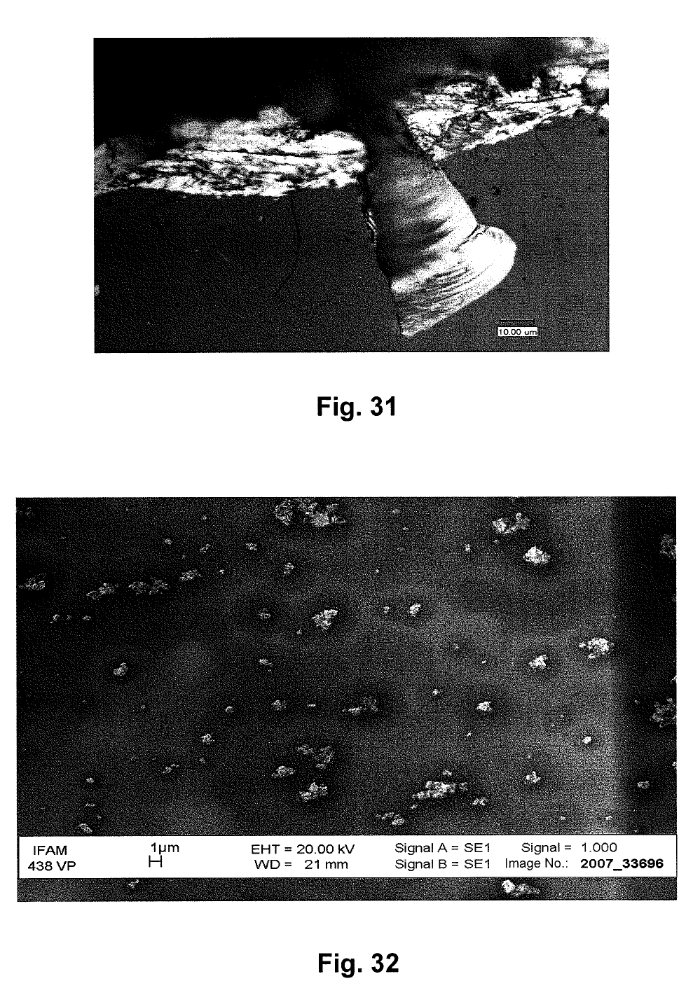

FIG. 32 is an SEM photograph of the cleaned coating, within which the titanium dioxide particles may clearly be seen.

The visible particles or agglomerates could be unambiguously identified by material analysis as being titanium dioxide particles. The size of the embedded particles is laterally up to several micrometers, the height of the particles up to 3 micrometers at an average layer thickness of the crosslinked layer of ˜100 nm.

### Example 8

### Embedding of Dye Particles

A pattern with embedded dye particles was produced in accordance with the method according to the invention. For this purpose, a solution was produced from one part of the silicone oil AK50 (Wacker Chemie AG) and 50 parts of the diluting agent AK0.65 (Wacker Chemie AG). The dye Fat Blue B01 (Clariant GmbH) was added to the solution in an amount such that excess dye is deposited as sediment. In order to remove the sediment and to remove relatively large agglomerates of the added dye, the dispersion was filtered (pore size of 400 nm) and subsequently processed promptly. Panes of glass, to which the dispersion was applied by means of spin coating, served as the base material. After evaporation of the solvent, a ˜140 nm-thick layer of the non-volatile component AK50 was left behind, along with the embedded dye particles, as a liquid film on the glass substrate.

This film was subsequently subjected to light of the 172 nm wavelength from a UV excimer lamp (Xeradex emitter; 50 W, Radium). The distance of the lamps from the substrate was ˜10 mm, the duration of irradiation ˜180 secs; the irradiation was carried out under a nitrogen atmosphere.

After the irradiation or crosslinking of the oil, there is obtained a coating which cannot be wiped manually with isopropanol and within which the added dye particles are embedded.

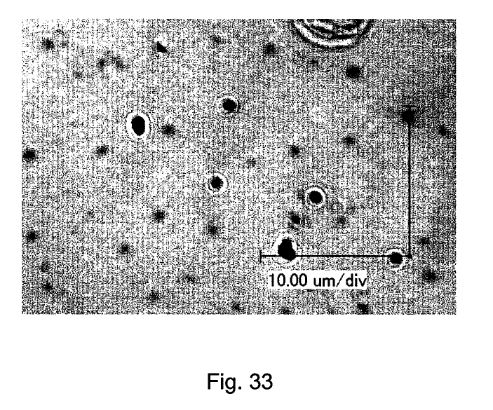

FIG. 33 is a microscope image of the dye particles having an average size of the diameter of below 1 μm.

### Example 9

### Partial Coating

An approx. 140 nm-thick layer made up of AK50 was applied to a silicon wafer by means of spin coating. A perforated mask was subsequently placed onto the layer and the mask was irradiated for 5 minutes under a nitrogen atmosphere with light of the 172 nm wavelength (Xeradex emitter, 50 W, Radium Lampenwerk GmbH). The distance between the mask and the underside of the lamp was ˜10 mm.

After the crosslinking of the irradiated regions of the liquid layer, the non-crosslinked residual film, positioned in the shadow region, of the AK50 could be rinsed off by propanol. A regular pattern of round coating islands was achieved in accordance with the round openings of the mask.

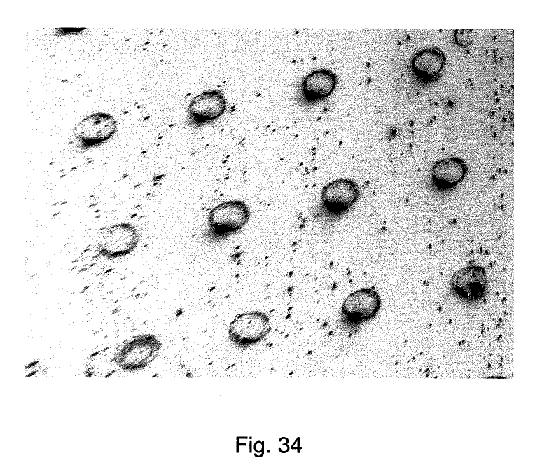

FIG. 34 shows the result of the partial coating in Example 9.

The coated regions could not be removed by manual cleaning and form, as a result of the comparatively higher surface energy compared to the untreated surface of the wafer, hydrophilic anchors.

### Example 10

### Anti-Fingerprint Coating on Metal Surfaces

A) The surface of an electroplated body having an average roughness Rₐ in the range of from 0.3 to 0.8 μm was activated, prior to the application of the liquid, to increase the surface energy to above 72 mN/m with the aid of a low-pressure oxygen plasma. Alternatively, the activation can, for example, be carried out by way of irradiation with short-wave UV radiation from excimer lamps. As a liquid precursor, the silicone oil AK50 (Wacker, surface tension 20.8 mN/m, viscosity 50 mm²/s) was applied by spin coating as an on average 50 nm, 100 nm and 200 nm-thick layer. The liquid precursor is deposited preferably in the depressions of the surface profile and forms in this way a non-closed, insular cover.

The radiation crosslinking took place within a recipient at a residual gas pressure of 0.01 mbar. The distance of the surface from the underside of the emitter was 40 mm. The UV irradiation source was an Xe excimer lamp having a wavelength of 172 nm from the manufacturer Haereus Noblelight. The irradiation intensity was ˜1.2 W/cm² and the duration of the irradiation was 30 secs.

B) As an alternative, the liquid precursor was irradiated under an inert gas atmosphere (for example nitrogen, CO₂, noble gases) at atmospheric pressure at an intensity in the range of from 100 to 400 mW/cm² and for a duration in the range of from 60 to 600 secs. A Xeradex Xe excimer emitter having a wavelength of 172 nm (from Radium) served as the light source. As a further alternative, the crosslinking can take place under an ambient atmosphere, provided that the person skilled in the art ensures that the irradiation dosage, i.e. the radiation power which impinges over time, is sufficient to generate a solid film.

C) Furthermore, patterns of irradiated brass and aluminum surfaces having an average roughness Rₐ in the range of from 0.5-1.2 μm were coated under the same conditions.

On account of the layer thickness, the presence of the coating may be clearly identified as a result of the optical color impression (as a result of interference effects). Resulting average layer thicknesses were on application of a 50 nm precursor layer thickness ˜45 nm, in the case of a 100 nm precursor layer thickness ˜90 nm and in the case of a 200 nm precursor layer thickness ˜185 nm. The local layer thicknesses of the coating islands were, on the other hand, higher by up to a factor of 2 than the average layer thicknesses. This observation may be explained based on the dynamic redistribution of the applied liquid silicone oil precursor. This produces a layer thickness deviation of up to a factor of 2 and an associated degree of coverage of approx. 0.5.

Nevertheless, the following has been found:

Preference is given to an average layer thickness of the finished coating in the range of from 50 to 300 nm. An average layer thickness in the range of from 100 to 250 nm is particularly preferred. In contrast to the description of the aforementioned PCT/EP 2006/062987, layer shrinkage may, depending on the selected process parameters, be observed as a result of the intensive irradiation with light of a wavelength of below 250 nm. This layer shrinkage, which may be measured by comparison of the applied layer thicknesses of the uncrosslinked precursor and the crosslinked precursor, may be up 60% and must be taken into account when setting the desired final layer thickness. The crosslinked coatings may not be removed from the surface as a result of manual wiping with a cloth. The coating displays a reduction in the perception of finger marks (anti-fingerprint properties) in accordance with PCT/EP 2006/062987. In addition, the coating displays easy-to-clean properties.

### Example 11

### Electroplated Plastics Material Surface

Treatment corresponding to Example 10, although now with an electroplated plastics material surface having an average roughness Rₐ in the range of from 0.6-1.0 μm. The crosslinked coatings may not be removed from the surface by manual wiping with a cloth. The coating displays anti-fingerprint properties according to PCT/EP 2006/062987.

### Example 12

### Si Wafer Under Various Process Gas Conditions

The surfaces of three Si wafers were provided by spin coating with the silicone oil AK10000 (Wacker, surface tension 21.5 mN/m, viscosity 10,000 mm²/s), layer thickness ˜250 nm. The radiation crosslinking took place (a) under atmospheric conditions or (b) within a recipient in the presence of nitrogen under atmospheric pressure or (c) under a residual gas pressure of 0.01 mbar. The distance of the surface from the underside of the emitter was 10 mm. The UV irradiation source was an Xe excimer lamp having a wavelength of 172 nm from the manufacturer Radium. The irradiation intensity was ˜0.8W/cm² and the duration of the irradiation was in each case 120 secs.

It was no longer possible to wipe away the crosslinked coatings using a cloth. The coatings are resistant to isopropanol and acetone; it was possible to detach a strip of Tesa film adhesively bonded to the coating without parts of the coating becoming detached from the Si surface. The surface energy was determined after 5 days as 22 mN/m (a, atmosphere), 28 mN/m (b, residual gas) and 32 mN/m (c, nitrogen) respectively.

These are coatings which have low surface energy and can be used as the easy-to-clean layer or as the parting layer.

### Example 13

### Si Wafer Coated, at Various Temperatures

The surface of an Si wafer was provided, by dipping in a solution, with the silicone oil AK50 having varying layer thicknesses of up to 500 nm. The radiation crosslinking took place within a recipient at a residual gas pressure of 0.01 mbar. The distance of the surface from the underside of the emitter was 10 mm. The UV irradiation source was an Xe excimer lamp having a wavelength of 172 nm from the manufacturer Radium. The irradiation intensity was ˜0.6 W/cm² and the duration of the irradiation was 120 secs.

After the crosslinking the coating cannot be manually wiped away using a cloth and displays resistance to acetone. The surface is a low-energy surface having a surface tension of below 22 mN/m.

The water contact angle of a water drop applied to the surface was ˜90°. After heating of the coating for one hour to 200° C., the contact angle was 96°; after heating for a following hour to 250° C., the angle rose to 100°. After heating of the coating for a further three hours at 250° C., the water contact angle was also 100°.

### Example 14

### Easy-to-Clean Surface (Easy-To-Clean Coating)

A thin liquid film consisting of AK50 (Wacker, surface tension 20.8 mN/m, viscosity 50 mm²/s) was applied to the surfaces of an irradiated brass pattern and an aluminum pattern having an average roughness Rₐ in the range of from 0.5-1.2 μm. A plurality of patterns having average layer thicknesses in the range of from 100 to 1,000 nm was produced.

The radiation crosslinking took place within a recipient filled with nitrogen (at atmospheric pressure). The distance of the surface from the underside of the emitter was 20 mm. The UV radiation source was an Xe excimer lamp having a wavelength of 172 nm from the manufacturer Radium (100 W/40 cm). The exposure time was 300 secs.

After crosslinking an approximately 50 to 750 nm-thick layer remains on the surface of the component. The layer displays easy-to-clean properties: For example, finger marks can very easily be wiped away from the surface using a damp cloth. The shrinkage (the reduction in layer thickness of the resulting layer in relation to the application thickness of the precursors) was 25-50%. The shrinkage may be quantified, for example, based on a reference layer on a wafer which passes through the same process. On account of the roughness of other surfaces, direct determination is possible in many cases only with great effort.

In addition, coated patterns having an average layer thickness in the range of from 170 to 200 nm display the effect of hardly differing in terms of color from the original material. An almost invisible easy-to-clean coating, which does not influence the actual surface characteristic, is obtained.

### Example 15

### Smoothing Coating

A liquid film consisting of AK10000 (Wacker, surface tension 21.5 mN/m, viscosity 10,000 mm²/s) having a layer thickness of 1 μm was applied to the surfaces of an irradiated brass pattern and an aluminum pattern having an average roughness Rₐ of 1.2 μm. This layer thickness corresponds to ˜83% of the Rₐ value.

The radiation crosslinking took place within a recipient filled with nitrogen (at atmospheric pressure). The distance of the surface from the underside of the emitter was 5 mm. The UV radiation source was an Xe excimer lamp having a wavelength of 172 nm from the manufacturer Radium (100 W/40 cm). The exposure time was 600 secs.

After crosslinking an on average 700 nm-thick crosslinked layer remains on the surface. The subsequently determined Rₐ value was 0.75 μm. A reduction in roughness of about 40% could thus be achieved.

### Example 16

### Antimicrobial Coating

A dispersion of approx. 1.5% by weight of nanosilver in silicone oil (NanoSilver BG, from Bio-Gate) having a viscosity of from 100-200 mPa and an average primary particle size of between 5 and 50 nm was applied, as a mixture with HMDSO (1:50), to a glass surface by means of spin coating. The glass surface was irradiated beforehand for 120 secs with the aid of UV radiation under an ambient atmosphere to increase the surface energy. The layer thickness of the liquid film was ˜500 nm. The silver-containing liquid layer was subsequently irradiated for 600 secs with UV light (172 nm, Xeradex emitter, 50 W, Radium Lampenwerk GmbH). The distance between the lower edge of the lamp and the surface was ˜15 mm; irradiation was carried out within a nitrogen atmosphere at a pressure of 1 bar. The irradiation created a non-wipeable, hydrophilic coating having an average layer thickness of ˜330 nm. Macroscopically, a browning of the substrate, caused by the incorporated silver, could be perceived. In addition, the presence of nanosilver could be identified with the aid of a UV-VIS spectrometer based on the absorption band, which is typical of silver, at 420 nm. No particle agglomerates having lateral dimensions of greater than 1 μm could be identified under a light microscope. The coating displays antimicrobial, but not cytotoxic properties.

### Example 17

### Adhesive Pretreatment

Various polymers and high-grade steel as the base material were cleaned at the surface with methyl ethyl ketone (MEK). The size of the pattern was 100 mm×25 mm. On the one hand, the cleaned material was used to produce reference adhesive bonds for a shear tension measurement in accordance with DIN EN 1465:1995-01. On the other hand, cleaned material was provided with a coating according to the invention. The liquid silicone oil layer (AK50, Wacker) was applied with the aid of an aerosol method; the average layer thicknesses are listed in Table 8. The oil layers were subsequently irradiated for 600 secs with light of the 172 nm wavelength (Xeradex emitter, 50 W, Radium Lampenwerk GmbH) at a distance of 10 mm under a nitrogen atmosphere. The resulting layer thicknesses may be calculated from the shrinkage listed in Table 8 (ratio between the end layer thickness and application layer thickness). The patterns produced in accordance with the invention were, again, used to produce and measure shear tension samples. The adhesives used were for the polymers listed Delo PUR 9691 and for high-grade steel Delo PUR 9694.

The results of the shear tension measurements are set out in Table 8. Listed are the maximum forces Fmax determined, at which the joint assembly was destroyed, i.e. the adhesive bond failed. All of the values were standardized in relation to the absolute values of the maximum force which was determined for the reference. Thus, for the coating according to the invention, a maximum force of >1 marks an improvement of the bond strength. An improvement could be observed for 4 of the 6 treated materials. The improvement was up to 100% (PTFE). Furthermore, with the coating according to the invention as the adhesive pretreatment for high-grade steel, an improvement of 37% could be achieved, wherein the limit of the adhesive potential was reached in this case. A pure cohesive failure of the adhesive could be observed in this case.

All of the tests were carried out using 3 identical samples. The deviations from the average value (As) are specified in Table 8.

TABLE 8
Results of the shear tension tests carried out on coatings according to
the invention

| | | Layer thickness | Layer thickness | | | | | | | |
|---|---|---|---|---|---|---|---|---|---|---|
| | | of the precursor | of the precursor | Fmax | Fmax | Standard | | Fmax | Standard | |
| | | layer after | before | (absolute) | (standardized) | deviation | Break | (standardized) | deviation | Break |
| | | crosslinking | crosslinking/after | [N] | [N] | Δs | image | [N] | Δs | image |
| Material | Adhesive | [nm] | crosslinking | Reference | | | | Coated samples | | |
| PA | Delo | 90 | 0.58 | 592 | 1 | 0.37 | Adhesive | 0.62 | 0.14 | Adhesive |
| PP | PUR | 76 | 0.63 | 179 | 1 | 0.09 | failure | 1.14 | 0.03 | failure |
| POM | 9691 | 106 | 0.62 | 407 | 1 | 0.08 | | 0.79 | 0.12 | |
| PE | | 76 | 0.56 | 162 | 1 | 0.23 | | 1.10 | 0.04 | |
| PTFE | | 143 | 0.75 | 47 | 1 | — | | 1.97 | 0.36 | |
| High- | Delo | 82 | 0.61 | 3,486 | 1 | 0.14 | | 1.37 | 0.15 | Cohesive |
| grade | PUR | | | | | | | | | failure |
| steel | 9694 | | | | | | | | | |

### Example 18

### Migration Barrier and Permanent Parting Layer

Transparent plastics material molds for the UV curing of paints in a paint pouring method are coated with a closed PDMS oil film of approx. 150 nm by a dipping method. Subsequently, the oil, AK 10,000 (Wacker GmbH), is strongly crosslinked in a nitrogen atmosphere by means of excimer radiation by irradiation within a nitrogen atmosphere at 1 bar. This ensured that each surface element was treated with a radiation dosage of at least 50 Ws/cm², preferably 70 W/s/cm². This radiation dosage can be set, for a 3D mold, by way of the parameters time and distance. In the present example the distance from the plastics material mold was on average 2 cm and the duration of irradiation 25 minutes; the radiation dosage was thus, on use of a Xeradex excimer lamp, on average −90 Ws/cm². This provides a migration barrier in relation to styrene, leading to a considerable lengthening of the duration of use of the plastics material molds. In order also to be able substantially dispense with external parting agents during the shaping process, a second PDMS oil film of approx. 100 nm is slightly crosslinked by means of excimer radiation. In this case too, the irradiation was carried out within a nitrogen atmosphere at 1 bar. The radiation dosage may be at most 30 Ws/cm², preferably at most 20 W/s/cm². In the present example the distance from the plastics material mold was on average 2 cm and the duration of irradiation 5 minutes; the radiation dosage was thus, on use of a Xeradex excimer lamp, on average ˜25 Ws/cm². The mold material used may be both silicone and polyamide.

### Example 19

### Gas Migration Barrier

PP foil (manufacturer: Tresphaphan, thickness: 25 μm) was provided by way of an aerosol method with a silicone oil layer (AK50, Wacker GmbH) having an average layer thickness of ˜120 nm. The liquid layers were subsequently irradiated with light of the 172 nm wavelength using an excimer lamp (manufacturer: Radium Lampenwerk GmbH). The duration of irradiation was in this case 600 secs at a distance between the lamp and foil of ˜0.5 cm. Although the aerosol method provides a droplet-like covering, it was possible to ensure, by monitoring with the aid of a light microscope based on the visible interference color courses, that the degree of coverage with the silicone oil is 1, i.e. complete covering was achieved. The average layer thicknesses were after irradiation ˜70 nm; the relative layer thickness deviation was in this case approximately 50%, i.e. the local layer thicknesses were 35-100 nm.

The oxygen permeability was measured with the aid of the permeation measuring apparatus OX-TRAN 2/20 (from Mocon). This involves determining the migration of oxygen through the coated foil (determination for foils in accordance with DIN 53380-3 and ASTM D 3985-05). The relative humidity of air during the measurement was 50%, the measuring temperature 30° C.

For the non-treated foil, an oxygen permeability of 3,460 cm³/(m²d) was measured; the coated foil had a permeability of 81 cm³/(m²d). A reduction of the oxygen permeability to ˜2.3% could thus be achieved.

### Example 20

### Flexible Scratch Protection Layer on Sensitive Surfaces

Transparent polycarbonate panels for car roof glazing were equipped with a closed PDMS oil film of approx. 2 μm using an aerosol method. Subsequently, the oil is strongly crosslinked in a nitrogen atmosphere by means of excimer radiation. The distance from the surface to the lamp is at most 1 cm, the duration of irradiation 20 minutes. This significantly improves the scratch resistance of the panel without a risk of the coating chipping off in the event of relatively intensive flexural stress.

### Example 21

### Flexible Coating

The coating from Example 3D), coating of a highly reflective aluminum sheet, displays a further special feature of the possibilities of the coating technology according to the invention.

The coated metal sheets were bent by hand. Bending radii of 2.5 mm were implemented. In practice, the test was carried out in such a way that the corresponding metal sheet was placed onto a rod and the radius of the rod was copied. The bent metal sheet was examined under a light microscope at a 1,000-fold resolution. No cracks or exfoliating of the layer was observed. In particular, there was no reduction in the abrasion resistance of the coating. It may therefore be assumed that the lower limit for the bending radius may still be much less than 2.5 mm. The result is flexible wear protection or flexible corrosion protection. This property is important in so far as the metal sheets are generally produced as a flat strip and are bent and tilted after coating to implement 3D shapes.

The flexibility of the coatings according to the invention is based generally in part on the residual content of carbon in the coating. Example 4 discloses exemplary parameters which can be used to implement corresponding carbon contents.

Accordingly, other functionalizations of the aforementioned surface functionalizations can be configured as a flexible coating. This includes for example a flexible scratch protection having, in contrast to the above-mentioned example, layer thicknesses in the range of several micrometers. These layer thicknesses can be applied in a plurality of plies within a plurality of cycles or preferably in one cycle.

Furthermore, it is possible, by setting the carbon content, to implement flexible tarnish protection, a flexible antimicrobial coating, a flexible structuring or topography-imparting coating, a flexible barrier coating, a flexible anti-fingerprint coating, a flexible easy-to-clean coating, etc. (for this purpose, reference is also made, for example, to Chapter 7).

### Example 22

### Thin Protective Layers on Ceramic Filter Materials

Ceramic filter media based on borosilicate fibers are equipped, as web materials, with a closed PDMS oil film having an average layer thickness of approx. 300 nm by way of an aerosol method. Subsequently, the oil is crosslinked in a nitrogen atmosphere by means of excimer radiation. The irradiation dosage was at least 50 Ws/cm² (at a distance of 1 cm and a duration of irradiation of 10 minutes on use of a Xeradex excimer lamp having a wavelength of 172 nm and a power of 50 W at a length of 40 cm). This considerably lengthens the service life of the sterile air filter elements produced from the filter media for the conditioning of process air during a regular disinfection within a cleaning-in-place (CIP) method. The reason for this is in particular the higher resistance, obtained as a result of the coating according to the invention, to alkaline hydrogen peroxide vapors. The low layer thickness of the coating leads in this case only to a very slight increase in the pressure differential through the filter medium.

1. A coating method comprising the following steps:
a) providing a mixture or a pure substance comprising or consisting of inactive, liquid precursors,
b) applying a liquid layer made up of the mixture or the pure substance to a surface to be coated,
c) crosslinking the liquid precursors by means of radiation having a wavelength of ≦250 nm, so that a solid layer is produced from the mixture and the layer comprises ≧10 atomic % of C, based on the quantity of the atoms contained in the layer without H and F,
and so that the C contained in the layer is at most 50 atomic % of the C, based on the quantity of the C atoms contained in the layer, constituent of a methoxy group.

2. The coating method as claimed in claim 1, wherein the crosslinking is carried out in such a way that at most 50 atomic % of the C, based on the quantity of the C atoms contained in the layer, is a constituent of an alkoxy group.

3. The coating method as claimed in claim 1, wherein the layer is crosslinked by means of laser radiation or UV radiation from an excimer lamp.

4. The coating method as claimed in claim 1, wherein the crosslinking is carried out by means of UV radiation of the wavelength ≦200 nm.

5. The coating method as claimed in claim 1, wherein the liquid precursors are applied at a layer thickness of from 3 nm to 10 μm.

6. The coating method as claimed in claim 1, wherein ≧50% by weight of the mixture provided in step a) consists, based on the total weight of the mixture, of inactive, liquid precursors.

7. The coating method as claimed in claim 1, wherein the precursors provided in step a) comprise ≧10 atomic % of C, based on the quantity of the atoms contained in the mixture without H and F.

8. The coating method as claimed in claim 1, wherein at most 50 atomic % of the C contained in the mixture provided in step a), based on the quantity of the C atoms contained in the mixture, is a constituent of a methoxy group.

9. The coating method as claimed in claim 1, wherein at most 50 atomic % of the C contained in the mixture provided in step a), based on the quantity of the C atoms contained in the mixture, is a constituent of an alkoxy group.

10. The coating method as claimed in claim 1, wherein the surface to be coated comprises no silanol groups.

11. The coating method as claimed in claim 1, wherein the liquid layer is applied under conditions under which no chemical reaction takes place between the inactive liquid precursors and the surface.

12. The coating method as claimed in claim 1, wherein the liquid precursors are non-functionalized silicone oils and/or high-boiling hydrocarbons and/or non-functionalized fluorinated silicone oils and/or fluorohydrocarbons and/or copolymers and/or co-oligomers of the aforementioned substances.

13. A crosslinked layer which can be produced in a method as claimed in claim 1.

14. The crosslinked layer as claimed in claim 13, wherein the C signal displays in the depth profile of the time of flight-secondary ion mass spectrometry (TOF-SIMS) profile, on standardization of the intensities to the silicon signal, a course which is substantially parallel to the X axis (sputtering cycles).

15. An item with a surface coated with a crosslinked layer, which can be produced by means of a coating method as claimed in claim 1.

16-66. (canceled)

67. A method for generating a surface topography on a surface to be coated by means of carrying out a method as claimed in claim 1, wherein the ratio of the liquid surface tension of the liquid precursor to the surface energy of the surface to be coated is selected in such a way that a partially closed layer, which is marked by an insular appearance, is generated in step c), the layer thickness in the region of the insular appearances being preferably at most 10 μm.

68. The method for generating a surface topography on a surface to be coated by means of carrying out a method as claimed in claim 1, wherein in step b) a mix is provided, comprising particles having a particle diameter of from 20% to 1,000%, based on the average layer thickness after the crosslinking.

69. The coating method as claimed in claim 2, wherein:
the layer is crosslinked by means of laser radiation or UV radiation from an excimer lamp;
the crosslinking is carried out by means of UV radiation of the wavelength ≦200 nm;
the liquid precursors are applied at a layer thickness of from 3 nm to 10 μm;
≧50% by weight of the mixture provided in step a) consists, based on the total weight of the mixture, of inactive, liquid precursors;
the precursors provided in step a) comprise ≧10 atomic % of C, based on the quantity of the atoms contained in the mixture without H and F;
at most 50 atomic % of the C contained in the mixture provided in step a), based on the quantity of the C atoms contained in the mixture, is a constituent of a methoxy group;
at most 50 atomic % of the C contained in the mixture provided in step a), based on the quantity of the C atoms contained in the mixture, is a constituent of an alkoxy group;
the surface to be coated comprises no silanol groups;
the liquid layer is applied under conditions under which no chemical reaction takes place between the inactive liquid precursors and the surface; and
the liquid precursors are non-functionalized silicone oils and/or high-boiling hydrocarbons and/or non-functionalized fluorinated silicone oils and/or fluorohydrocarbons and/or copolymers and/or co-oligomers of the aforementioned substances.

70. An item with a surface coated with a crosslinked layer, which can be produced by means of a coating method as claimed in claim 68.

71. A method for generating a surface topography on a surface to be coated by means of carrying out a method as claimed in claim 69, wherein the ratio of the liquid surface tension of the liquid precursor to the surface energy of the surface to be coated is selected in such a way that a partially closed layer, which is marked by an insular appearance, is generated in step c), the layer thickness in the region of the insular appearances being preferably at most 10 μm.

72. The method for generating a surface topography on a surface to be coated by means of carrying out a method as claimed in claim 69, wherein in step b) a mix is provided, comprising particles having a particle diameter of from 20% to 1,000%, based on the average layer thickness after the crosslinking.
